(19) United States
(12) Patent Application Publication
(10) Pub. No.: US 2017/0193309 A1
(43) Pub. Date: Jul. 6, 2017

(54) MOVING INFORMATION ANALYZING SYSTEM AND MOVING INFORMATION ANALYZING METHOD

(71) Applicant: Panasonic Intellectual Property Management Co., Ltd., Osaka (JP)

(72) Inventors: Marie Kanda, Fukuoka (JP); Junko Noda, Nagasaki (JP); Hiroyuki Yamamoto, Ishikawa (JP); Yoshihiro Sugishita, Osaka (JP)

(21) Appl. No.: 15/391,205

(22) Filed: Dec. 27, 2016

(30) Foreign Application Priority Data
Jan. 6, 2016 (JP) 2016-001331
Jan. 6, 2016 (JP) 2016-001333

(51) Int. Cl. G06K 9/00; G06Q 30/02; G06T 11/60; H04N 5/232; H04N 7/18; G06T 7/20

(52) U.S. Cl. CPC G06K 9/00771; H04N 7/183; G06T 7/20; G06T 11/60; H04N 5/23293; G06Q 30/0201

(57) ABSTRACT

A camera captures an image of an object region, extracts moving information regarding a staying position or a passing position of each moving object, stores the extracted moving information of each moving object, and transmits a captured image of the object region and the moving information of each moving object to a server in a predetermined transmission cycle. The server acquires moving information of at least one moving object satisfying a selection condition regarding a specific behavior on the basis of the moving information of each moving object, generates a moving information analysis image in which the moving information of at least one moving object satisfying the selection condition regarding the specific behavior is superimposed on the captured image, and displays the moving information analysis image on a monitor.

### BACKGROUND

1. Technical Field

The present disclosure relates to a moving information analyzing system and a moving information analyzing method capable of generating a moving information analysis image in which staying information or passing information of a moving object such as a person is superimposed on an image captured by a camera.

2. Description of the Related Art

As the related art in which a level of activity of a person over a period of time at an imaging site where a camera is provided is displayed as a heat map image, for example, Japanese Patent Unexamined Publication No. 2009-134688 is known.

Japanese Patent Unexamined Publication No. 2009-134688 discloses a technique of analyzing moving information of a person at the imaging site where a security camera connected to a network is provided so as to calculate a level of activity, generating a heat map image in which a detection result from a sensor is superimposed on a floor plan of the imaging site, and displaying the heat map image on a browser screen corresponding to the security camera. Consequently, it is possible to understand a level of activity of the person at the imaging site by viewing the heat map image displayed on the browser screen.

Here, a case is assumed in which a camera captures an image of a predetermined object region (for example, a location where a plurality of merchandise display shelves are disposed in a store) by using the configuration disclosed in Japanese Patent Unexamined Publication No. 2009-134688. A case is assumed in which a heat map image is generated in which staying information or passing information of a moving object (for example, a person) who moves in the object region is superimposed on an image captured by the camera.

In the configuration disclosed in Japanese Patent Unexamined Publication No. 2009-134688, all objects (including persons) in the imaging site are targeted, there may be a person who is not a true purchaser (customer) desired by a store side among persons recognized from the image captured by the camera. In other words, fine analysis of moving information of each true customer desired by the store side cannot be performed, and thus a heat map image truly desired by the store side may not be obtained.

For example, a staying position or a passing position of each customer in a store differs, such as a customer who uniformly looks around merchandise display shelves in the store or a customer who stays at a specific location in the store. In Japanese Patent Unexamined Publication No. 2009-134688, it may not be possible to perform fine analysis of moving information of each customer in a store, taking such a situation into consideration.

### SUMMARY

In order to solve the above-described problem of the related art, an object of the present disclosure is to provide a moving information analyzing system and a moving information analyzing method capable of performing fine analysis of moving information of each customer instead of all customers shown in an object region and thus efficiently obtaining a moving information analysis image in which an activity of a customer truly desired by a store side in a store is appropriately understood.

According to the present disclosure, there is provided a moving information analyzing system including a camera and a server that are connected to each other. The camera captures an image of an object region, extracts moving information regarding a staying position or a passing position of each moving object, stores the extracted moving information of each moving object, and transmits a captured image of the object region and the moving information of each moving object to the server in a predetermined transmission cycle. The server acquires moving information of at least one moving object satisfying a selection condition regarding a specific behavior on the basis of the moving information of each moving object transmitted from the camera, generates a moving information analysis image in which the moving information of at least one moving object satisfying the selection condition regarding the specific behavior is superimposed on the captured image transmitted from the camera, and displays the moving information analysis image on a monitor connected to the server.

According to the present disclosure, it is possible to perform fine analysis of moving information of each customer instead of all customers reflected in an object region and thus efficiently obtain a moving information analysis image in which an activity of a customer truly desired by a store side in a store is appropriately understood.

### BRIEF DESCRIPTION OF THE DRAWINGS

FIG. 1 a system configuration diagram illustrating details of a system configuration of a sales management system including a moving information analyzing system of each exemplary embodiment;

FIG. 2 is a block diagram illustrating details of a functional internal configuration of each of a camera and a server of a first exemplary embodiment;

FIG. 3 is a diagram illustrating a summary of an operation of a background image generating section of the camera of the first exemplary embodiment;

FIG. 4A is a diagram illustrating an example of a captured image which is input into an image input section. FIG. 4B is a diagram illustrating an example of a background image generated by the background image generating section;

FIG. 5 is a time chart illustrating operation timings of respective processes including image input, background image generation, and moving information analysis in the camera of the first exemplary embodiment;

FIG. 6 is a time chart corresponding to a case where the camera of the first exemplary embodiment periodically performs a transmission process;

FIG. 7 is a time chart corresponding to a case where the camera of the first exemplary embodiment changes an operation timing of the transmission process in response to detection of an event;

FIG. 8 is a time chart corresponding to a case where the camera of the first exemplary embodiment omits the transmission process before and after an event is detected;

FIG. 9 is a diagram illustrating an example of a layout of a food sales area in which the camera of the first exemplary embodiment is provided in a plurality;

FIG. 10 is a diagram illustrating an example of an operation screen including a moving information analysis image of a store, generated by a display image generating section of the server of the first exemplary embodiment;

FIG. 11 is a diagram illustrating another example of an operation screen including a moving information analysis image of the store, generated by the display image generating section of the server of the first exemplary embodiment;

FIG. 12 is a diagram illustrating an example of an operation screen of a monthly report related to a food sales area of the store, dated in May, 2014, generated by a report generating output section of the server of the first exemplary embodiment;

FIG. 13 is a block diagram illustrating details of a functional internal configuration of a camera of a modification example of the first exemplary embodiment;

FIG. 14 is a block diagram illustrating details of a first example of a functional internal configuration of each of a camera and a server of a second exemplary embodiment;

FIG. 15 is a diagram schematically illustrating an example of a moving information analysis image in which moving information of at least one person uniformly having passed all sales areas is superimposed;

FIG. 16 is a diagram schematically illustrating an example of a moving information analysis image in which moving information of at least one person having stayed at only a specific sales area among all sales areas is superimposed;

FIG. 17 is a diagram schematically illustrating an example of a moving information analysis image in which moving information of at least one person having stayed at only a specific sales area for a long period of time among all sales areas and having passed other sales areas is superimposed;

FIG. 18 is a flowchart illustrating an example of operation procedures of a loop process in the camera of the second exemplary embodiment;

FIG. 19 is a flowchart illustrating an example of operation procedures of a loop process in the camera and the server on the expiry of a moving information preservation period in the camera of the second exemplary embodiment;

FIG. 20 is a flowchart illustrating an example of operation procedures of a loop process in the camera and the server when an analysis data display instruction is received from an input device of the second exemplary embodiment;

FIG. 21 is a block diagram illustrating details of a second example of a functional internal configuration of each of the camera and the server of the second exemplary embodiment;

FIG. 22 is a diagram illustrating an example of an operation screen including a moving information analysis image of a store, generated by a display image generating section of the server of the second exemplary embodiment;

FIG. 23 is a flowchart illustrating an example of operation procedures of a staying situation analysis operation on the moving information analysis image illustrated in FIG. 22 performed by a salesperson;

FIG. 24 is a flowchart illustrating another example of operation procedures of a loop process in the camera of the second exemplary embodiment;

FIG. 25 is a block diagram illustrating details of a first example of a functional internal configuration of each of a camera and a server of a third exemplary embodiment;

FIG. 26 is a diagram schematically illustrating an example of a moving information analysis image in which moving information of a purchaser whose staying time is one minute or more is superimposed;

FIG. 27 is a diagram schematically illustrating an example of a moving information analysis image in which moving information of a purchaser whose staying time is three minutes or more is superimposed;

FIG. 28 is a diagram schematically illustrating an example of a moving information analysis image in which moving information of a purchaser whose staying time is five minutes or more is superimposed;

FIG. 29 is a flowchart illustrating an example of operation procedures of a loop process in the camera of the third exemplary embodiment;

FIG. 30 is a flowchart illustrating an example of operation procedures of a loop process in the camera and the server on the expiry of a moving information preservation period in the camera of the third exemplary embodiment;

FIG. 31 is a flowchart illustrating an example of operation procedures of a loop process in the camera and the server when an analysis data display instruction is received from an input device of the third exemplary embodiment;

FIG. 32 is a block diagram illustrating details of a second example of a functional internal configuration of each of the camera and the server of the third exemplary embodiment;

FIG. 33 is a diagram schematically illustrating an example of a moving information analysis image in which moving information of a female purchaser is superimposed;

FIG. 34 is a diagram schematically illustrating an example of a moving information analysis image in which moving information of a male purchaser is superimposed;

FIG. 35 is a diagram schematically illustrating an example of a moving information analysis image in which moving information of each of male and female purchasers is superimposed;

FIG. 36 is a diagram schematically illustrating an example of a moving information analysis image in which moving information of a purchaser in his or her forties is superimposed;

FIG. 37 is a diagram schematically illustrating an example of a moving information analysis image in which moving information of a purchaser in his or her sixties or more is superimposed; and

FIG. 38 is a flowchart illustrating another example of operation procedures of a loop process in the camera of the third exemplary embodiment.

### DETAILED DESCRIPTION

Hereinafter, a description will be made of each exemplary embodiment in which a moving information analyzing system and a moving information analyzing method according to the present disclosure are specifically disclosed with reference to the drawings. However, a detailed description more than necessary will be omitted in some cases. For example, a detailed description of the well-known content or a repeated description of the substantially same configuration will be omitted in some cases. This is so that a person skilled in the art can easily understand the present disclosure by preventing the following description from being unnecessarily redundant. The accompanying drawings and the following description are provided in order for a person skilled in the art to fully understand the present disclosure, and are not intended to limit the subject matter recited in the claims

### First Exemplary Embodiment

Hereinafter, a description will be made of a first exemplary embodiment of a moving information analyzing system, a camera, and a moving information analyzing method according to the present disclosure with reference to the drawings. The present disclosure may be defined as a moving information analysis image generation method including operations (steps) of a camera generating a moving information analysis image (which will be described later).

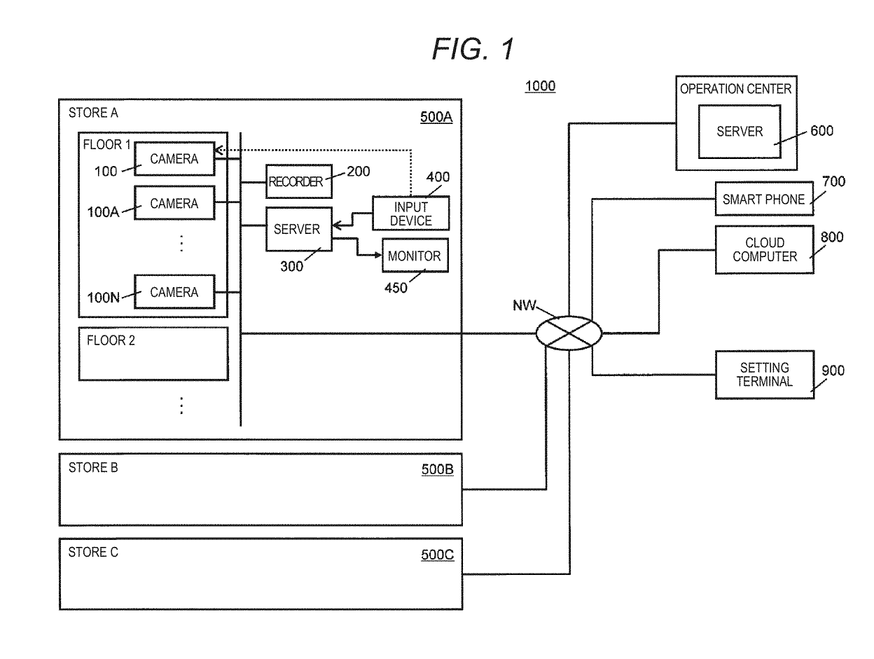

In the following first exemplary embodiment, as illustrated in FIG. 1, a description thereof will be made, for example, assuming use of sales management system 1000 in which moving information analyzing systems 500A, 500B, 500C, . . . related to the present disclosure are respectively provided in a plurality of stores (store A, store B, store C, . . . ), and the plurality of moving information analyzing systems 500A, 500B, 500C, . . . are connected to each other via network NW. However, exemplary embodiments of the moving information analyzing system, a camera, and a moving information analyzing method related to the present disclosure are not limited to content to be described later.

FIG. 1 is a system configuration diagram illustrating details of a system configuration of sales management system 1000 including moving information analyzing systems 500A, 500B, 500C, . . . of each exemplary embodiment. Sales management system 1000 illustrated in FIG. 1 includes moving information analyzing systems 500A, 500B, 500C, . . . which are respectively provided in a plurality of stores A, B, C, . . . , server 600 of an operation center, smart phone 700, cloud computer 800, and setting terminal 900.

Respective moving information analyzing systems 500A, 500B, 500C, . . . , server 600 of the operation center, smart phone 700, the cloud computer 800, and setting terminal 900 are connected to each other via network NW. Network NW is wireless network or a wired network. The wireless network is, for example, a wireless local area network (LAN), a wireless wide area network (WAN), 3G, long term evolution (LTE), or wireless gigabit (WiGig). The wired network is, for example, an intranet or the Internet.

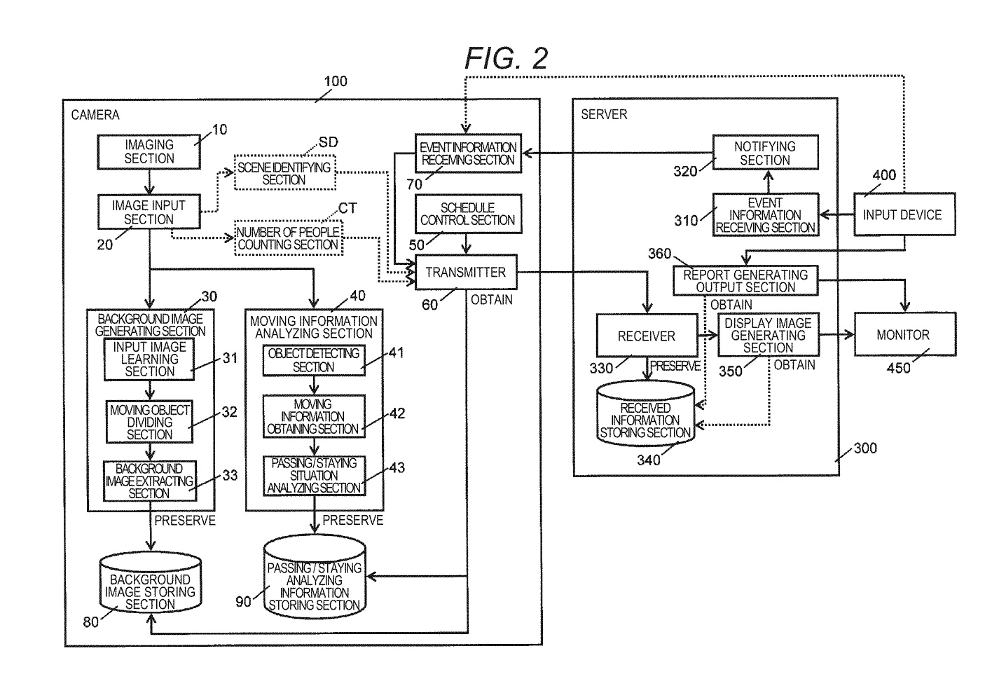

Moving information analyzing system 500A provided in store A includes a plurality of cameras 100, 100A, . . . , and 100N provided in floor 1, recorder 200, server 300, input device 400, and monitor 450 illustrated in FIG. 1. In the same manner as in floor 1, a plurality of cameras are provided in floor 2, and the cameras in floor 2 are not illustrated. Internal configurations of respective cameras 100, 100A, . . . , and 100N are the same as each other, and details thereof will be described later with reference to FIG. 2.

Recorder 200 is configured by using, for example, a semiconductor memory or a hard disk device, and stores data on an image captured by each of the cameras provided in store A (hereinafter, the image captured by the camera is referred to as a “captured image”). The data on the captured image stored in recorder 200 is provided for monitoring work such as crime prevention.

Server 300 is configured by using, for example, a personal computer (PC), and notifies camera 100 of the occurrence of a predetermined event (for example, a change of a layout of a sales area of floor 1 of store A) in response to an input operation performed by a user (who is a user of, for example, the moving information analyzing system and indicates a salesperson or a store manager of store A; this is also the same for the following description) who operates input device 400.

Server 300 generates a moving information analysis image in which moving information regarding a staying position or a passing position of a moving object (for example, a person such as a salesperson, a store manager, or a store visitor; this is also the same for the following description) in an imaging region of the camera (for example, camera 100) is superimposed on a captured image obtained by the camera (for example, camera 100) by using data (which will be described later) transmitted from the camera (for example, camera 100), and displays the image on monitor 450.

Server 300 performs a predetermined process (for example, a process of generating a moving information analysis report which will be described later) in response to an input operation performed by the user operating input device 400, and displays the moving information analysis report on monitor 450. Details of an internal configuration of server 300 will be described later with reference to FIG. 2.

Input device 400 is configured by using, for example, a mouse, a keyboard, a touch panel, or a touch pad, and outputs a signal corresponding to a user's input operation to camera 100 or server 300. In FIG. 1, for simplification of illustration, an arrow is shown only between input device 400 and camera 100, but arrows may be shown between input device 400 and other cameras (for example, cameras 100A and 100N).

Monitor 450 is configured by using, for example, a liquid crystal display (LCD) or an organic electroluminescence (EL) display, and displays data related to a moving information analysis image or a moving information analysis report generated by server 300. Monitor 450 is provided as an external apparatus separately from server 300, but may be included in server 300.

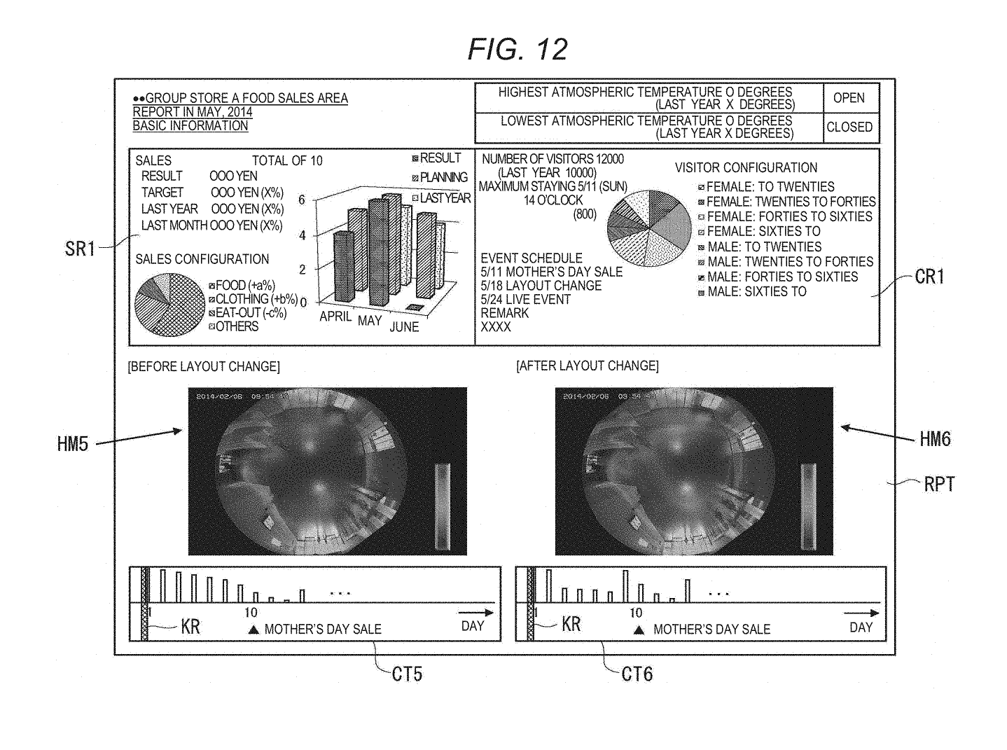

Server 600 of the operation center is a viewing apparatus which acquires and displays moving information analysis images or moving information analysis reports generated by moving information analyzing systems 500A, 500B, 500C, . . . provided in the respective stores A, B, C, . . . in response to an input operation performed by an employee (for example, an officer) of the operation center who operates server 600 of the operation center. Server 600 of the operation center holds various information pieces (for example, sales information, information regarding the number of visitors, event schedule information, the highest atmospheric temperature information, and the lowest atmospheric temperature information) required to generate a moving information analysis report (refer to FIG. 12). These various information pieces may be held in the servers provided in respective stores A, B, C, . . . . Server 600 of the operation center may perform each process which is performed by the server (for example, server 300 of store A) provided in each of stores A, B, C, . . . . Consequently, server 600 of the operation center can integrate data from the respective stores A, B, C, . . . so as to generate a moving information analysis report (for example, refer to FIG. 12 to be described later) and thus to acquire specific data (for example, a moving information analysis report illustrated in FIG. 12) related to one store selected through an input operation on server 600 of the operation center, or to display a data comparison result between specific sales areas (for example, meat sales areas) of a plurality of stores.

Smart phone 700 is a viewing apparatus which acquires and displays moving information analysis images or moving information analysis reports generated by moving information analyzing systems 500A, 500B, 500C, . . . provided in the respective stores A, B, C, . . . in response to an input operation performed by an employee (for example, a sales representative) of the operation center who operates smart phone 700.

The cloud computer 800 is an online storage which stores data related to moving information analysis images or moving information analysis reports generated by moving information analyzing systems 500A, 500B, 500C, . . . provided in the respective stores A, B, C, . . . , and performs a predetermined process (for example, retrieval and extraction of a moving information analysis report dated on the Y-th day of the X month) in response to in response to an input operation performed by an employee (for example, a sales representative) of the operation center who operates smart phone 700 and displays a process result on smart phone 700.

Setting terminal 900 is configured by using, for example, a PC, and can execute dedicated browser software for displaying a setting screen of the camera of moving information analyzing systems 500A, 500B, 500C, . . . provided in the respective stores A, B, C, . . . . Setting terminal 900 displays a setting screen (for example, a common gateway interface (CGI)) of the camera by using the browser software in response to an input operation of an employee (for example, a system manager of sales management system 1000) of the operation center operating setting terminal 900, and sets information regarding the camera by editing (correcting, adding, and deleting) the information.

### Camera

FIG. 2 is a block diagram illustrating details of a functional internal configuration of each of camera 100 and server 300 of the first exemplary embodiment. In sales management system 1000 illustrated in FIG. 1, the cameras provided in the respective stores A, B, C, . . . have the same configuration, and thus camera 100 will be described as an example in FIG. 2.

Camera 100 illustrated in FIG. 2 includes imaging section 10, image input section 20, background image generating section 30, moving information analyzing section 40, schedule control section 50, transmitter 60, event information receiving section 70, background image storing section 80, and passing/staying analyzing information storing section 90. Background image generating section 30 includes input image learning section 31, moving object dividing section 32, and background image extracting section 33. Moving information analyzing section 40 includes object detecting section 41, moving information obtaining section 42, and passing/staying situation analyzing section 43.

Imaging section 10 includes at least a lens and an image sensor. The lens collects light (light beams) which is incident from the outside of camera 100 and forms an image on an imaging surface of the image sensor. As the lens, a fish-eye lens, or a wide angle lens which can obtain an angle of view of 140 degrees or greater is used. The image sensor is a solid-state imaging element such as a charged-coupled device (CCD) or a complementary metal oxide semiconductor (CMOS), and converts an optical image formed on the imaging surface into an electric signal.

Image input section 20 is configured by using, for example, a central processing unit (CPU), a micro-processing unit (MPU), or a digital signal processor (DSP), and performs a predetermined signal process using the electric signal from imaging section 10 so as to generate data (frame) for a captured image defined by red, green, and blue (RGB) or YUV (luminance and color difference) which can be recognized by the human eye, and outputs the data to background image generating section 30 and moving information analyzing section 40.

Background image generating section 30 is configured by using, for example, a CPU, an MPU, or a DSP, and generates a background image obtained by removing a moving object (for example, a person) included in the captured image for every data item (frame) for the captured image output from image input section 20 at a predetermined frame rate (for example, 30 frames per second (fps)), and preserves the background image in background image storing section 80. The process of generating a background image in background image generating section 30 may employ an image processing method disclosed in, for example, Japanese Patent Unexamined Publication No. 2012-203680, but is not limited to this method.

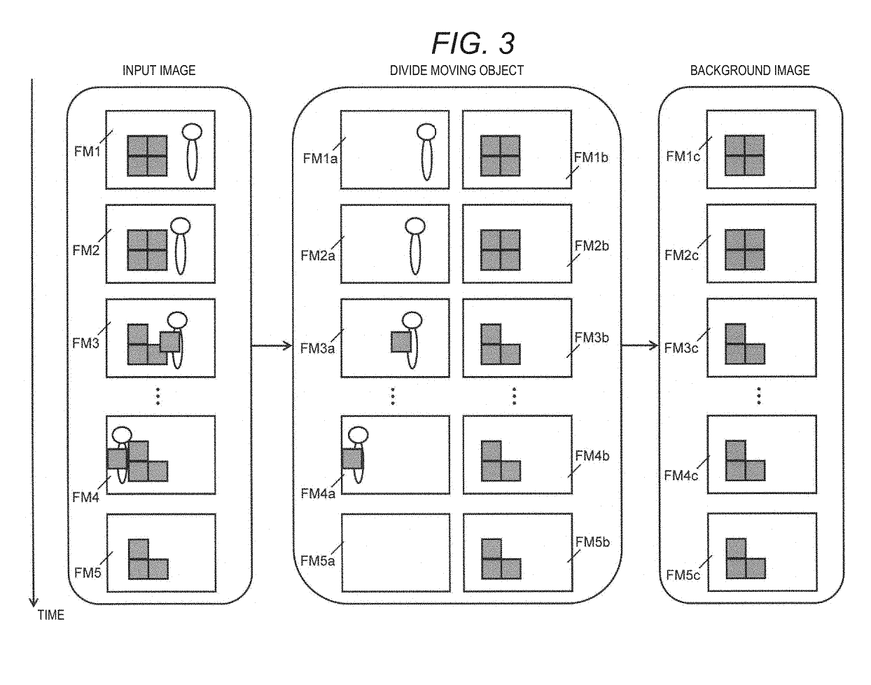

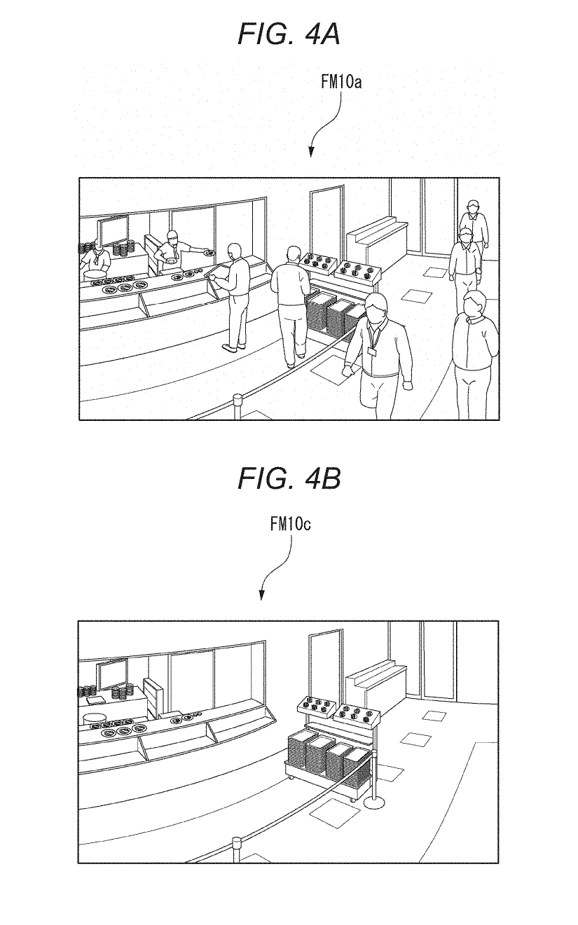

Here, a summary of an operation of background image generating section 30 will be described briefly with reference to FIGS. 3 to 4B. FIG. 3 is a diagram illustrating a summary of an operation of background image generating section 30 of camera 100 according to the first exemplary embodiment. FIG. 4A is a diagram illustrating an example of a captured image which is input to image input section 20. FIG. 4B is a diagram illustrating an example of a background image generated by background image generating section 30.

FIG. 3 schematically illustrates results generated by input image learning section 31, moving object dividing section 32, and background image extracting section 33 from the left side to the right side of the figure perpendicular to a time axis which is directed from the top to the bottom of the figure, and illustrates a state in which a visitor to the store carries one corrugated cardboard among four corrugated cardboards for drinks.

Input image learning section 31 analyzes the distribution of luminance and color difference in each pixel in frames (for example, respective frames FM1 to FM5 illustrated in FIG. 3) of a plurality of captured images output from image input section 20.

Moving object dividing section 32 divides the respective frames FM1 to FM5 of the captured images into information (for example, refer to frames FM1a to FM5a) regarding a moving object (for example, a person) and information (for example, refer to frames FM1b to FM5b) regarding a portion (for example, a background) other than the moving object, by using a result (that is, an analysis result of the distribution situation of the luminance and the color difference in each of the same pixels among the plurality of frames (for example, in the time axis direction illustrated in FIG. 3)) of input image learning section 31. In the frames FM3 and FM4 of the captured images showing a state in which the person as a moving object carries the corrugated cardboard, values of luminance and color differences corresponding to pixels of the corrugated cardboard carried by the person change in the time axis direction (for example, refer to FIG. 3), and thus moving object dividing section 32 regards the corrugated cardboard carried by the person as a moving object.

Background image extracting section 33 extracts frames FM1b to FM5b in which the information regarding the portion other than the moving object is shown among the information pieces divided by moving object dividing section 32, as frames FM1c to FM5c for background images corresponding to frames FM1 to FM5 of the captured images output from image input section 20, and preserves the frames in background image storing section 80.

In frame FM10a of a captured image illustrated in FIG. 4A, for example, a person providing food and a person receiving the food on a tray in a restaurant are shown as moving objects. In contrast with frame FM10a of the captured image illustrated in FIG. 4A, in frame FM10c (refer to FIG. 4B) of a background image generated by background image generating section 30, the person providing the food and the person receiving the food as moving objects in the same restaurant are removed so that neither of the two persons are shown.

Moving information analyzing section 40 is configured by using, for example, a CPU, an MPU, or a DSP, and detects moving information regarding a staying position or a passing position of a moving object (for example, a person) included in the captured image for every data item (frame) regarding the captured image output from image input section 20 at a predetermined frame rate (for example, 10 fps), and preserves the background image in passing/staying analyzing information storing section 90. Object detecting section 41 performs a predetermined image process (for example, a person detection process or a face detection process) on a frame of a captured image output from image input section 20 so as to detect the presence or absence of a moving object (for example, a person) included in the frame of the captured image. In a case where a moving object included in the frame of the captured image is detected, object detecting section 41 outputs information (for example, frame coordinate information) regarding a detection region of the moving object in the frame of the captured image, to moving information obtaining section 42. In a case where a moving object included in the frame of the captured image is not detected, object detecting section 41 outputs information (for example, predetermined null information) regarding a detection region of the moving object, to moving information obtaining section 42.

Moving information obtaining section 42 associates the present and past information pieces regarding the detection region with each other by using the information regarding the captured image output from image input section 20 and the past information (for example, captured image information or coordinate information) regarding the detection region of the moving object on the basis of the information regarding the detection region of the moving object output from object detecting section 41, and outputs the association result to passing/staying situation analyzing section 43 as moving information (for example, an amount of change in the coordinate information of the detection region of the moving object).

Passing/staying situation analyzing section 43 extracts and generates, from a plurality of captured images, moving information (for example, “object position information”, “moving information”, and “information regarding a passing situation or a staying situation”) regarding a staying position or a passing position of the moving object (for example, a person) in the frame of the captured image on the basis of the moving information output from moving information obtaining section 42. Passing/staying situation analyzing section 43 may generate a color portion visualizing image of a moving information analysis image (heat map image) generated in display image generating section 350 of server 300 by using the extraction result of the moving information regarding the staying position or the passing position of the moving object (for example, a person).

By using moving information for frames of a plurality of captured images, passing/staying situation analyzing section 43 can extract and generate accurate moving information regarding a position where a moving object (for example, a person) stays or passes from the frames of the captured images which are output from image input section 20.

Schedule control section 50 is configured by using, for example, a CPU, an MPU, or a DSP, and gives, to transmitter 60, an instruction for a predetermined transmission cycle for periodically transmitting, to server 300, the background image data preserved in background image storing section 80 and the extraction result data of the moving information regarding the staying information or the passing information of the moving object preserved in passing/staying analyzing information storing section 90. The predetermined transmission cycle is, for example, 15 minutes, an hour, 12 hours, or 24 hours, and is not limited to such intervals.

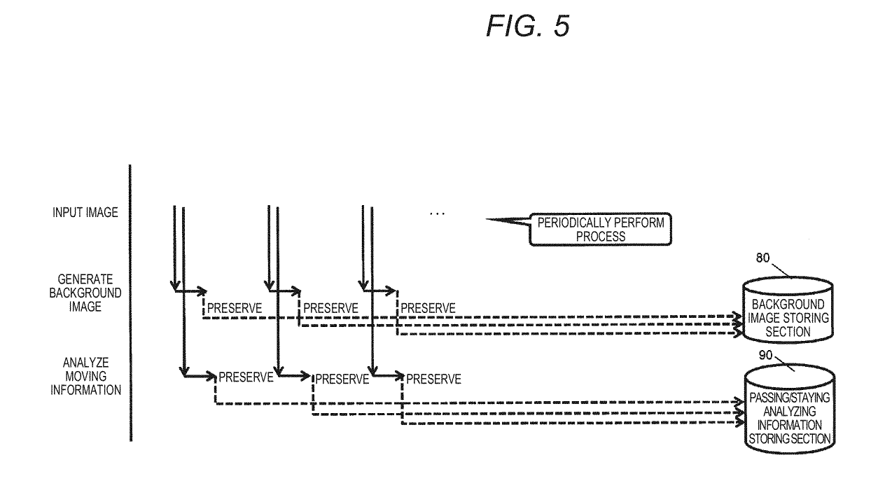

Transmitter 60 obtains and transmits the background image data preserved in background image storing section 80 and the extraction result data of the moving information regarding the staying information or the passing information of the moving object preserved in passing/staying analyzing information storing section 90 to server 300 in response to the instruction from schedule control section 50 or event information receiving section 70. Transmission timing in transmitter 60 will be described later with reference to FIGS. 5 to 8.

Event information receiving section 70 as an example of an event information obtaining section receives (obtains) a notification of detection of a predetermined event (for example, a change of a layout of a sales area of floor 1 of store A) from server 300 or input device 400, and outputs, to transmitter 60, an instruction for transmitting, to server 300, the background image data preserved in background image storing section 80 and the extraction result data of the moving information regarding the staying information or the passing information of the moving object preserved in passing/staying analyzing information storing section 90 when receiving the notification of detection of the predetermined event.

Background image storing section 80 is configured by using, for example, a semiconductor memory or a hard disk device, and stores the data (frame) regarding the background image generated by background image generating section 30.

Passing/staying analyzing information storing section 90 is configured by using, for example, a semiconductor memory or a hard disk device, and stores the extraction result data (for example, “object position information”, “moving information”, and “information regarding a passing situation or a staying situation”) of the moving information regarding the staying position or the passing position of the moving object (for example, a person), generated by moving information analyzing section 40.

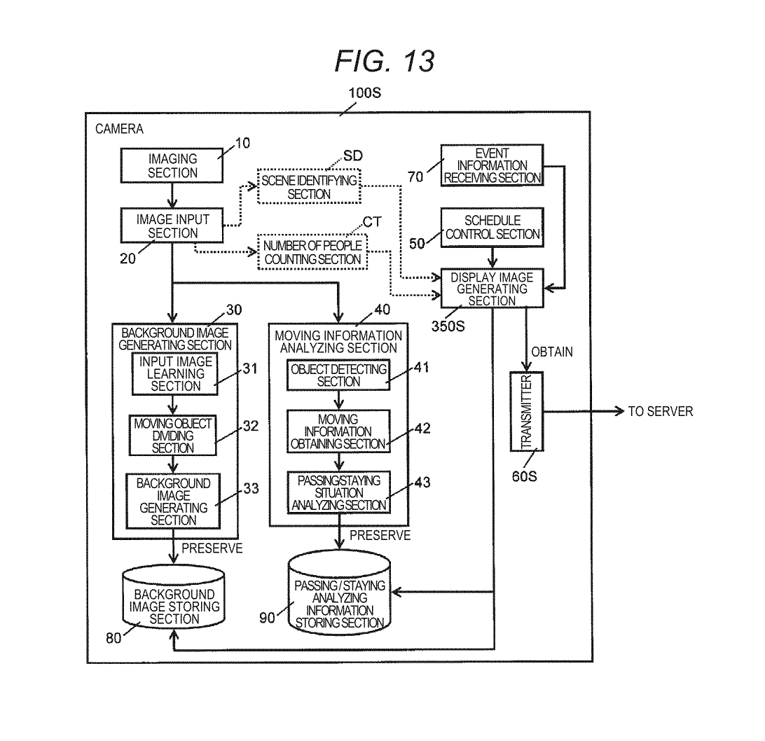

Camera 100 illustrated in FIG. 2 may be provided with scene identifying section SD which performs an operation as follows (for example, refer to FIG. 13) instead of event information receiving section 70. Scene identifying section SD as an example of an image change detecting section determines whether or not there is a change (for example, an event such as a change of a layout of a sales area of floor 1 of store A) in a captured image output from image input section 20. In a case where a change in the captured image is detected, scene identifying section SD outputs, to transmitter 60, an instruction for transmitting, to server 300, the background image data preserved in background image storing section 80 and the extraction result data of the moving information regarding the staying information or the passing information of the moving object preserved in passing/staying analyzing information storing section 90.

Camera 100 illustrated in FIG. 2 may be further provided with people counting section CT which performs an operation as follows (for example, refer to FIG. 13). People counting section CT as an example of a moving object detecting section performs a predetermined image process (for example, a person detecting process) on a captured image output from image input section 20 so as to count the number of detected moving objects included in the captured image to transmitter 60. People counting section CT outputs information regarding the number of detected moving objects included in the captured image to transmitter 60.

### Server

Server 300 illustrated in FIG. 2 includes event information receiving section 310, notifying section 320, receiver 330, received information storing section 340, display image generating section 350, and report generating output section 360.

In a case where information indicating that a predetermined event (for example, a change of a layout of a sales area of floor 1 of store A) has occurred for each corresponding camera (for example, camera 100) and is input from input device 400, event information receiving section 310 receives a notification of detection of the predetermined event. Event information receiving section 310 outputs information indicating that the notification of detection of the predetermined event has been received, to notifying section 320. The information indicating that a predetermined event has occurred includes an identification number (for example, C1, C2, . . . which will be described later) of the camera which images a location where the predetermined event has occurred as an imaging region.

Notifying section 320 transmits the notification of detection of the predetermined event, output from event information receiving section 310, to a corresponding camera (for example, camera 100).

Receiver 330 receives the data (that is, the background image data preserved in background image storing section 80 and the extraction result data of the moving information regarding the staying information or the passing information of the moving object preserved in passing/staying analyzing information storing section 90) transmitted from transmitter 60 of camera 100, and outputs the data to received information storing section 340 and display image generating section 350.

Received information storing section 340 is configured by using, for example, a semiconductor memory or a hard disk device, and stores the data (that is, the background image data preserved in background image storing section 80 and the extraction result data of the moving information regarding the staying information or the passing information of the moving object preserved in passing/staying analyzing information storing section 90) received by receiver 330.

Display image generating section 350 as an example of an image generating section is configured by using, for example, a CPU, an MPU, or a DSP, and generates a moving information analysis image in which the moving information regarding the staying position and the passing position of the moving object is superimposed on the background image by using the data (that is, the background image data preserved in background image storing section 80 and the extraction result data of the moving information regarding the staying information or the passing information of the moving object preserved in passing/staying analyzing information storing section 90) is obtained from receiver 330 or received information storing section 340.

The moving information analysis image is an image in which the moving information visually indicating a location at which a moving object stays or a location through which the moving object passes is quantitatively visualized within a predetermined range (for example, values of 0 to 255) such as in a heat map in an imaging region corresponding to a captured image on the background image obtained by removing the moving object (for example, a person) which thus is not shown from the captured image acquired by camera 100. Display image generating section 350 as an example of a display control section displays the generated moving information analysis image on monitor 450.

Report generating output section 360 as an example of a report generating section is configured by using, for example, a CPU, an MPU, or a DSP, and generates a moving information analysis report (for example, refer to FIG. 12) which will be described later in a case where an instruction for generating the moving information analysis report is input from input device 400. Report generating output section 360 as an example of a display control section displays the generated moving information analysis report on monitor 450.

Process of Transmitting Data from Camera to Server

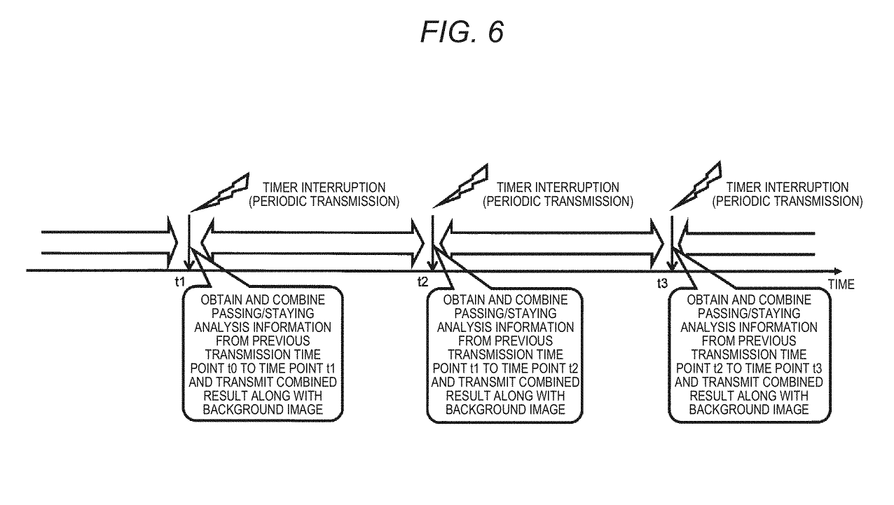

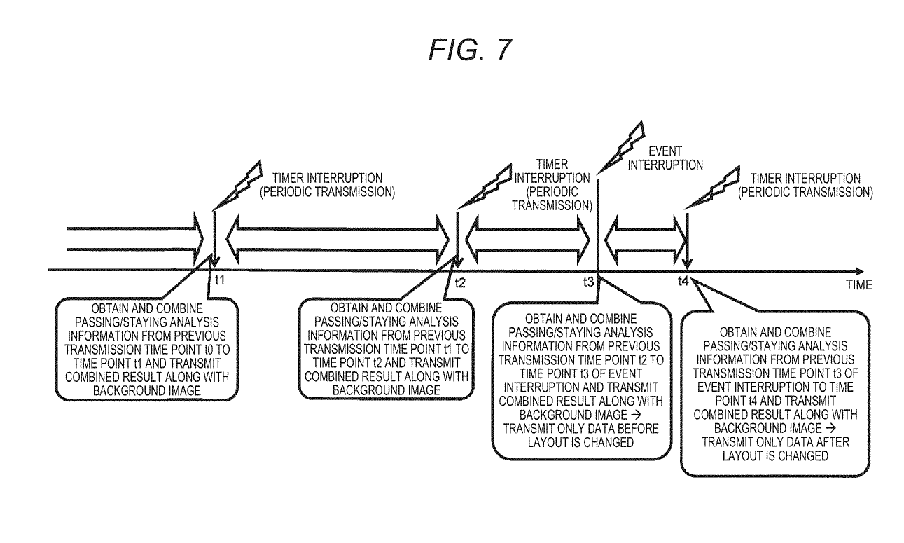

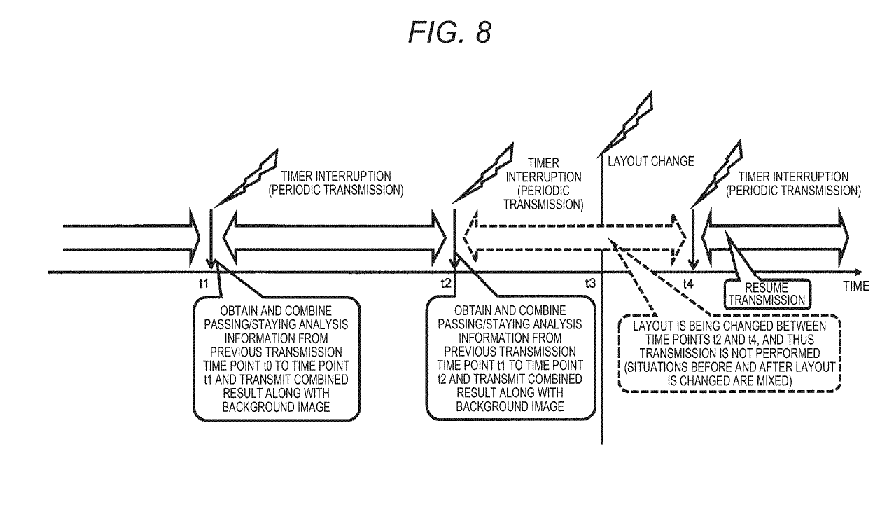

Next, with reference to FIGS. 5 to 8, a description will be made of a process of transmitting data from camera 100 to server 300. FIG. 5 is a time chart illustrating operation timings of a transmission process in camera 100 of the first exemplary embodiment. FIG. 6 is a time chart corresponding to a case where camera 100 of the first exemplary embodiment periodically performs the transmission process. FIG. 7 is a time chart corresponding to a case where camera 100 of the first exemplary embodiment changes an operation timing of the transmission process in response to detection of an event. FIG. 8 is a time chart corresponding to a case where camera 100 of the first exemplary embodiment omits the transmission process before and after an event is detected.

In FIG. 5, in camera 100, if a captured image is output from image input section 20 (image input), background image generating section 30 generates a background image of the captured image output from image input section 20 (background image generation) and preserves the background image in background image storing section 80, and moving information analyzing section 40 extracts moving information regarding a staying position or a passing position of a moving object (for example, a person) included in the captured image output from image input section 20 (moving information analysis). The respective processes such as the image input, the background image generation, and the moving information analysis are periodically and repeatedly performed.

For example, after the initial respective processes such as the image input, the background image generation, and the moving information analysis illustrated in FIG. 5 are performed, for example, as illustrated in FIG. 7, at an end point of a transmission cycle for which an instruction is given by schedule control section 50, transmitter 60 receives, for example, timer interruption from schedule control section 50, obtains the background image data preserved in background image storing section 80 and the extraction result data of the moving information regarding the staying information or the passing information of the moving object preserved in passing/staying analyzing information storing section 90 from previous transmission time point t0 to present transmission time point t1, and transmits the data to server 300 (time point t1). As described above, a periodic transmission interval (transmission cycle) in transmitter 60 is 15 minutes, an hour, 12 hours, 24 hours, or the like, and an instruction therefor is given by schedule control section 50 in advance. The background image data transmitted by transmitter 60 may be data corresponding to a single background image or may be data corresponding to a plurality of background images (for example, a plurality of background images obtained at intervals of five minutes).

Next, when the second and subsequent respective processes such as the inputting of the image input, the background image generation, and the moving information analysis illustrated in FIG. 5 are performed, for example, as illustrated in FIG. 7, at an end point of a transmission cycle for which an instruction is given by schedule control section 50, transmitter 60 receives, for example, timer interruption from schedule control section 50, obtains the background image data preserved in background image storing section 80 and the extraction result data of the moving information regarding the staying information or the passing information of the moving object preserved in passing/staying analyzing information storing section 90 from previous transmission time point t1 to present transmission time point t2, and transmits the data to server 300 (time point t2).

For example, as illustrated in FIG. 7, if a notification of detection of a predetermined event (for example, a change of a layout of a sales area of floor 1 of store A) is received from event information receiving section 70 (time point t3), transmitter 60 receives, for example, event interruption from event information receiving section 70, obtains the background image data preserved in background image storing section 80 and the extraction result data of the moving information regarding the staying information or the passing information of the moving object preserved in passing/staying analyzing information storing section 90 from previous transmission time point t2 to present transmission time point t3, and transmits the data to server 300 (time point t3). A transmission process in transmitter 60 may be performed by using not only the method illustrated in FIG. 7 but also either of the methods illustrated in FIGS. 6 and 8.

In FIGS. 6 to 8, description of the same content as that of the transmission process illustrated in FIG. 5 will be made briefly or omitted, and different content will be described. Specifically, in FIG. 6, even if event interruption is received from event information receiving section 70 at time point t3, transmitter 60 does not transmit the background image data preserved in background image storing section 80 and the extraction result data of the moving information regarding the staying information or the passing information of the moving object preserved in passing/staying analyzing information storing section 90 from previous transmission time point t2 to present transmission time point t3 to server 300 (time point t3).

However, in the transmission process illustrated in FIG. 6, in a case where a predetermined event occurs from time point t2 to time point t3, since content of a captured image is updated, different background images are used together before and after the event is detected, and thus there is a possibility that the content of a moving information analysis image may not be accurate.

Therefore, in FIG. 7, if a notification of detection of a predetermined event (for example, a change of a layout of a sales area of floor 1 of store A) from event information receiving section 70 (time point t3), transmitter 60 receives, for example, event interruption from event information receiving section 70, obtains the background image data preserved in background image storing section 80 and the extraction result data of the moving information regarding the staying information or the passing information of the moving object preserved in passing/staying analyzing information storing section 90 from previous transmission time point t2 to present transmission time point t3 at which the event interruption is received, and transmits the data to server 300 (time point t3). At an end point of a transmission cycle for which an instruction is given by schedule control section 50, transmitter 60 receives, for example, timer interruption from schedule control section 50, obtains the background image data preserved in background image storing section 80 and the extraction result data of the moving information regarding the staying information or the passing information of the moving object preserved in passing/staying analyzing information storing section 90 from previous transmission time point t3 at which the event interruption is received to present transmission time point t4, and transmits the data to server 300 (time point t4).

In FIG. 8, even if event interruption is received from event information receiving section 70 at time point t3, transmitter 60 does not transmit the background image data preserved in background image storing section 80 and the extraction result data of the moving information regarding the staying information or the passing information of the moving object preserved in passing/staying analyzing information storing section 90 from previous transmission time point t2 to present transmission time point t3 at which the event interruption is received to server 300 (time point t3). At an end point of a transmission cycle for which an instruction is given by schedule control section 50, transmitter 60 receives, for example, timer interruption from schedule control section 50, and does not transmit the background image data preserved in background image storing section 80 and the extraction result data of the moving information regarding the staying information or the passing information of the moving object preserved in passing/staying analyzing information storing section 90 from previous transmission time point t3 at which the event interruption is received to present transmission time point t4, and transmits the data to server 300 (time point t4).

In other words, in a case where the event interruption is received from event information receiving section 70 at time point t3, transmitter 60 does not transmit the background image data preserved in background image storing section 80 and the extraction result data of the moving information regarding the staying information or the passing information of the moving object preserved in passing/staying analyzing information storing section 90 from previous transmission time point t2 up to a start point (t4 in FIG. 8) of a transmission cycle after the event interruption is received, to server 300 (from time point t2 to time point t4).

In FIG. 8, for example, if timer interruption is received from schedule control section 50 (time point t4), transmitter 60 resumes transmission of the background image data preserved in background image storing section 80 and the extraction result data of the moving information regarding the staying information or the passing information of the moving object preserved in passing/staying analyzing information storing section 90 to server 300. Specifically, although not illustrated in FIG. 8, at an end point of a transmission cycle for which an instruction is given by schedule control section 50 after time point t4, transmitter 60 receives, for example, timer interruption from schedule control section 50, obtains the background image data preserved in background image storing section 80 and the extraction result data of the moving information regarding the staying information or the passing information of the moving object preserved in passing/staying analyzing information storing section 90 from time point t4 to the present transmission time point, and transmits the data to server 300.

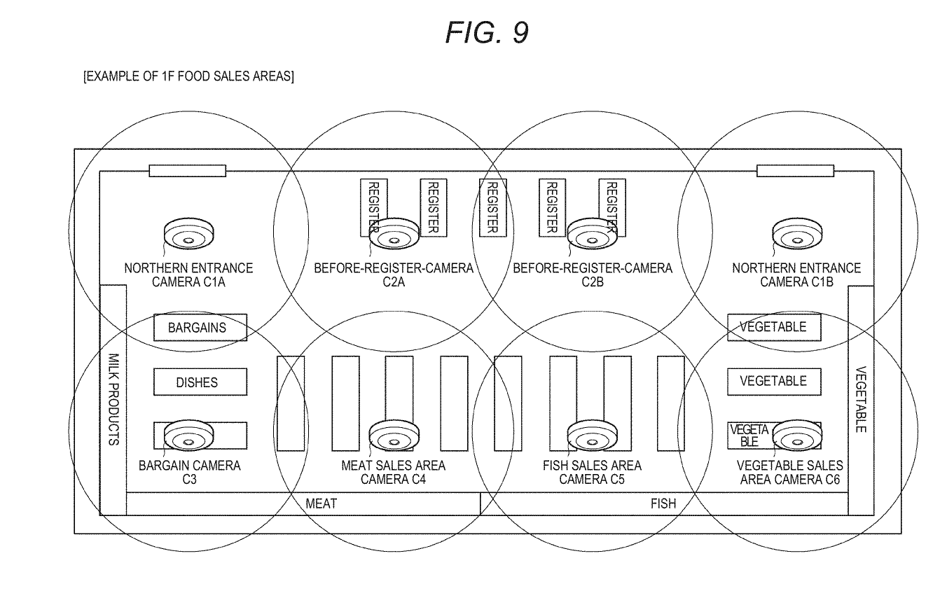

FIG. 9 is a diagram illustrating an example of a layout of a food sales area where camera 100 of the first exemplary embodiment is provided in plurality. FIG. 9 illustrates a state in which, for example, in the food sales area of floor 1 (1F) of store A, a plurality of (for example, eight) cameras are provided on a ceiling surface of floor 1. Specifically, a total of eight cameras (for example, omnidirectional cameras) including northern entrance cameras C1A and C1B, before-register-cameras C2A and C2B, bargain camera C3, meat sales area camera C4, fish sales area camera C5, and vegetable sales area camera C6 are provided. The type of camera is not limited to the omnidirectional camera, and may be a fixed camera in which a fixed angle of view is set, or may be a PTZ (pan, tilt, and zoom) camera having a panning function, a tilting function, and a zooming function.

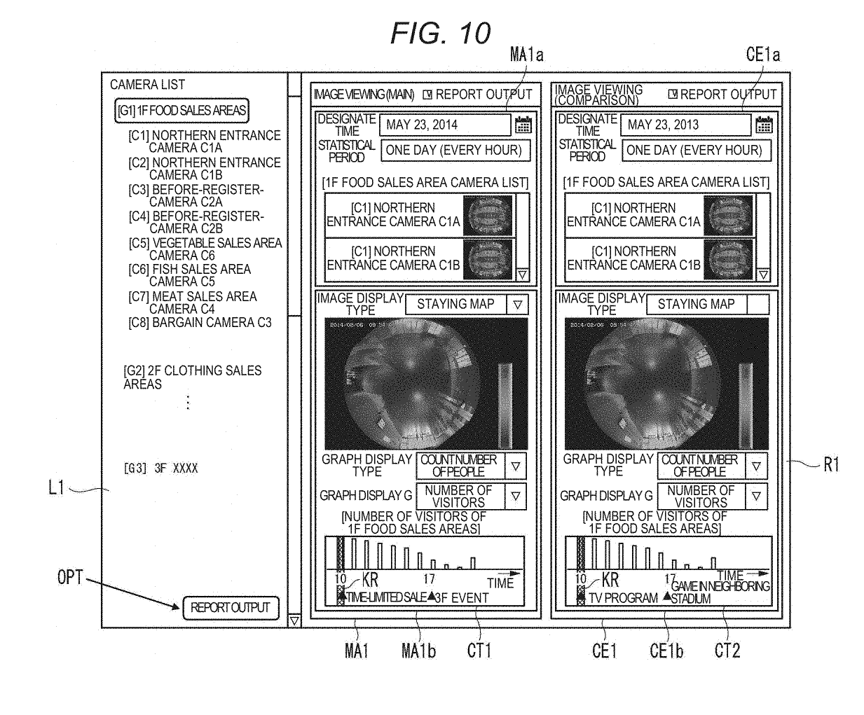

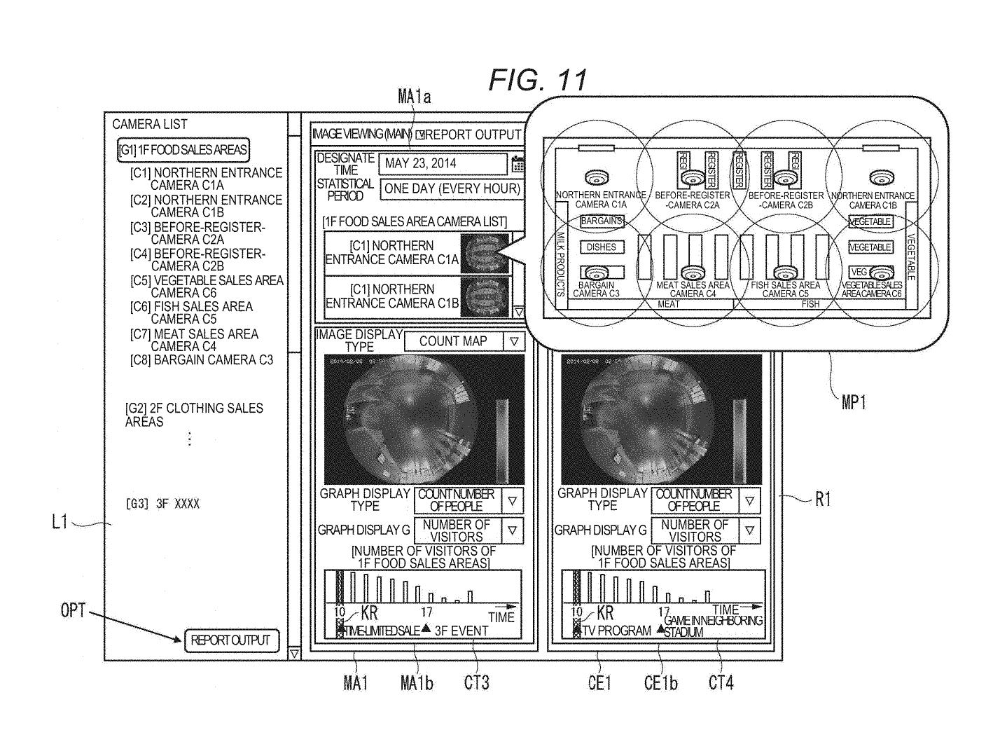

FIG. 10 is a diagram illustrating an example of an operation screen including a moving information analysis image of store A, generated by display image generating section 350 of server 300 of the first exemplary embodiment. FIG. 11 is a diagram illustrating another example of an operation screen including a moving information analysis image of store A, generated by display image generating section 350 of server 300 of the first exemplary embodiment. The operation screens illustrated in FIGS. 10 and 11 are displayed on monitor 450 by display image generating section 350.

On the operation screen illustrated in FIG. 10, a list of screens for selecting the cameras provided in the store is hierarchically shown in left display region L1. For example, in the food sales area (identification number: G1) of floor 1 (1F), northern entrance camera CIA (identification number: C1), northern entrance camera C1B (identification number: C2), before-register-camera C2A (identification number: C3), before-register-camera C2B (identification number: C4), vegetable sales area camera C6 (identification number: C5), fish sales area camera C5 (identification number: C6), meat sales area camera C4 (identification number: C7), and bargain camera C3 (identification number: C8) are shown hierarchically. This is also the same for a clothing sales area of floor 2 (2F) and other sales areas, and thus description thereof will be omitted.

On the operation screen illustrated in FIG. 10, display region MA1 of main (for example, present) moving information analysis information and display region CE1 of subsidiary (for example, comparison) moving information analysis information are displayed in right display region R1.

In display region MA1 of moving information analysis information, a designated condition display region MA1a including a designated time (including the date) at which server 300 generates a viewing object moving information analysis image, a statistical period indicating, for example, the unit of half a day, the unit of a day, the unit of one week, or the unit of one month, and a screen for selecting the cameras of each sales area selected in display region L1, and moving information analysis result display region MA1b including an image display type of a moving information analysis image, a graph display type, a graph display G (group), and display region CT1 of the number of visitors of each sales area, are displayed.

The image display type of a moving information analysis image includes a staying map, illustrated in FIG. 10, in which staying information of a moving object (for example, a person) is shown, a count map, illustrated in FIG. 11, in which passing information of a moving object (for example, a person) is shown, and captured images thereof. The number of moving objects (for example, persons) detected by people counting section CT in time series (for example, every hour in FIGS. 10 and 11) is shown in display region CT1 of the number of visitors of each sales area. For example, if input device 400 shifts selection bar KR displayed in display region CT1 of the number of visitors of each sales area in the time direction through a user's input operation, display image generating section 350 sequentially displays moving information analysis images which are generated at time points indicated by selection bar KR.

As illustrated in FIG. 11, instead of the screen for selecting the cameras of each sales area in display region MA1 of moving information analysis information, an example of layout MP1 in which the plurality of cameras illustrated in FIG. 9 are provided in each sales area may be displayed.

Similarly, on display region CE1 of subsidiary moving information analysis information, a designated condition display region CE1a including a designated time (including the date) at which server 300 generates a viewing object moving information analysis image as display region MA1 of main moving information analysis information, a statistical period indicating, for example, the unit of half a day, the unit of a day, the unit of one week, or the unit of one month, and a screen for selecting the cameras of each sales area selected in display region MA1 of main moving information analysis information, and moving information analysis result display region CE1b including an image display type of a moving information analysis image, a graph display type, a graph display G (group), and display region CT2 of the number of visitors of each sales area, are displayed. In a case of using display region CE1 of subsidiary moving information analysis information, for example, not only comparison between states before and after a layout in the store is changed but also usage such as comparison between states before and after a discount seal is attached to merchandise, comparison between states before and after a time-limited sale is performed, comparison between a date and the same date in the previous year, and comparison between stores (for example, and comparison between a meat sales area of store A and a meat sales area of the store B) may be included.

The number of moving objects (for example, persons) detected by people counting section CT in a time series (for example, every hour in FIGS. 10 and 11) is shown in display region CT2 of the number of visitors of each sales area. For example, if input device 400 shifts selection bar KR displayed in display region CT2 of the number of visitors of each sales area in the time direction through a user's input operation, display image generating section 350 sequentially reproduces and displays moving information analysis images which are generated at time points indicated by selection bar KR.

Input device 400 can designate a specific time zone on the time axis and can input a comment (for example, a time-limited sale, a 3F event, a TV program, and a game in a neighboring stadium), through a user's input operation, to display region CT1 of the number of visitors of each sales area of display region MA1 of main (for example, present) moving information analysis information and display region CT2 of the number of visitors of each sales area of display region CE1 of subsidiary (for example, comparison) moving information analysis information.

In FIG. 11, the remaining content is the same as that described with reference to FIG. 10 except that the image display type is a count map, and thus detailed description thereof will be omitted. In the same manner as in FIG. 10, also in FIG. 11, for example, if input device 400 shifts selection bar KR displayed in each of display regions CT3 and CT4 of the number of visitors of each sales area in the time direction through a user's input operation, display image generating section 350 sequentially reproduces and displays moving information analysis images which are generated at time points indicated by selection bar KR.

FIG. 12 is a diagram illustrating an example of operation screen RPT of a monthly report related to a food sales area of store A, dated in May, 2014, generated by report generating output section 360 of server 300 of the first exemplary embodiment. The monthly report (refer to FIG. 12) as an example of a moving information analysis report of the first exemplary embodiment is a screen which is generated by report generating output section 360 and is displayed on monitor 450 when report output button OPT provided on the lower part of left display region L1 of the operation screen illustrated in FIG. 10 or FIG. 11 is pressed via input device 400. Report generating output section 360 of server 300 may output the monthly report illustrated in FIG. 12 or partial information thereof (for example, a monthly report of a meat sales area among the food sales areas) from a printer (not illustrated) provided in store A. Consequently, a salesperson in store A can receive the printed and distributed monthly report of, for example, all the food sales areas or the meat sales area as a part thereof, in the form of a moving information analysis image in which a visitor is not shown being output.

The operation screen RPT of the monthly report (the moving information analysis report) illustrated in FIG. 12 shows various information pieces including a title of the monthly report, information regarding an atmospheric temperature, display region SR1 related to sales information, display region CR1 related to statistical information such as the number of visitors of a store (for example, store A), display regions of moving information analysis images HM5 and HM6 generated by display image generating section 350 before and after a layout of the sales area is changed as an example of a predetermined event, and display regions CT5 and CT6 of the number of visitors of each sales area. The various information pieces regarding the title of the monthly report, the information regarding the atmospheric temperature, the sales information, the event information, the information regarding a configuration of the visitors, and the like are transmitted, for example, from server 600 of the operation center to a server (for example, server 300) of a corresponding store (for example, store A). The various information pieces regarding the title of the monthly report, the information regarding the atmospheric temperature, the sales information, the event information, the information regarding a configuration of the visitors, and the like may be stored in server 300 or a storing section (not illustrated) of the store in advance.

Also in the operation screen RPT of the monthly report illustrated in FIG. 12, in the same manner as in FIG. 10 or FIG. 11, for example, if input device 400 shifts selection bar KR displayed in each of display regions CT5 and CT6 of the number of visitors of each sales area in the time direction through a user's input operation, display image generating section 350 sequentially displays moving information analysis images which are generated at time points indicated by selection bar KR.

As mentioned above, in moving information analyzing system 500A of the first exemplary embodiment, camera 100 generates a background image of a captured image of a predetermined imaging region, extracts moving information regarding a staying position or a passing position in the imaging region of a moving object (for example, a person) included in the captured image, and transmits the background image of the captured image and the moving information of the moving object to server 300 at a predetermined transmission cycle. Server 300 generates a moving information analysis image in which the moving information of the moving object is superimposed on the background image of the captured image, and displays the moving information analysis image on monitor 450.

Consequently, moving information analyzing system 500A generates the background image which is a base of the moving information analysis image so that the moving object (for example, a person) is removed so as not to be shown therein, and can thus appropriately protect the privacy of the moving object (the person) shown in an imaging region when a moving information analysis image is generated. Since moving information analyzing system 500A superimposes the moving information regarding the staying position or the passing position in the imaging region of the moving object (the person) on the background image which has already been updated at a predetermined timing (for example, the time at which a periodic transmission cycle arrives), it is possible to visually display a moving information analysis image which appropriately indicates accurate moving information regarding the staying position or the passing position in the imaging region of the moving object to a user in a predefined transmission cycle in a state in which the moving object is removed from the captured image.

Since moving information analyzing system 500A gives, to schedule control section 50 of the camera, an instruction for a predetermined transmission cycle for transmitting a background image and moving information of a moving object, it is possible to periodically transmit the background image and the moving information of the moving object to server 300 according to the transmission cycle for which the instruction is given in advance.

Since moving information analyzing system 500A transmits a background image and moving information of a moving object to server 300 when receiving a notification of detection of a predetermined event (for example, an event such as a change of a layout of a sales area in a store) from event information receiving section 70, server 300 can generate a moving information analysis image in which moving information regarding staying positions or passing positions of a moving object in an imaging region before and after the time at which the predetermined event is detected is accurately reflected.

Since moving information analyzing system 500A transmits a background image and moving information of a moving object to server 300 when scene identifying section SD detects a change (for example, a change of a layout of a sales area in a store) in a captured image, server 300 can generate a moving information analysis image in which moving information regarding staying positions or passing positions of a moving object in an imaging region before and after the time at which the change in the captured image is detected is accurately reflected.

In moving information analyzing system 500A, since people counting section CT counts the number of detected moving objects included in a captured image and outputs information regarding the number of detected moving objects to transmitter 60, it is possible to display a moving information analysis image including information regarding staying positions or passing positions of a moving object in an imaging region and a display screen (operation screen) including the number of detected moving objects on monitor 450.

Since moving information analyzing system 500A does not transmit a background image and moving information of a moving object in a transmission cycle including the time at which event information receiving section 70 receives a notification of detection of a predetermined event, it is possible to prevent moving information pieces regarding staying positions or passing positions of a moving object in an imaging region before and after the predetermined event (for example, a change of a layout of a sales area in a store) is detected from being used together when server 300 generates a moving information analysis image.

In moving information analyzing system 500A, since report generating output section 360 generates a moving information analysis report including a moving information analysis image generated before detecting a predetermined event (for example, a change of a layout of a sales area in a store) and a moving information analysis image generated after detecting the same event, it is possible to show how moving information regarding a staying position or a passing position of a moving object in an imaging region changes due to the predetermined event in contrasted and easily understandable manner.

In moving information analyzing system 500A, a generated moving information analysis report is displayed on monitor 450 through a predetermined input operation (for example, a user's operation of pressing the report output button), and thus the moving information analysis report can be visually displayed to the user.

In moving information analyzing system 500A, since respective cameras 100, 100A, . . . , and 100N perform generation of a background image of a captured image and extraction of moving information regarding a staying position or a passing position of a moving object included in the captured image, and then server 300 generates and displays a moving information analysis image, a processing load on server 300 can be reduced when compared with a case where server 300 performs generation of a background image of a captured image and extraction of moving information regarding a staying position or a passing position of a moving object included in the captured image, and thus it is possible to alleviate a limitation on the number of cameras which can be connected to single server 300.

### Modification Examples of First Exemplary Embodiment

In the above-described first exemplary embodiment, the process of generating a moving information analysis image is performed by server 300, but the process of generating a moving information analysis image may also be performed by camera 100 (refer to FIG. 13). FIG. 13 is a block diagram illustrating details of a functional internal configuration of camera 100S of a modification example of the first exemplary embodiment. Camera 100S illustrated in FIG. 13 includes imaging section 10, image input section 20, background image generating section 30, moving information analyzing section 40, schedule control section 50, transmitter 60S, event information receiving section 70, background image storing section 80, passing/staying analyzing information storing section 90, and display image generating section 350S. In description of each section of camera 100S illustrated in FIG. 13, constituent elements having the same configuration and operation as those of camera 100 illustrated in FIG. 2 are given the same reference numerals, and description thereof will be omitted, and differing content will be described.

Display image generating section 350S as an example of an image generating section generates a moving information analysis image in which moving information regarding a staying position and a passing position of a moving object is superimposed on a background image by using background image data preserved in background image storing section 80 and extraction result data of the moving information regarding the staying information or the passing information of the moving object preserved in passing/staying analyzing information storing section 90 in response to an instruction from schedule control section 50 or event information receiving section 70, and outputs the moving information analysis image to transmitter 60.

Transmitter 60S transmits data on the moving information analysis image generated by display image generating section 350S to server 300.

As described above, in the modification example of the first exemplary embodiment, camera 100S generates a background image of a captured image of a predetermined imaging region, extracts moving information regarding a staying position or a passing position in the imaging region of a moving object (for example, a person) included in the captured image, and generates a moving information analysis image in which the moving information of the moving object is superimposed on the background image of the captured image by using the background image of the captured image and the moving information of the moving object. Consequently, camera 100S generates the background image which is a base of the moving information analysis image so that the moving object (for example, a person) is removed so as not to be shown therein, and can thus appropriately protect privacy of the moving object (the person) shown in an imaging region when a moving information analysis image is generated. Since camera 100S superimposes the moving information regarding the staying position or the passing position in the imaging region of the moving object (the person) on a captured image which is obtained in real time, it is possible to generate a moving information analysis image which appropriately indicates the latest moving information regarding the staying position or the passing position in the imaging region of the moving object in a state in which the moving object is removed from the captured image.

Since camera 100S performs a process up to a point of generating a moving information analysis image and transmits moving information analysis image data which is a result of the process to server 300, for example, server 300 may not perform the process of generating a moving information analysis image in a state in which a processing load on server 300 is considerably high, and thus it is possible to minimize an increase in the processing load on server 300.

Here, a description will be made of each of configurations, operations, and effects of the moving information analyzing system, the camera, and the moving information analyzing method according to the present disclosure.

According to an exemplary embodiment of the present disclosure, there is provided a moving information analyzing system including a camera; and a server that is connected to the camera, in which the camera includes an imaging section that captures an image of a predetermined imaging region; a background image generating section that generates a background image of the captured image of the imaging region; a moving information analyzing section that extracts moving information regarding a staying position or a passing position of a moving object included in the captured image in the imaging region; and a transmitter that transmits the background image generated by the background image generating section and the moving information of the moving object extracted by the moving information analyzing section to the server in a predetermined transmission cycle, and in which the server includes an image generating section that generates a moving information analysis image in which the moving information of the moving object is superimposed on the background image of the captured image; and a display control section that displays the moving information analysis image generated by the image generating section on a display section.

In this configuration, the camera generates a background image of a captured image of a predetermined imaging region, extracts moving information regarding a staying position or a passing position of a moving object (for example, a person) included in the captured image in the imaging region, and transmits the background image the captured image and the moving information of the moving object to the server in a predetermined transmission cycle. The server generates a moving information analysis image in which the moving information of the moving object is superimposed on the background image of the captured image, and displays the moving information analysis image on a display section.

Consequently, the moving information analyzing system generates the background image which is a base of the moving information analysis image so that the moving object (for example, a person) is removed so as not to be shown therein, and can thus appropriately protect the privacy of the moving object (the person) shown in an imaging region when a moving information analysis image is generated. Since the moving information analyzing system superimposes the moving information regarding the staying position or the passing position in the imaging region of the moving object (the person) on the background image which has already been updated at a predetermined timing (for example, the time at which a periodic transmission cycle arrives), it is possible to visually display a moving information analysis image which appropriately indicates accurate moving information regarding the staying position or the passing position in the imaging region of the moving object to a user in a predefined transmission cycle in a state in which the moving object is removed from the captured image. According to the exemplary embodiment of the present disclosure, in the moving information analyzing system, the camera further include a schedule control section that gives an instruction for the predetermined transmission cycle for transmitting the background image and the moving information of the moving object to the transmitter. According to this configuration, since the moving information analyzing system gives, to the schedule control section of the camera, an instruction for a predetermined transmission cycle for transmitting a background image and moving information of a moving object, it is possible to periodically transmit the background image and the moving information of the moving object to the server according to the transmission cycle for which the instruction is given in advance.

According to the exemplary embodiment of the present disclosure, in the moving information analyzing system, the camera further an event information obtaining section that obtains a notification of detection of a predetermined event, and the event information obtaining section gives an instruction for a transmission timing of the background image and the moving information of the moving object to the transmitter after a notification of detection of the predetermined event is obtained.

According to this configuration, since the moving information analyzing system transmits a background image and moving information of a moving object to the server when the even information obtaining section obtains a notification of detection of a predetermined event (for example, an event such as a change of a layout of a sales area in a store), the server can generate a moving information analysis image in which moving information regarding staying positions or passing positions of a moving object in an imaging region before and after the time at which a specific event is detected is accurately reflected.

According to the exemplary embodiment of the present disclosure, in the moving information analyzing system, the camera further includes an image change detecting section that detects a change in the captured image, and the image change detecting section gives an instruction for a transmission timing of the background image and the moving information of the moving object to the transmitter after a change in the captured image is detected.

According to this configuration, since the moving information analyzing system transmits a background image and moving information of a moving object to the server when the image change detecting section detects a change (for example, a change of a layout of a sales area in a store) in a captured image, the server can generate a moving information analysis image in which moving information regarding staying positions or passing positions of a moving object in an imaging region before and after the time at which the change in the captured image is detected is accurately reflected. According to the exemplary embodiment of the present disclosure, in the moving information analyzing system, the camera further includes a moving object counting section that counts the number of detected moving objects included in the captured image, and the moving object counting section outputs information regarding the number of detected moving objects included in the captured image to the transmitter.

According to this configuration, in the moving information analyzing system, since the moving object counting section counts the number of detected moving objects included in a captured image and outputs information regarding the number of detected moving objects to the transmitter, it is possible to display a moving information analysis image including information regarding staying positions or passing positions of a moving object in an imaging region and a display screen (operation screen) including the number of detected moving objects on the display section.

According to the exemplary embodiment of the present disclosure, in the moving information analyzing system, the transmitter omits transmission of the background image and the moving information of the moving object in the predetermined transmission cycle including the time at which the event information obtaining section obtains a notification of detection of the predetermined event. According to this configuration, since the moving information analyzing system does not transmit a background image and moving information of a moving object in a transmission cycle including the time at which the event information obtaining section obtains a notification of detection of a predetermined event, it is possible to prevent moving information pieces regarding staying positions or passing positions of a moving object in an imaging region before and after the predetermined event (for example, a change of a layout of a sales area in a store) is detected from being used together when the server generates a moving information analysis image.

According to the exemplary embodiment of the present disclosure, in the moving information analyzing system, the server further includes a report generating section that generates a moving information analysis report including the moving information analysis image generated by the image generating section before the predetermined event is detected and the moving information analysis image generated by the image generating section after the predetermined event is detected.

According to this configuration, in the moving information analyzing system, since the report generating section generates a moving information analysis report including a moving information analysis image generated before detecting a predetermined event (for example, a change of a layout of a sales area in a store) and a moving information analysis image generated after detecting the same predetermined event, it is possible to show how moving information regarding a staying position or a passing position of a moving object in an imaging region changes due to the predetermined event in contrasted and easily understandable manner.

According to the exemplary embodiment of the present disclosure, in the moving information analyzing system, the report generating section displays the moving information analysis report on the display section in response to a predetermined input operation.

According to this configuration, in the moving information analyzing system, a generated moving information analysis report is displayed on the display section through a predetermined input operation (for example, a user's operation of pressing a report output button), and thus the moving information analysis report can be visually displayed to the user.

According to an exemplary embodiment of the present disclosure, there is provided a camera including an imaging section that captures an image of a predetermined imaging region; a background image generating section that generates a background image of the captured image of the imaging region; a moving information analyzing section that extracts moving information regarding a staying position or a passing position of a moving object included in the captured image in the imaging region; and an image generating section that generates a moving information analysis image in which the moving information of the moving object is superimposed on the background image of the captured image by using the background image generated by the background image generating section and the moving information of the moving object extracted by the moving information analyzing section.

According to this configuration, the camera generates a background image of a captured image of a predetermined imaging region, extracts moving information regarding a staying position or a passing position in the imaging region of a moving object (for example, a person) included in the captured image, and generates a moving information analysis image in which the moving information of the moving object is superimposed on the background image of the captured image by using the background image of the captured image and the moving information of the moving object.

Consequently, the camera generates the background image which is a base of the moving information analysis image so that the moving object (for example, a person) is removed so as not to be shown therein, and can thus appropriately protect privacy of the moving object (the person) shown in an imaging region when a moving information analysis image is generated. Since the camera superimposes the moving information regarding the staying position or the passing position in the imaging region of the moving object (the person) on a captured image which is already updated at the time of a predetermined timing (for example, the time at which a periodic transmission cycle arrives), it is possible to generate a moving information analysis image which appropriately indicates accurate moving information regarding the staying position or the passing position in the imaging region of the moving object in a state in which the moving object is removed from the captured image.

According to an exemplary embodiment of the present disclosure, there is provided a moving information analyzing method for a moving information analyzing system in which a camera and a server that is connected to each other, the method including causing the camera to captures an image of a predetermined imaging region, to generate a background image of the captured image of the imaging region, to extract moving information regarding a staying position or a passing position of a moving object included in the captured image in the imaging region, and to transmit the generated background image and the moving information of the extracted moving object to the server in a predetermined transmission cycle; and causing the server to generate a moving information analysis image in which the moving information of the moving object is superimposed on the background image of the captured image, and to display the generated moving information analysis image on a display section.

In this method, the camera generates a background image of a captured image of a predetermined imaging region, extracts moving information regarding a staying position or a passing position of a moving object (for example, a person) included in the captured image in the imaging region, and transmits the background image of the captured image and the moving information of the moving object to the server in a predetermined transmission cycle. The server generates a moving information analysis image in which the moving information of the moving object is superimposed on the background image of the captured image, and displays the moving information analysis image on a display section.

Consequently, the moving information analyzing system generates the background image which is a base of the moving information analysis image so that the moving object (for example, a person) is removed so as not to be shown therein, and can thus appropriately protect the privacy of the moving object (the person) shown in an imaging region when a moving information analysis image is generated. Since the moving information analyzing system superimposes the moving information regarding the staying position or the passing position in the imaging region of the moving object (the person) on the background image which has already been updated at a predetermined timing (for example, the time at which a periodic transmission cycle arrives), it is possible to visually display a moving information analysis image which appropriately indicates accurate moving information regarding the staying position or the passing position in the imaging region of the moving object to a user in a predefined transmission cycle in a state in which the moving object is removed from the captured image.

### Second Exemplary Embodiment

Next, a description will be made of examples of cameras 100P and 100Q and servers 300P and 300Q forming a moving information analyzing system according to a second exemplary embodiment with reference to the drawings. Cameras 100P and 100Q and servers 300P and 300Q of the present exemplary embodiment are other examples of cameras and servers replacing camera 100 and server 300 forming moving information analyzing systems 500A, 500B, . . . of the above-described first exemplary embodiment. Thus, cameras 100P and 100Q and servers 300P and 300Q of the present exemplary embodiment also function as the camera and server forming moving information analyzing systems 500A, 500B, . . . illustrated in FIG. 1, and the description related to FIG. 1 is also to the present exemplary embodiment.

### Camera

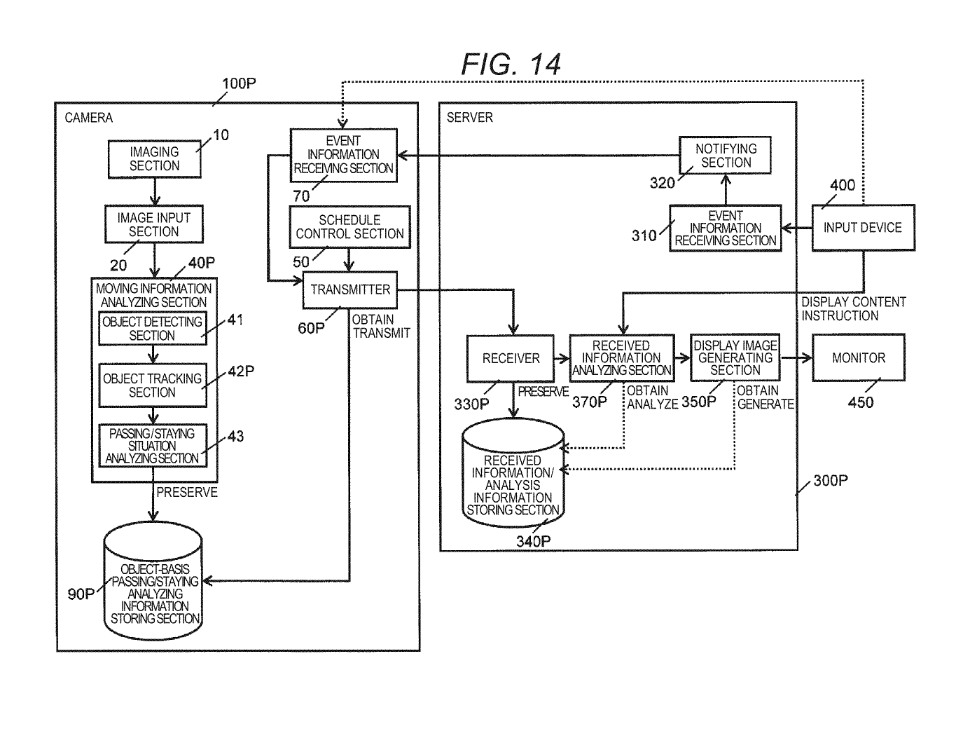

FIG. 14 is a block diagram illustrating details of a first example of a functional internal configuration of each of a camera and a server of a second exemplary embodiment. In camera 100P illustrated in FIG. 14, background image generating section 30 and background image storing section 80 are omitted from camera 100 illustrated in FIG. 2, moving information analyzing section 40, passing/staying analyzing information storing section 90, and transmitter 60 are respectively replaced with moving information analyzing section 40P, object-basis passing/staying analyzing information storing section 90P, and transmitter 60P, and other configurations are the same as those of camera 100. Therefore, in the following description of camera 100P illustrated in FIG. 14, the same constituent elements as those of camera 100 illustrated in FIG. 2 are given the same reference numerals, and description thereof will be omitted, and differing content will be described. FIG. 14 illustrates only single camera 100P, but a plurality of cameras may be connected to server 300P.

Camera 100P illustrated in FIG. 14 includes imaging section 10, image input section 20, moving information analyzing section 40P, schedule control section 50, transmitter 60P, event information receiving section 70, and object-basis passing/staying analyzing information storing section 90P. Moving information analyzing section 40P includes object detecting section 41, object tracking section 42P, and passing/staying situation analyzing section 43. Camera 100P may include background image generating section 30 and background image storing section 80. Hereinafter, a monitoring region (for example, a merchandise display shelf, a special merchandise sales area, or a register counter in a store, or a doorway of the store) imaged by respective cameras 100P and 100Q will be referred to as an “object region”. In other words, the object region is included in an angle of view of camera 100P.

Moving information analyzing section 40P is configured by using, for example, a CPU, an MPU, or a DSP, and detects moving information regarding a staying position or a passing position of a person for each moving object (for example, a person such as a customer or a salesperson) included in a captured image for every data item (frame) for the captured image output from image input section 20 at a predetermined frame rate (for example, 10 frames per second (fps)), and preserves the moving information in object-basis passing/staying analyzing information storing section 90P. In the following description, the moving information output from moving information analyzing section 40P or 40Q may include any one of “moving information regarding a staying position of each person”, “moving information regarding a passing position of each person”, and “moving information regarding a staying position and a passing position of each person”.

In a case where at least one moving object (for example, a person such as a customer or a salesperson) included in a frame of the captured image is detected, object detecting section 41 outputs information regarding the person and information regarding a detection region of the person (for example, coordinate information for each person in the frame) to object tracking section 42P for each person in the frame of the captured image. In a case where a person is not detected in the frame of the captured image, object detecting section 41 outputs, for example, predetermined null information to object tracking section 42P as the information regarding a detection region of a person.

Object tracking section 42P tracks moving information of each person from the past detection region to the present detection region in an object region (for example, the inside of the store) by using respective pieces of feature amount information corresponding to a plurality of frames of the captured image output from the image input section 20 on the basis of the information regarding the moving object (for example, a person such as a customer or a salesperson) and information regarding the detection region of each person output from object detecting section 41, and outputs the tracked information to passing/staying situation analyzing section 43 as moving information (for example, a change amount of coordinate information of the detection region of each person).

Passing/staying situation analyzing section 43 extracts and generates moving information regarding a staying position or a passing position of each moving object (for example, a person such as a customer or a salesperson) in a frame of the captured image on the basis of the moving information output from object tracking section 42P with respect to a plurality of captured images.

Passing/staying situation analyzing section 43 may generate a visualized image of a color portion of a moving information analysis image (heat map image) generated by display image generating section 350 of server 300, by using an extraction result of the moving information regarding the staying position or the passing position of each person.

Passing/staying situation analyzing section 43 analyzes a plurality of captured images in a time series, and can thus extract and generate accurate moving information regarding a position where a person has stayed or passed in an object region (for example, the inside of the store) for each moving object (for example, a person such as a customer or a salesperson) in frames of the captured images output from image input section 20. The time-series analysis of a plurality of captured images indicates that a position where a moving object has stayed or passed is analyzed in a time series by using an output from object tracking section 42P.

Object-basis passing/staying analyzing information storing section 90P is configured by using, for example, a semiconductor memory or a hard disk device, and stores extraction result data of moving information regarding a staying position or a passing position of a customer for each moving object (for example, a customer) generated by moving information analyzing section 40P. A moving information preservation period (for example, a week) in object-basis passing/staying analyzing information storing section 90P is set in the extraction result data of moving information in order to prevent an increase in a storage capacity of object-basis passing/staying analyzing information storing section 90P. The moving information stored in object-basis passing/staying analyzing information storing section 90P is moving information regarding a staying position or a passing position of each person detected in an object region.

Transmitter GOP acquires the captured image data generated by image input section 20 and the extraction result data of the moving information regarding the staying position or the passing position of each moving object (for example, a customer) stored in object-basis passing/staying analyzing information storing section 90P in response to an instruction from schedule control section 50 or event information receiving section 70, and transmits the data to server 300P. Only a single captured image is not transmitted from transmitter 60P, and, as will be described later, captured images corresponding to a period of a transmission cycle in transmitter 60P are assumed to be transmitted so that a video of an object region formed of a plurality of captured images can be displayed on monitor 450. A transmission timing in transmitter 60P is the same as in FIGS. 5 to 8, and thus a description thereof will be omitted. Arrows between transmitter 60P and image input section 20 are not illustrated in order to simplify FIG. 14.

### Server

In server 300P illustrated in FIG. 14, report generating output section 360 is omitted from server 300 illustrated in FIG. 2, received information analyzing section 370P is added thereto, receiver 330, received information storing section 340, and display image generating section 350 are respectively replaced with receiver 330P, received information/analysis information storing section 340P, and display image generating section 350P, and other configurations are the same as those of server 300.

Therefore, in the following description of server 300P illustrated in FIG. 14, constituent elements having the same configuration and operation as those of server 300 illustrated in FIG. 2 are given the same reference numerals, and description thereof will be omitted, and differing content will be described.

Server 300P illustrated in FIG. 14 includes event information receiving section 310, notifying section 320, receiver 330P, received information/analysis information storing section 340P, received information analyzing section 370P, and display image generating section 350P. Server 300P may include report generating output section 360.

Receiver 330P receives data (that is, the captured image data generated by image input section 20 and the extraction result data of the moving information regarding the staying information or the passing information of each moving object (for example, a person such as a customer or a salesperson) preserved in object-basis passing/staying analyzing information storing section 90P) transmitted from transmitter 60P of camera 100P, and stores the data in received information/analysis information storing section 340P. Receiver 330P may output the data transmitted from transmitter 60P of camera 100P, to received information analyzing section 370P. Hereinafter, the data which is video by receiver 330P and is transmitted from transmitter 60P will be referred to as “received data”.

Received information/analysis information storing section 340P is configured by using, for example, a semiconductor memory or a hard disk device, and stores the received data. The received data is read by received information analyzing section 370P. Received information/analysis information storing section 340P stores an analysis result (that is, an analysis result of received data corresponding to a display content instruction from input device 400) from received information analyzing section 370P. The analysis result is read by display image generating section 350P.

Received information analyzing section 370P is configured by using, for example, a CPU, an MPU, or a DSP, and reads the received data from received information/analysis information storing section 340P in a case of receiving a display content instruction for displaying a moving information analysis image including moving information of each moving object (for example, a person such as a customer or a salesperson) satisfying a selection condition regarding a specific behavior from input device 400, for example, in response to a user's operation. Received information analyzing section 370P analyzes the received data, extracts moving information of each moving object (for example, a person such as a customer or a salesperson) conforming to the display content instruction from input device 400 from the received data, and stores an analysis result which is an extraction result in received information/analysis information storing section 340P.

Here, the specific behavior is, for example, a behavior in which a person uniformly has passed all sales corners in a store as an object region, a behavior in which a person has stayed at a specific sales corners among all of the sales corners in the store as object regions, and a behavior in which a person has stayed at only a specific sales corner among all of the sales corners in the store as object regions and has passed other sales corners. However, the specific behavior is not limited to such behaviors.

Display image generating section 350P is configured by using, for example, a CPU, an MPU, or a DSP, and generates a moving information analysis image (heat map image) in which the moving information regarding the staying position or the passing position of each moving object (for example, a person such as a customer or a salesperson) corresponding to the analysis result is superimposed on the captured image by using the analysis result in received information analyzing section 370P from received information/analysis information storing section 340P and the captured image data included in the received data.

Unlike the moving information analysis image generated in the first exemplary embodiment, the moving information analysis image generated by display image generating section 350P is an image in which moving information of a moving object (for example, a person such as a customer or a salesperson) having performed the specific behavior is superimposed on a captured image in response to a display content instruction output from input device 400. In other words, the moving information analysis image of the present exemplary embodiment is an image in which moving information indicating a staying position or a passing position of each person having performed the specific behavior which is truly desired by a user (for example, a manager of the store) operating input device 400 is quantitatively visualized within a predetermined range (for example, values of 0 to 255) such as in a heat map on a captured image obtained by camera MP. Display image generating section 350P displays the generated moving information analysis image on monitor 450. However, display image generating section 350P may generate the moving information analysis image (that is, an image in which moving information of all persons detected by camera 100 is superimposed) generated by display image generating section 350 in the first exemplary embodiment.

In the present exemplary embodiment, the moving information analysis image is described as an image in which moving information of each moving object (for example, a person such as a customer or a salesperson) having performed the specific behavior is superimposed on a captured image obtained by camera 100P or 100Q. However, data on which moving information is superimposed is not limited to a captured image. For example, the moving information extracted by received information analyzing section 370P or 370Q may be superimposed on the background image of the captured image described in the first exemplary embodiment. In this case, camera 100P or 100Q includes background image generating section 30. Data on which moving information is superimposed may be not only a captured image obtained by camera 100P or 100Q but also a contour image in which a person in a captured image is subject to image processing so as to be transparent so that it is difficult to specify the person in the captured image. A technique for generating a contour image from a captured image is a well-known technique, and is disclosed in, for example, Japanese Patent Unexamined Publication Nos. 2015-149557, 2015-149558 and 2015-149559.

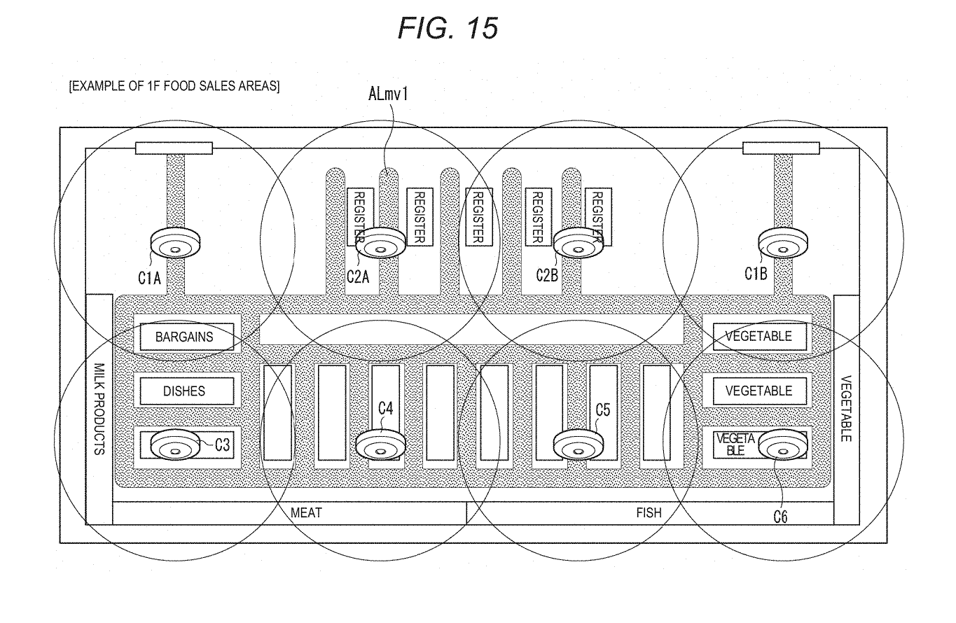

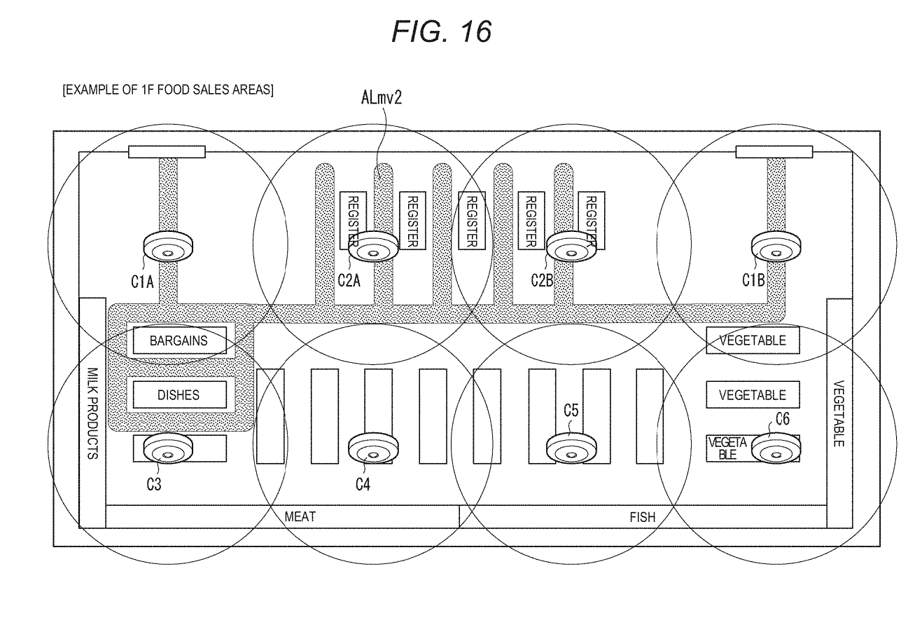

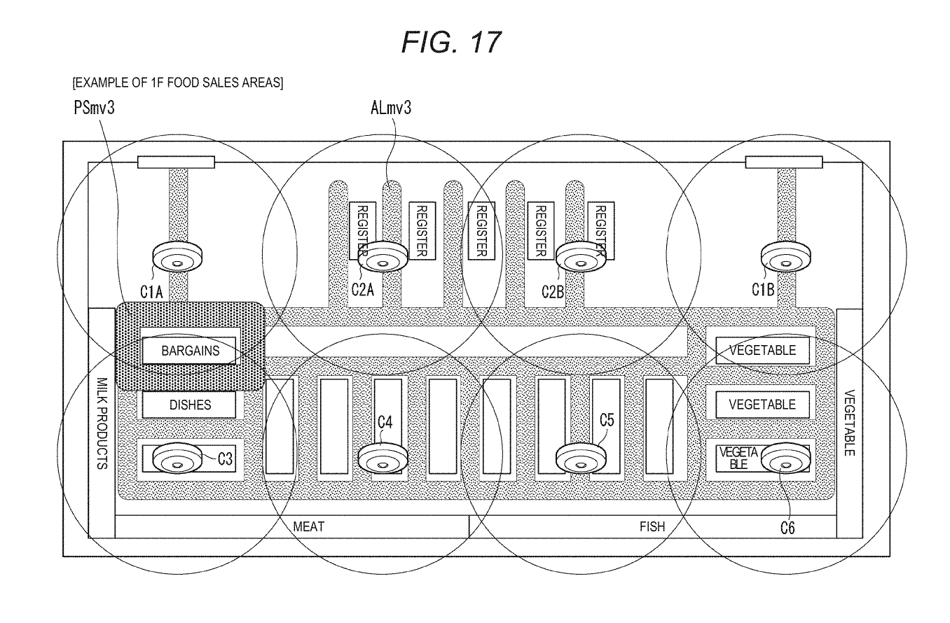

FIG. 15 is a diagram schematically illustrating an example of a moving information analysis image in which moving information ALmv1 of at least one person uniformly having passed all sales corners is superimposed. FIG. 16 is a diagram schematically illustrating an example of a moving information analysis image in which moving information ALmv2 of at least one person having stayed at only a specific sales corner among all sales corners is superimposed. FIG. 17 is a diagram schematically illustrating an example of a moving information analysis image in which moving information ALmv3 of at least one person having stayed for a long period of time at only a specific sales corner among all sales corners and having passed other sales corners is superimposed.

FIGS. 15 to 17 schematically illustrate a distribution indicating staying positions of a person (for example, a customer) having performed a specific behavior conforming to a display content instruction from input device 400, a distribution indicating passing positions, or distributions of staying positions and passing positions, in angles of view (in other words, imaging object regions) of eight cameras (specifically, northern entrance cameras C1A and C1B, before-register-cameras C2A and C2B, bargain camera C3, meat sales area camera C4, fish sales area camera C5, and vegetable sales area camera C6) with the layout of the food sales area of store 1F illustrated in FIG. 9 as an example.

A moving information analysis image generated by display image generating section 350P of server 300P is an image in which each of various pieces of moving information ALmv1, moving information ALmv2, moving information ALmv3, and moving information PSmv3 illustrated in FIGS. 15 to 17 is superimposed on a captured image obtained by camera 100P unlike in the schematic diagrams shown in FIGS. 15 to 17. For better understanding of description, in FIGS. 15 to 17, the moving information in the angles of view of the eight cameras is shown on the layout of the food sales area of store 1F, but moving information in angles of view of a single camera or two to seven cameras may be shown on a corresponding layout of the food sales area of store 1F. In other words, a moving information analysis image generated by display image generating section 350P of server 300P may be, for example, an image in which moving information of a moving object within an angle of view is superimposed on a captured image within the angle of view of a single camera, and may be an image in which moving information of a moving object within angles of view is superimposed on a captured image within the angles of view of a plurality of cameras.

FIG. 15 illustrates moving information ALmv1 in which all pieces of moving information of respective persons (for example, customers) having performed a behavior of uniformly passing all sales corners (that is, the bargain sales corner, the milk product sales corner, the meat sales area, the fish sales area, and the vegetable sales area) are superimposed. In this case, a moving information analysis image in which moving information ALmv1 is superimposed on a captured image is displayed on monitor 450 by server 300P. A single person may uniformly have passed all of the sales corners, and, in this case, only moving information of the single person is superimposed on a captured image. Therefore, a salesperson (for example, a manager) of the store side can visually recognize moving information of each person (for example, a customer) having performed a behavior of uniformly passing all of the sales corners and can also check moving information of each person on the basis of the moving information analysis image corresponding to FIG. 15.

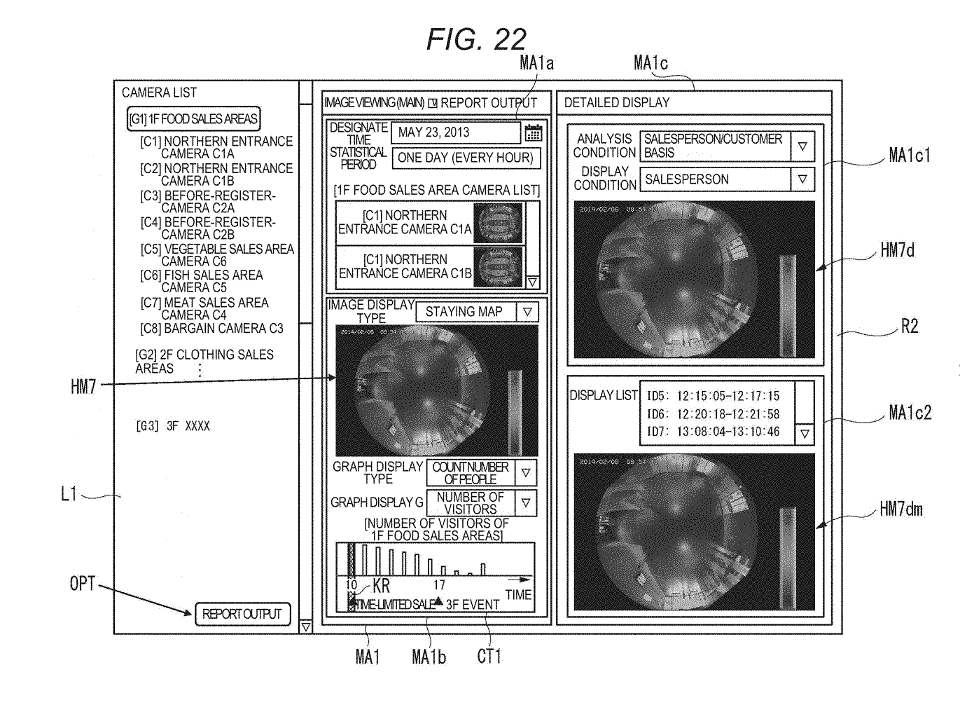

FIG. 16 illustrates moving information ALmv2 in which all pieces of moving information of respective persons (for example, customers) having performed a behavior of staying at only specific sales corners (for example, the bargain sales corner, a part of the milk product sales corner, and the dishes sales area) among all of the sales corners are superimposed. In this case, a moving information analysis image in which moving information ALmv2 is superimposed on a captured image is displayed on monitor 450 by server 300P. A single person may have stayed at only the specific sales corners, and, in this case, only moving information of the single person is superimposed on a captured image. Therefore, a salesperson (for example, a manager) of the store side can visually recognize moving information of each person (for example, a customer) having performed a behavior of staying at only specific sales corners (for example, the bargain sales corner, a part of the milk product sales corner, and the dishes sales area) and can also check moving information of each person on the basis of the moving information analysis image corresponding to FIG. 16. A user may use input device 400 to select any specific sales corner in a display condition of an analysis condition in FIG. 22 which will be described later.

FIG. 17 illustrates moving information ALmv3 and PSmv3 in which all pieces of moving information of respective persons (for example, customers) having performed a behavior of staying at only specific sales corner s for a long period of time among all of the sales corners and passing other sales corner s are superimposed. Specifically, moving information PSmv3 indicates moving information of each person (for example, a customer) having performed a behavior of staying at only the bargain sales corner for a long period of time (for example, a time of a predetermined threshold value or more). Moving information ALmv3 indicates moving information of each person (for example, a customer) having performed a behavior of passing sales corner s other than the bargain sales corner.

In this case, a moving information analysis image in which pieces of moving information ALmv3 and PSmv3 are superimposed on a captured image is displayed on monitor 450 by server 300P. As mentioned above, server 300P or 300Q of the present exemplary embodiment can display moving information of each person (for example, a customer) having a plurality of behaviors (that is, a behavior of staying at only the bargain sales corner for a long period of time and a behavior of passing other sales corners) on monitor 450 as a moving information analysis image. A single person may have stayed at only a specific sales corner and passed other sales corners, and, in this case, only moving information of the single person is superimposed on a captured image. Therefore, a salesperson (for example, a manager) of the store side can visually recognize moving information of a person (for example, a customer) having performed behaviors of staying at only a specific sale corner (for example, the bargain sales corner) for a long period of time (for example, 15 minutes or more) and passing other sales corners, and can also check moving information of each person, on the basis of the moving information analysis image corresponding to FIG. 17. A user may use input device 400 to select any specific sales corner in a display condition of an analysis condition in FIG. 22 which will be described later. In FIGS. 15 to 17, moving information may be color-coded and displayed for each person by server 300P.

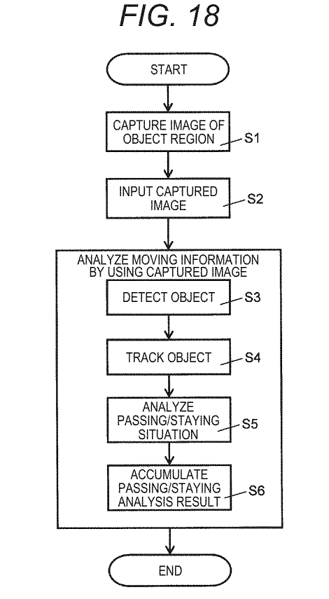

Next, with reference to FIG. 18, a description will be made of a loop process (repetition process) in camera 100P of the present exemplary embodiment. FIG. 18 is a flowchart illustrating an example of operation procedures of a loop process in camera 100P of the second exemplary embodiment.

In FIG. 18, camera 100P captures an image of a store as an object region within a predefined angle of view (step S1), and inputs captured image data (step S2). In steps S3 to S6, camera 100P analyzes moving information of each object (fₒr example, a person such as a customer or a salesperson) moving in the object region by using the captured image obtained in step S2.

Specifically, camera 100P performs image processing on a frame of the captured image obtained in step S2, and detects whether or not there is a person (for example, a customer) in the frame (step S3).

Camera 100P tracks moving information from the past detection region of a moving object to the present detection region thereof in the object region (for example, the inside of the store) by using feature amount information corresponding to a plurality of frames of the captured image obtained in step S2 on the basis of information regarding the person and information regarding a detection region of the person for each person obtained in step S3 (step S4). Camera 100P acquires a tracking result of each person as moving information (for example, a change amount of coordinate information for each person). Camera 100P extracts and generates moving information regarding a staying position or a passing position of each person in a frame of the captured image on the basis of the moving information with respect to a plurality of captured images (step S5). Consequently, camera 100P obtains a difference between frames of a plurality of captured images, and can thus extract and generate accurate moving information regarding a position where a person (for example, a customer or a salesperson) has stayed or passed in an object region (for example, the inside of a store) in frames of the captured images output from image input section 20.

Camera 100P stores an analysis result (that is, extraction result data of the moving information regarding the staying position or the passing position of the person (for example, a customer or a salesperson)) in step S5 (step S6). Camera 100P repeatedly performs the processes in steps S1 to S6 as a loop process.

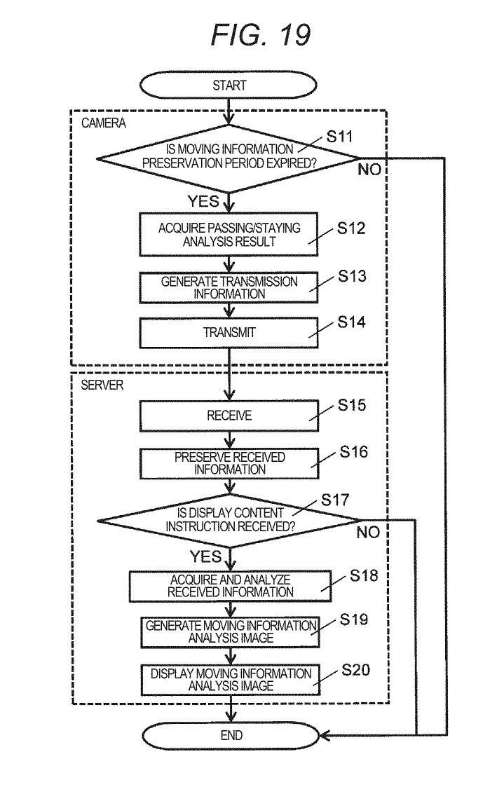

Next, with reference to FIG. 19, a description will be made of a loop process (repetition process) in camera 100P and server 300P on the expiry of a moving information preservation period in camera 100P of the present exemplary embodiment. FIG. 19 is a flowchart illustrating examples of operation procedures of a loop process in camera 100P and server 300P on the expiry of a moving information preservation period in the camera of the second exemplary embodiment.

In FIG. 19, when a preservation period of the moving information stored in object-basis passing/staying analyzing information storing section 90P is expired (YES in step S11), camera 100P reads and acquires the moving information (that is, an analysis result of passing or staying of each person) whose preservation period is expired, from object-basis passing/staying analyzing information storing section 90P (step S12). Camera 100P generates data (hereinafter, also referred to as “transmission data”) to be transmitted to server 300P (step S13), and transmits the transmission data to server 300P (step S14). The transmission data includes the moving information of each person acquired in step S12 and the captured image data acquired in step S2.

On the other hand, server 300P receives the transmission data transmitted from camera 100P (step S15), and stores the received data in received information/analysis information storing section 340P (step S16). Server 300P determines whether or not a display content instruction (for example, “a behavior of uniformly having passed all sales corners in a store which is an object region”) is received from input device 400 when the user operates the input device 400 on an operation screen (refer to FIG. 22) which will be described later (step S17). In a case where the display content instruction from input device 400 is not received by server 300P (NO in step S17), the process illustrated in FIG. 19 is finished. In a case where the display content instruction from input device 400 is received by server 300P (YES in step S17), server 300P reads the received data from received information/analysis information storing section 340P. Server 300P analyzes the received data so as to extract moving information of each person conforming to the display content instruction from input device 400 (step S18), and stores an analysis result which is an extraction result in received information/analysis information storing section 340P.

Server 300P generates a moving information analysis image in which moving information regarding a staying position or a passing position of each person corresponding to the analysis result is superimposed on a captured image by using the analysis result from received information/analysis information storing section 340P and the captured image data included in the received data (step S19). Server 300P displays the generated moving information analysis image on monitor 450 (step S20).

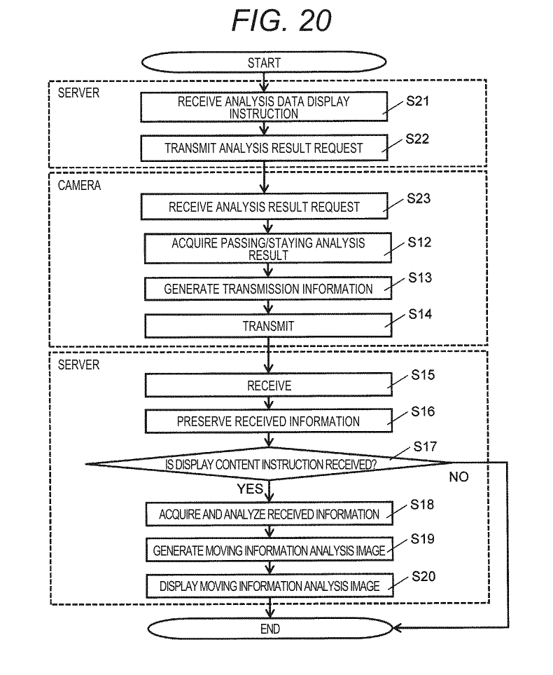

Next, with reference to FIG. 20, a description will be made of a loop process (repetition process) in camera 100P and server 300P on the expiry of a moving information preservation period in camera 100P of the present exemplary embodiment. FIG. 20 is a flowchart illustrating an example of operation procedures of a loop process in camera 100P and server 300P when an analysis data display instruction is received from input device 400 of the second exemplary embodiment. In FIG. 20, processes having the same content as that of the processes illustrated in FIG. 19 are given the same reference signs, a description thereof will be made briefly or omitted, and differing content will be described.

In FIG. 20, server 300P receives an analysis data display instruction from input device 400 (step S21). The analysis data display instruction is output from input device 400, and is received by event information receiving section 310 of server 300P, when the user operating input device 400 performs an operation for requesting display of a moving information analysis image in which moving information of each person having performed the specific behavior is superimposed, on the operation screen (refer to FIG. 22) which will be described later. If the analysis data display instruction is received, server 300P transmits an analysis result request for requesting an analysis result of moving information regarding staying or passing of each person, to camera 100P from notifying section 320 (step S22).

If the analysis result request is received from server 300P (step S23), camera 100P reads and acquires moving information (that is, an analysis result of passing or staying of each person) of each person detected in the object region, from object-basis passing/staying analyzing information storing section 90P (step S12). Processes in step S12 and the subsequent steps are the same as the processes in step S12 and the subsequent steps illustrated in FIG. 19, and thus a description thereof will be omitted.

### Another Example of Camera

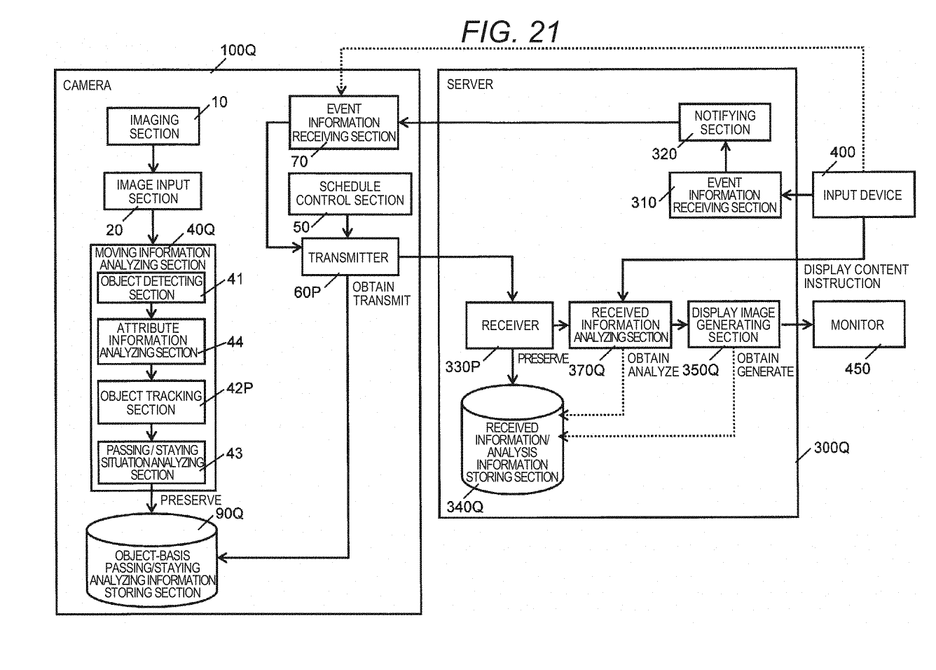

FIG. 21 is a block diagram illustrating details of a second example of a functional internal configuration of each of the camera and the server of the second exemplary embodiment. In description of camera 100Q and server 300Q illustrated in FIG. 21, the same constituent elements as those of camera 100P and server 300P illustrated in FIG. 14 are given the same reference numerals, a description thereof will be made briefly or omitted, and differing content will be described.

Camera 100Q illustrated in FIG. 21 includes imaging section 10, image input section 20, moving information analyzing section 40Q, schedule control section 50, transmitter 60P, event information receiving section 70, and object-basis passing/staying analyzing information storing section 90Q. Moving information analyzing section 40Q includes object detecting section 41, attribute information analyzing section 44, object tracking section 42P, and passing/staying situation analyzing section 43. Camera 100Q may include background image generating section 30 and background image storing section 80.

Moving information analyzing section 40Q is configured by using, for example, a CPU, an MPU, or a DSP, and detects moving information regarding a staying position or a passing position of a person for each moving object (for example, a person such as a customer or a salesperson) included in a captured image for every data item (frame) for the captured image output from image input section 20 at a predetermined frame rate (for example, 10 frames per second (fps)), and preserves the moving information in object-basis passing/staying analyzing information storing section 90Q.

In a case where at least one moving object (for example, a person such as a customer or a salesperson) included in a frame of the captured image is detected, object detecting section 41 outputs information regarding the person and information (for example, coordinate information for each person in the frame) regarding a detection region of the person to attribute information analyzing section 44 for each person in the frame of the captured image. In a case where a person is not detected in the frame of the captured image, object detecting section 41 outputs, for example, predetermined null information to attribute information analyzing section 44 as the information regarding a detection region of a person.

Attribute information analyzing section 44 determines attribute information (for example, the sex, the age, and an age range of a person, and a salesperson or a customer) of the person shown in a captured image output from image input section 20 through image processing on the basis of the information regarding the person and the information regarding a detection region of the person for each person output from object detecting section 41. A technique of determining sex, age, and an age range through image processing is a well-known technique, and thus details thereof will not be described. Regarding a method of determining whether a person is a salesperson or a customer, for example, in a case where a salesperson wears a common uniform in a store, the salesperson can be easily identified through image processing, and persons other than the salesperson may be determined as being customers. In a case where a wireless tag for transmitting position information is attached to a basket or a card carried by a customer in a store, attribute information analyzing section 44 may receive a signal from the wireless tag with camera 100Q, and may acquire position information of a customer by analyzing the signal. An analysis result in attribute information analyzing section 44 is preserved in object-basis passing/staying analyzing information storing section 90Q along with analysis result data of moving information of each person in passing/staying situation analyzing section 43.

Object-basis passing/staying analyzing information storing section 90Q is configured by using, for example, a semiconductor memory or a hard disk device, and stores extraction result data of moving information regarding a staying position or a passing position of each person generated by moving information analyzing section 40Q in correlation with the attribute information of the person. A moving information preservation period (for example, a week) in object-basis passing/staying analyzing information storing section 90Q is set in the extraction result data of moving information of each person in order to prevent an increase in a storage capacity of object-basis passing/staying analyzing information storing section 90Q. The moving information stored in object-basis passing/staying analyzing information storing section 90Q is moving information regarding a staying position or a passing position of each person detected in an object region.

Transmitter 60P acquires the captured image data generated by image input section 20 and the extraction result data of the moving information regarding the staying position or the passing position of each person stored in object-basis passing/staying analyzing information storing section 90Q in response to an instruction from schedule control section 50 or event information receiving section 70 and the attribute information, and transmits the data to server 300Q.

### Another Example of Server

Server 300Q illustrated in FIG. 21 includes event information receiving section 310, notifying section 320, receiver 330P, received information/analysis information storing section 340Q, received information analyzing section 370Q, and display image generating section 350Q. Server 300Q may include report generating output section 360.

Receiver 330P receives data (that is, the captured image data generated by image input section 20 and the extraction result data of the moving information regarding the staying information or the passing information of each person preserved in object-basis passing/staying analyzing information storing section 90Q and the attribute information) transmitted from transmitter 60P of camera 100Q, and stores the data in received information/analysis information storing section 340Q. Receiver 330P may output the data transmitted from transmitter 60P of camera 100Q, to received information analyzing section 370Q.

Received information/analysis information storing section 340Q is configured by using, for example, a semiconductor memory or a hard disk device, and stores the received data. The received data is read by received information analyzing section 370Q. Received information/analysis information storing section 340Q stores an analysis result (that is, an analysis result of received data corresponding to a display content instruction from input device 400) from received information analyzing section 370Q. The analysis result is read by display image generating section 350Q.

Received information analyzing section 370Q is configured by using, for example, a CPU, an MPU, or a DSP, and reads the received data from received information/analysis information storing section 340Q in a case of receiving a display content instruction for displaying moving information of each moving object (for example, a person such as a customer or a salesperson) satisfying a selection condition regarding a specific behavior in a moving information analysis image from input device 400, for example, in response to a user's operation. Received information analyzing section 370Q analyzes the received data, extracts moving information and attribute information of each moving object (for example, a person such as a customer or a salesperson) conforming to the display content instruction from input device 400 from the received data, and stores an analysis result which is an extraction result in received information/analysis information storing section 340Q.

Display image generating section 350Q is configured by using, for example, a CPU, an MPU, or a DSP, and generates a moving information analysis image (heat map image) in which the moving information regarding the staying position or the passing position of each moving object (for example, a person such as a customer or a salesperson) corresponding to the analysis result is superimposed on the captured image by using the analysis result in received information analyzing section 370Q from received information/analysis information storing section 340Q and the captured image data included in the received data.

Unlike the moving information analysis image generated in the first exemplary embodiment, the moving information analysis image generated by display image generating section 350Q is an image in which moving information of a moving object (for example, a person such as a customer or a salesperson) having performed the specific behavior is displayed on a captured image in response to a display content instruction output from input device 400. In other words, the moving information analysis image of the present exemplary embodiment is an image in which moving information indicating a staying position or a passing position of each person who is truly desired by a user (for example, a manager of the store) operating input device 400 in consideration of attribute information of the person is quantitatively visualized within a predetermined range (for example, values of 0 to 255) such as in a heat map on a captured image obtained by camera 100Q. Display image generating section 350Q displays the generated moving information analysis image on monitor 450. However, display image generating section 350Q may generate the moving information analysis image (that is, an image in which moving information of all persons detected by camera 100 is superimposed) generated by display image generating section 350 in the first exemplary embodiment.

FIG. 22 is a diagram illustrating an example of an operation screen including a moving information analysis image of store A, generated by display image generating section 350Q of server 300Q of the second exemplary embodiment. The operation screen illustrated in FIG. 22 is generated by display image generating section 350Q and is displayed on monitor 450. In description of the operation screen illustrated in FIG. 22, the same portions as those of the operation screen illustrated in FIG. 10 are given the same reference numerals, a description thereof will be made briefly or omitted, and differing content will be described. The operation screen illustrated in FIG. 22 is formed of left display region L1 and right display region R2. On the operation screen illustrated in FIG. 22, display region MA1 of moving information analysis information on the designated date and time (for example, May 23, 2013) and display region MA1c of a detailed display screen of moving information analysis image HM7 are displayed in right display region R2. The content displayed in display region MA1 of moving information analysis information is the same as the content displayed in display region MA1 of moving information analysis information illustrated in FIG. 10. In other words, moving information analysis image HM7 displayed in display region MA1 of moving information analysis information may be an image generated by display image generating section 350 of server 300 of the first exemplary embodiment, and may be an image generated by display image generating section 350Q of server 300Q of the second exemplary embodiment. In other words, moving information analysis image HM7 is an image in which moving information regarding staying positions of all persons detected by camera 100 or camera 100Q is superimposed on a captured image obtained by northern entrance camera C1A (refer to FIG. 9), for example, for a day of May 23, 2013. In moving information analysis image HM7, a “staying map” is selected as a video display type, and is thus a map in which staying positions of all persons are shown, but, if a “passing map” is selected as a video display type, the map is a map in which passing positions of all persons are shown.

Here, if any one of positions in moving information analysis image HM7 is designated (for example, through clicking or a touch operation) through an operation performed by a user (for example, a manager of the store) using input device 400, server 300Q displays detailed display screens MA1c1 and MA1c2 for more finely analyzing moving information analysis image HM7 in which the moving information indicating the staying positions of all persons is superimposed, in display region MA1c.

Selection items such as an “analysis condition” and a “display condition” for more finely analyzing moving information analysis image HM7d and moving information analysis image HM7 are displayed on detailed display screen MA1c1. Moving information analysis image HM7d may be the same as moving information analysis image HM7, and may be an enlarged image of a designated location in moving information analysis image HM7. The “analysis condition” is a large item for analyzing moving information analysis image HM7d, and may include, for example, “salesperson/customer basis”, “passing basis”, “staying basis”, “sex basis”, “age basis”, “age range basis”, “staying time basis”, “designated behavior basis”, “external condition basis”, and “moving information characteristic basis” (for example, a person goes around the whole store, or stays at a specific location). The “display condition” is a small item for more finely analyzing a selection item designated in the “analysis condition”.

In FIG. 22, the “analysis condition” is “salesperson/customer basis”, the “display condition” is a “salesperson”. In other words, moving information analysis image HM7 displayed in detailed display screen MA1c1 shows only staying information of “salespersons”, narrowed by received information analyzing section 370Q by using an analysis result (specifically, an attribute of the “salesperson”) in attribute information analyzing section 44 of camera 100Q through an operation performed by a user (for example, the salesperson) using input device 400.

Moving information analysis image HM7dm, and a display list of three “salespersons” detected from the staying information of “salespersons” narrowed by using the “analysis condition” and the “display condition” are displayed in detailed display screen MA1c2. Moving information analysis image HM7dm is the same as moving information analysis image HM7d. In FIG. 22, the display list of “three” “salespersons” is shown, but there is no limitation to three persons, and more persons can be displayed by operating a scroll bar. FIG. 22 illustrates the display list in which three persons having “ID5”, “ID6”, and “ID7” as identifiers are shown along with staying time periods thereof. In other words, the salesperson having “ID5” stays for a time period of “12:15:05 to 12:17:15”, the salesperson having “ID6” stays for a time period of “12:20:18 to 12:21:58”, and the salesperson having “ID7” stays for a time period of “13:08:04 to 13:10:46”.

Here, if the salesperson designates “ID5” or “12:15:05 to 12:17:15” indicating a staying time through clicking by operating input device 400, display image generating section 350Q of server 300Q reproduces moving information (that is, a change for the time period at the staying position) of the salesperson corresponding to “ID5” in a moving image form. At this time, display image generating section 350Q may reproduce moving information for the time period along with a video of captured images. Consequently, in server 300Q, movement at a staying time period of a salesperson who a user is interested in can be checked in a moving image form, and thus it is possible to appropriately monitor work such as a customer service or merchandise display of, for example, the salesperson having “ID5”. Since captured images corresponding to a transmission cycle, obtained by camera 100Q are stored in received information/analysis information storing section 340Q of server 300Q, server 300Q can reproduce the captured images in a moving image form by using a plurality of captured images.

During reproduction of the captured images, display image generating section 350Q of server 300Q may replace the captured images with transparent images in which a person in a video of captured images is shown with only a contour thereof, or may replace the captured images with a background image at the time period, by using the techniques disclosed in the above-described three Patent Documents (Japanese Patent Unexamined Publication Nos. 2015-149557, 2015-149558 and 2015-149559). Consequently, it is possible to appropriately protect the privacy of a customer at the time period.

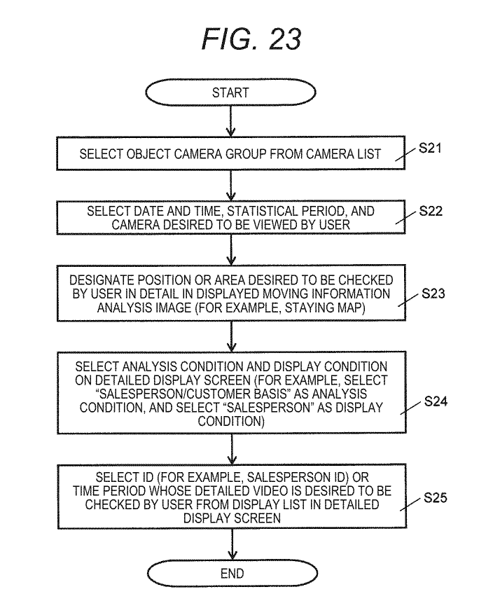

FIG. 23 is a flowchart illustrating examples of operation procedures of a staying situation analysis operation on moving information analysis image HM7 illustrated in FIG. 22 performed by a salesperson. In description of FIG. 23, FIG. 22 will be referred to as necessary.

In FIG. 23, if a user (for example, a manager of a store) selects an object camera group from the camera list in display region L1 illustrated in FIG. 22 by operating input device 400 (step S21). For example, the “1F food sales area” is assumed to be selected. Next, the date and time, a statistical period, and a camera desired to be viewed by the user are selected (step S22). For example, it is assumed that “May 23, 2013, a day, and the northern entrance camera” are selected.

If a position or an area whose details are desired to be checked by the user are designated (for example, through clicking or a touch operation) in moving information analysis image HM7 showing a staying map through the user's operation (step S23), server 300Q displays detailed display screens MA1c1 and MA1c2 for more finely analyzing moving information analysis image HM7 in which moving information indicating staying positions of all persons is superimposed, in display region MA1c.

The “analysis condition” and the “display condition” in detailed display screen MA1c1 are selected through the user's operation (step S24). For example, it is assumed that a “salesperson/customer basis” is selected as the “analysis condition”, and a “salesperson” is selected as “display condition”. In response to this selection, server 300Q displays moving information analysis image HM7dm, and a display list of three “salespersons” detected from the staying information of “salespersons” c narrowed by using the “analysis condition” and the “display condition” in detailed display screen MA1c2.

If “ID5” of the salesperson or “12:15:05 to 12:17:15” indicating a staying time is designated through clicking through the user's operation (step S25), server 300Q reproduces moving information (that is, a change for the time period at the staying position) of the salesperson corresponding to “ID5” in a moving image form.

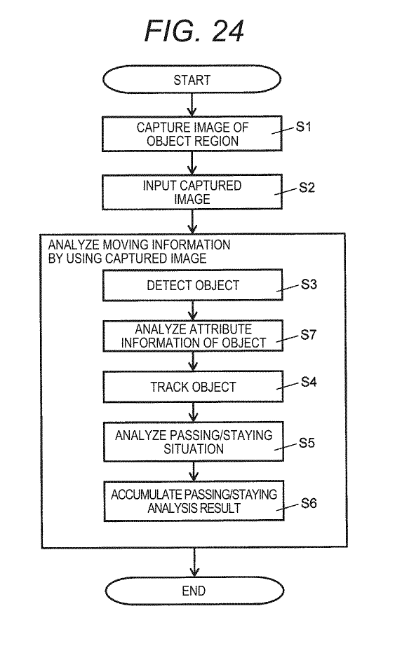

Next, with reference to FIG. 24, a description will be made of a loop process (repetition process) in camera 100Q of the present exemplary embodiment. FIG. 24 is a flowchart illustrating other examples of operation procedures of a loop process in camera 100Q of the second exemplary embodiment. In FIG. 24, processes having the same content as that of the processes illustrated in FIG. 18 are given the same reference signs, a description thereof will be made briefly or omitted, and differing content will be described.

In FIG. 24, after step S3, camera 100Q determines attribute information of the person shown in the captured image obtained in step S2 through image processing on the basis of information regarding the person and information regarding a detection region of the person for each person, obtained in step S3 (step S7). Processes in step S7 and the subsequent steps are the same as the processes in step S4 and the subsequent steps illustrated in FIG. 18, and thus a description thereof will be omitted.

Operation procedures of a loop process in camera 100Q and server 300Q on the expiry of a moving information preservation period are the same as those in the flowchart illustrated in FIG. 19, operation procedures of a loop process in camera 100Q and server 300Q when an analysis data display instruction is received from input device 400 are the same as those in the flowchart illustrated in FIG. 20, and thus descriptions thereof will be omitted.

As mentioned above, in moving information analyzing system 500A of the second exemplary embodiment, camera 100P captures an image of a monitoring object region, extracts moving information regarding a staying position or a passing position of each person included in a captured image, and transmits captured image data and extraction result data of moving information of each person to server 300P in a predetermined transmission cycle. Server 300P analyzes extraction result data of moving information of at least one person satisfying a selection condition in response to a display content instruction as the selection condition regarding a specific behavior, extracts moving information of a person having performed the specific behavior indicated by the display content instruction, generates moving information analysis image in which the moving information as an extraction result is superimposed on the captured image, and displays the moving information analysis image on monitor 450.

Consequently, moving information analyzing system 500A can perform fine analysis of moving information of each person (for example, a customer) truly desired by a salesperson on a store side instead of all persons shown in an object region. Moving information analyzing system 500A can efficiently obtain a moving information analysis image (heat map image) in which activity in the store of a customer truly desired by the store side is appropriately recognized by using a fine analysis result of the moving information, and can thus present valuable materials for improving a marketing strategy unique to a retail industry for increasing sales of the store, to the store side.

In moving information analyzing system 500A, server 300P analyzes and acquires moving information of at least one person having passed the entire object region according to a display content instruction, and generates and displays a moving information analysis image in which a result thereof is superimposed on a captured image. Consequently, according to moving information analyzing system 500A, a salesperson (for example, a manager) of a store can understand detailed activity of each customer who uniformly has gone around the store. For example, if switching from “passing all regions in the store” to “staying at only a specific location in the store for a long period of time” occurs through a user's operation in the “analysis condition” on the operation screen illustrated in FIG. 22, server 300P can perform switching from a moving information analysis image of a customer who “uniformly has gone around the store” to a moving information analysis image of a customer who “has stayed at only a specific location in the store for a long period of time” so as to display the moving information analysis image.

In moving information analyzing system 500A, if a display content instruction is received from input device 400, server 300P analyzes and acquires moving information of at least one person having passed the entire object region, and generates and displays a moving information analysis image in which a result thereof is superimposed on a captured image. Consequently, according to moving information analyzing system 500A, a salesperson (for example, a manager) of a store can understand detailed activity of each customer who uniformly has gone around the store as moving information desired to be understood by operating input device 400 used by the salesperson.

In moving information analyzing system 500A, server 300Q analyzes and acquires moving information of at least one person having stayed at a specific location in an object region according to a display content instruction, and generates and displays a moving information analysis image in which a result thereof is superimposed on a captured image. Consequently, according to moving information analyzing system 500A, a salesperson (for example, a manager) of a store can understand detailed activity of each customer who has stayed at a specific location (for example, a bargain sales corner) in the store for a long period of time (for example, 15 minutes or more). For example, if switching from “staying at only a specific location in the store for a long period of time” to “passing all regions in the store” occurs through a user's operation in the “analysis condition” on the operation screen illustrated in FIG. 22, server 300Q can perform switching from a moving information analysis image of a customer who “has stayed at only a specific location in the store for a long period of time” to a moving information analysis image of a customer who “uniformly has gone around the store” so as to display the moving information analysis image.

In moving information analyzing system 500A, if a display content instruction is received from input device 400, server 300Q analyzes and acquires moving information of at least one person having stayed at a specific location in an object region, and generates and displays a moving information analysis image in which a result thereof is superimposed on a captured image. Consequently, according to moving information analyzing system 500A, a salesperson (for example, a manager) of a store can understand detailed activity of each customer who has stayed at a specific location in the store for a long period of time as moving information desired to be understood by the salesperson by operating input device 400 used by the salesperson.

In moving information analyzing system 500A, if a user designates any one of positions in moving information analysis image HM7 by using input device 400, server 300Q displays detailed display screen HA1c1 as an input screen of a selection condition for more finely analyzing a moving information analysis image on monitor 450. In a case where there are pieces of moving information of a plurality of persons satisfying an “analysis condition” and a “display condition” designated on detailed display screen HA1c1, server 300Q displays identifiers of the pieces of moving information of the plurality of persons on monitor 450 along with moving information analysis image HM7dm. Consequently, according to moving information analyzing system 500A, a salesperson (for example, a manager) of a store can efficiently understand moving information desired to be understood by performing a simple operation on an input screen for more finely analyzing a moving information analysis image with respect to a position which the salesperson is interested in on the moving information analysis image, and can thus understand specific information of a detected person.

In moving information analyzing system 500A, if a user designates any one (for example, “ID5” in FIG. 22) of identifiers by using input device 400, server 300Q reproduces moving information (that is, a change in the time period at a staying position) of a salesperson corresponding to “ID5” in a moving image form. Consequently, in server 300Q, movement at the “time period” of a salesperson having “ID5” who a user is interested in can be checked in a moving image form, and thus it is possible to appropriately monitor work such as a customer service or merchandise display of, for example, the salesperson having “ID5”.

As mentioned above, although the various exemplary embodiments have been described with reference to the drawings, needless to say, the present disclosure is not limited to the exemplary embodiments. It is obvious that a person skilled in the art can conceive of various modifications or alterations within the scope of the invention disclosed in the claims, and it is understood that they naturally fall within the technical scope of the present disclosure.

In the above-described embodiments, a moving object exemplifies a person (for example, purchaser) moving in a store, but is not limited to a person. For example, a moving object may be a vehicle or a robot. In a case where a moving object is a person, moving information of a customer (visitor) or a salesperson in a store is analyzed. In a case where a moving object is a vehicle, for example, moving information of a vehicle in a parking lot or a road may be analyzed, and a congestion situation such as traffic jam may be displayed in a moving information analysis image.

In a case where a moving object is a robot, a robot which monitors a situation of a merchandise display shelf while circulating a store, and notifies a server of the store side of the situation, has been recently used, and a circulating situation of such a robot may be displayed in a moving information analysis image. For example, in a case where a moving object is a robot, server 300P or 300Q may be provided with a robot command notifying section (not illustrated) for controlling a going-around operation of the robot in a store, and may perform the following control. The robot command notifying section may be provided in camera 100P or 100Q, and, in this case, if a moving information analysis image transmitted from server 300P or 300Q is received by camera 100P or 100Q, the robot command notifying section performs an operation.

Specifically, if a moving information analysis image having moving information (for example, a staying situation) of each customer based on a display content instruction from input device 400 is generated, the robot command notifying section may cause the robot to preferentially go around an area where a staying time of a customer is long by using the moving information analysis image (for example, a staying map). Consequently, a salesperson (for example, a manager) of a store can understand a situation of an area where a staying time of a customer is long from an image captured by the robot, and can thus appropriately check the situation.

As another example, if a moving information analysis image having moving information (for example, a staying situation) of each salesperson is generated in response to a display content instruction from input device 400, the robot command notifying section may cause the robot to preferentially go around an area where a staying time of a salesperson is short by using the moving information analysis image (for example, a staying map). This is because, for example, a salesperson arranges merchandise on a display shelf disposed in a sales corner in the area where a staying time of the salesperson is long. Consequently, a salesperson (for example, a manager) of a store can understand a situation of an area where a staying time of a salesperson is short, that is, an area which a customer tends to enter, from an image captured by the robot, and can thus appropriately check the situation.

As still another example, if a moving information analysis image having moving information (for example, a passing situation) of each customer is generated in response to a display content instruction from input device 400, the robot command notifying section may cause the robot to preferentially go around an area where a large number of customers pass by using the moving information analysis image (for example, a passing map). Consequently, a salesperson (for example, a manager) of a store can understand a situation of an area which is crowded with a lot of customers from an image captured by the robot, and can thus appropriately check the situation so as to take necessary measures (for example, arrangement or supply of merchandise).

As still another example, if a moving information analysis image having moving information (for example, a staying situation) of each customer is generated in response to a display content instruction from input device 400, the robot command notifying section may cause the robot to preferentially go around an area where a staying time of a customer is short by using the moving information analysis image (for example, a staying map). Consequently, a salesperson (for example, a manager) of a store can cause the robot to efficiently monitor situations regarding whether or not supply or arrangement of merchandise in the store is necessary without hindering a customer from viewing merchandise. The above-described robot may be provided with a camera, and an image captured by the camera may be transmitted to server 300P or 300Q.

As still another example, if merchandise registration data (that is, the number of sales and an amount of sales for each piece of merchandise) transmitted from a point of sales (POS) system (not illustrated) is acquired in interlocking with the POS system, the robot command notifying section generates a moving information analysis image having moving information (for example, sex-basis moving information) of each customer based on a display content instruction from input device 400. The robot command notifying section may cause the robot to preferentially go around an area where a staying time is long in a moving information analysis image of a female customer by using the moving information analysis image of the female customer having a higher purchase ratio than that of a male customer. Consequently, a salesperson (for example, a manager) of a store can cause the robot to monitor a situation of a merchandise display shelf at which sales of the merchandise are high, and can thus understand a timing suitable for supplying of the merchandise.

A description has been made of a case where, if a display content instruction is received from input device 400, received information analyzing section 370P or 370Q reads received data from received information/analysis information storing section 340P or 340Q and analyzes the received data. However, even if the display content instruction is not received from input device 400, received information analyzing section 370P or 370Q may repeatedly perform an analysis process (that is, tendency analysis on moving information of a moving object) on received data in a predefined periodic cycle, and may store analysis results in received information/analysis information storing section 340P or 340Q. In this case, display image generating section 350P or 350Q may generate a moving information analysis image by using the analysis results stored in received information/analysis information storing section 340P or 340Q. In other words, even if there is no explicit operation from a user operating input device 400, server 300P or 300Q may generate a moving information analysis image.

A description has been made of a case where an analysis process on received data is performed by server 300P or 300Q, but the analysis process may be performed by passing/staying situation analyzing section 43 of moving information analyzing section 40P or 40Q of camera 100P or 100Q. In other words, a display content instruction from input device 400 is transmitted to camera 100P or 100Q via server 300P or 300Q, or is directly transmitted thereto, from input device 400. In this case, an analysis result in passing/staying situation analyzing section 43 is stored in object-basis passing/staying analyzing information storing section 90P or 90Q. Transmitter GOP causes the analysis result in passing/staying situation analyzing section 43 to be also be included in transmission data, and transmits the transmission data to server 300P or 300Q. Server 300P or 300Q generates a moving information analysis image by using received data. Consequently, received information analyzing section 370P or 370Q can be omitted from server 300P or 300Q, and thus a processing load is reduced.

In the second exemplary embodiment described above, server 300P may divide persons in a store into salespersons and purchasers (visitors), and generate a moving information analysis image for the salespersons and a moving information analysis image for the purchases and display the images on monitor 450. In this case, in camera 100P, object detecting section 41 of moving information analyzing section 40P determines whether a moving object is a salesperson or a purchaser, and stores an analysis result of moving information of each person (that is, each salesperson or each customer) in object-basis passing/staying analyzing information storing section 90P. Regarding a method in which object detecting section 41 determines whether a person is a salesperson or a customer, for example, in a case where a salesperson wears a common uniform in a store, the salesperson can be easily identified through image processing, and persons other than the salesperson may be determined as being customers. In a case where a wireless tag for transmitting position information is attached to a basket or a card carried by a customer in a store, object detecting section 41 may receive a signal from the wireless tag with camera 100P, and may acquire position information of a purchaser by analyzing the signal.

In the second exemplary embodiment described above, camera 100Q may extract moving information for each staying time in a store in addition to the sex, the age, and an age range of a moving object. In this case, camera 100Q measures a staying time of a moving object with moving information analyzing section 40Q, and also stores a measurement result of the staying time in object-basis passing/staying analyzing information storing section 90Q. Consequently, since server 300Q generates a moving information analysis image for each staying time in a store in addition to the sex, the age, and an age range of a moving object, and displays the moving information analysis image on monitor 450, a salesperson of the store can understand a difference between, for example, a person staying at the store for an hour and a person leaving the store in five minutes.

In the second exemplary embodiment, a display content instruction output from input device 400 may include whether or not a person has passed a designated area in a store (for example, whether or not a person has passed a register), a designated behavior (for example, whether a purchaser carries a basket, a cart, or neither), and an external condition (for example, weather). Server 300P or 300Q may analyze moving information read from received information/analysis information storing section 340P or 340Q in accordance with such a display content instruction, and may generate a moving information analysis image in which an analysis result thereof is superimposed on a captured image and display the moving information analysis image on monitor 450. Consequently, a salesperson (for example, a manager) of a store can visually recognize a moving information analysis image in which activity of a purchaser desired to be understood is specified for each case of whether or not a person has passed the above-described designated area, for each designated behavior, or for each external condition, by operating input device 400, and can thus examine closely an arrangement layout of merchandise or the like.

Here, a case is assumed in which a camera captures an image of a predetermined imaging region (for example, a predetermined position in a store), and generates and displays a moving information analysis image in which staying information or passing information of a moving object such as a person in each imaging region is superimposed.

### Third Exemplary Embodiment

Next, a description will be made of examples of cameras 100P and 100Q and servers 300P and 300Q forming a moving information analyzing system according to a third exemplary embodiment with reference to the drawings. Cameras 100P and 100Q and servers 300P and 300Q of the present exemplary embodiment are other examples of cameras and servers replacing camera 100 and server 300 forming moving information analyzing systems 500A, 500B, . . . of the above-described first exemplary embodiment. Thus, cameras 100P and 100Q and servers 300P and 300Q of the present exemplary embodiment also function as the camera and server forming moving information analyzing systems 500A, 500B, . . . illustrated in FIG. 1, and the description related to FIG. 1 is also to the present exemplary embodiment.

### Camera

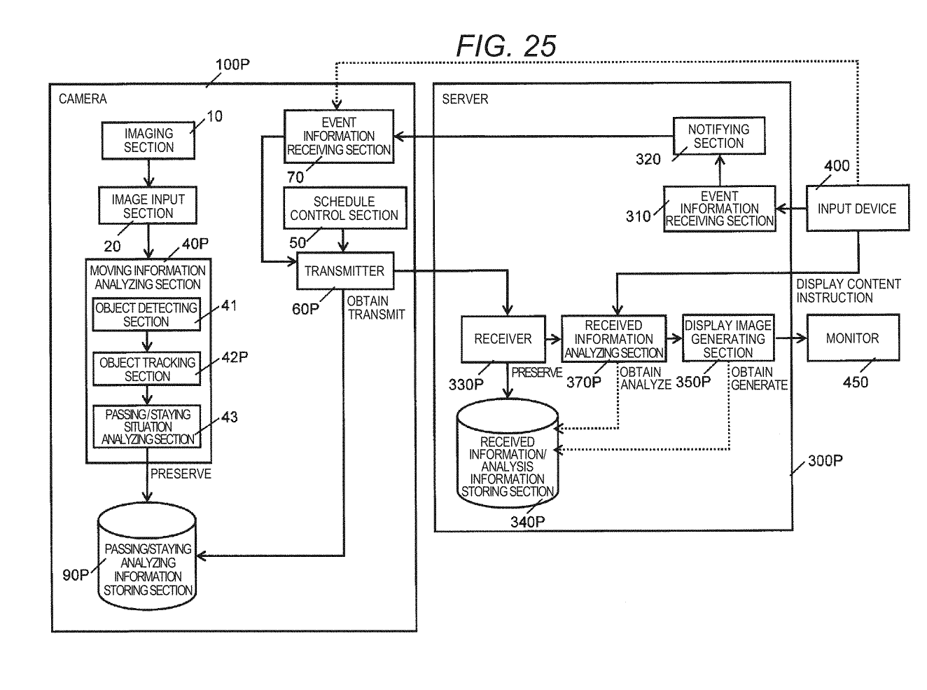

FIG. 25 is a block diagram illustrating details of a first example of a functional internal configuration of each of camera 100P and server 300P of a third exemplary embodiment. In camera 100P illustrated in FIG. 25, background image generating section 30 and background image storing section 80 are omitted from camera 100 illustrated in FIG. 2, moving information analyzing section 40, passing/staying analyzing information storing section 90, and transmitter 60 are respectively replaced with moving information analyzing section 40P, object-basis passing/staying analyzing information storing section 90P, and transmitter 60P, and other configurations are the same as those of camera 100. Therefore, in the following description of camera 100P illustrated in FIG. 25, the same constituent elements as those of camera 100 illustrated in FIG. 2 are given the same reference numerals, and description thereof will be omitted, and differing content will be described. FIG. 25 illustrates only single camera 100P, but a plurality of cameras may be provided.

Camera 100P illustrated in FIG. 25 includes imaging section 10, image input section 20, moving information analyzing section 40P, schedule control section 50, transmitter 60P, event information receiving section 70, and object-basis passing/staying analyzing information storing section 90P. Moving information analyzing section 40P includes object detecting section 41, object tracking section 42P, and passing/staying situation analyzing section 43. Camera 100P may include background image generating section 30 and background image storing section 80. Hereinafter, a monitoring region (for example, a merchandise display shelf, a special merchandise sales area, or a register counter in a store, or a doorway of the store) imaged by respective cameras 100P and 100Q will be referred to as an “object region”. In other words, the object region is included in an angle of view of camera 100P.

Moving information analyzing section 40P is configured by using, for example, a CPU, an MPU, or a DSP, and detects moving information regarding a staying position or a passing position of a person for each moving object (for example, a person such as a customer or a salesperson) included in a captured image for every data item (frame) for the captured image output from image input section 20 at a predetermined frame rate (for example, 10 frames per second (fps)), and preserves the moving information in object-basis passing/staying analyzing information storing section 90P.

In a case where a moving object included in a frame of the captured image is detected, object detecting section 41 outputs information regarding the moving object and information regarding a detection region of the moving object with respect to the frame of the captured image, to object tracking section 42P. In a case where a moving object is not detected in the frame of the captured image, object detecting section 41 outputs information regarding a detection region of a moving object (for example, predetermined null information) to object tracking section 42P.

Object tracking section 42P tracks moving information of the moving object from the past detection region to the present detection region in an object region (for example, the inside of the store) by using respective pieces of feature amount information corresponding to a plurality of frames of the captured image output from the image input section 20 on the basis of the information regarding the moving object and information regarding the detection region of the moving object output from object detecting section 41, and outputs the tracked information to passing/staying situation analyzing section 43 as moving information (for example, an amount of change in the coordinate information of the detection region of the moving object).

Passing/staying situation analyzing section 43 extracts and generates moving information regarding a staying position or a passing position of the moving object in a frame of the captured image on the basis of the moving information output from object tracking section 42P with respect to a plurality of captured images. Passing/staying situation analyzing section 43 may generate a visualized image of a color portion of a moving information analysis image (heat map image) generated by display image generating section 350 of server 300, by using an extraction result of the moving information regarding the staying position or the passing position of the moving object (for example, a person).

Passing/staying situation analyzing section 43 obtains movement information and staying information of the moving object in a plurality of captured images, and can thus extract and generate accurate moving information regarding a position where the moving object (for example, a person) has stayed or passed in an object region (for example, the inside of the store) in frames of the captured images output from image input section 20.

Object-basis passing/staying analyzing information storing section 90P is configured by using, for example, a semiconductor memory or a hard disk device, and stores extraction result data of moving information regarding a staying position or a passing position of the moving object (for example, a person) generated by moving information analyzing section 40P. A moving information preservation period (for example, for a week) in object-basis passing/staying analyzing information storing section 90P is set in the extraction result data of moving information in order to prevent an increase in a storage capacity of object-basis passing/staying analyzing information storing section 90P. The moving information stored in object-basis passing/staying analyzing information storing section 90P is an integrated result of pieces of moving information regarding staying position or passing position of all moving objects detected in an object region, and is not moving information regarding a staying position or a passing position of each moving object.

Transmitter 60P acquires the captured image data generated by image input section 20 and the extraction result data of the moving information regarding the staying position or the passing position of the moving object stored in object-basis passing/staying analyzing information storing section 90P in response to an instruction from schedule control section 50 or event information receiving section 70, and transmits the data to server 300P. A transmission timing in transmitter 60P is the same as in FIGS. 5 to 8, and thus a description thereof will be omitted. Arrows between transmitter 60P and image input section 20 are not illustrated in order to simplify FIG. 25.

### Server

In server 300P illustrated in FIG. 25, report generating output section 360 is omitted from server 300 illustrated in FIG. 2, received information analyzing section 370P is added thereto, receiver 330, received information storing section 340, and display image generating section 350 are respectively replaced with receiver 330P, received information/analysis information storing section 340P, and display image generating section 350P, and other configurations are the same as those of server 300.

Therefore, in the following description of server 300P illustrated in FIG. 25, constituent elements having the same configuration and operation as those of server 300 illustrated in FIG. 2 are given the same reference numerals, and description thereof will be omitted, and differing content will be described.

Server 300P illustrated in FIG. 25 includes event information receiving section 310, notifying section 320, receiver 330P, received information/analysis information storing section 340P, received information analyzing section 370P, and display image generating section 350P. Server 300P may include report generating output section 360.

Receiver 330P receives data (that is, the captured image data generated by image input section 20 and the extraction result data of the moving information regarding the staying information or the passing information of the moving object preserved in object-basis passing/staying analyzing information storing section 90P) transmitted from transmitter 60P of camera 100P, and stores the data in received information/analysis information storing section 340P. Receiver 330P may output the data transmitted from transmitter 60P of camera 100P, to received information analyzing section 370P. Hereinafter, the data which is video by receiver 330P and is transmitted from transmitter 60P will be referred to as “received data”.

Received information/analysis information storing section 340P is configured by using, for example, a semiconductor memory or a hard disk device, and stores the received data. The received data is read by received information analyzing section 370P. Received information/analysis information storing section 340P stores an analysis result (that is, an analysis result of received data corresponding to a display content instruction from input device 400) from received information analyzing section 370P. The analysis result is read by display image generating section 350P.

Received information analyzing section 370P is configured by using, for example, a CPU, an MPU, or a DSP, and reads the received data from received information/analysis information storing section 340P in a case of receiving a display content instruction for displaying moving information regarding a specific situation in a moving information analysis image from input device 400 in response to a user's operation. Received information analyzing section 370P analyzes the received data, extracts moving information conforming to the display content instruction from input device 400 from the received data, and stores an analysis result which is an extraction result in received information/analysis information storing section 340P.

Here, the specific situation is, for example, a situation in which a moving object stays in a store which is an object region for one minute or more, a situation in which a moving object stays in a store which is an object region for three minutes or more, a situation in which a moving object stays in a store which is an object region for five minutes or more, and a situation in which the number of passing moving objects in a store which is an object region is ten or more. However, the specific situation is not limited to such situations.

Display image generating section 350P is configured by using, for example, a CPU, an MPU, or a DSP, and generates a moving information analysis image (hₑₐt map image) in which the moving information regarding the staying position or the passing position of each moving object corresponding to the analysis result is superimposed on the captured image by using the analysis result in received information analyzing section 370P from received information/analysis information storing section 340P and the captured image data included in the received data.

Unlike the moving information analysis image generated in the first exemplary embodiment, the moving information analysis image generated by display image generating section 350P is an image in which only moving information conforming to the specific situation is superimposed on a captured image in response to a display content instruction output from input device 400. In other words, the moving information analysis image is an image in which moving information indicating a staying position or a passing position of a moving object which is truly desired by a user (for example, a manager of the store) operating input device 400 is quantitatively visualized within a predetermined range (for example, values of 0 to 255) such as in a heat map on a captured image obtained by camera 100P. Display image generating section 350P displays the generated moving information analysis image on monitor 450.

In the present exemplary embodiment, the moving information analysis image is described as an image in which moving information conforming to the specific situation is superimposed on a captured image obtained by camera 100P or 100Q, but is not limited to a captured image, and moving information may be superimposed on a background image of a captured image described in the first exemplary embodiment. In this case, camera 100P or 100Q includes background image generating section 30. Moving information conforming to the specific situation may be superimposed not only on a captured image obtained by camera 100P or 100Q but also on a contour image in which only a contour of a person in a captured image is displayed so that it is difficult to specify the person in the captured image. A technique for generating a contour image from a captured image is a well-known technique, and is disclosed in, for example, Japanese Patent Unexamined Publication Nos. 2015-149557, 2015-149558 and 2015-149559.

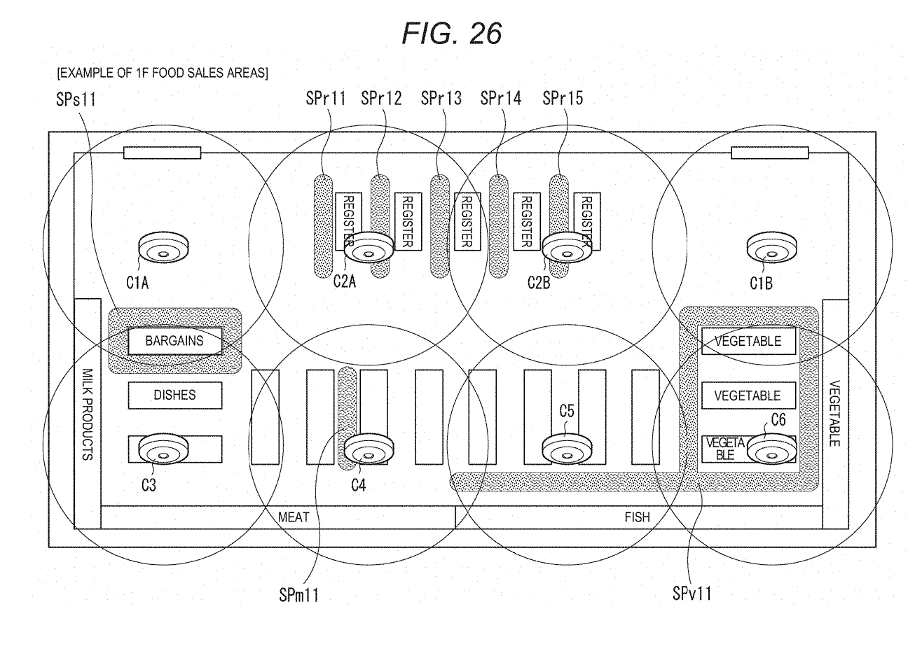

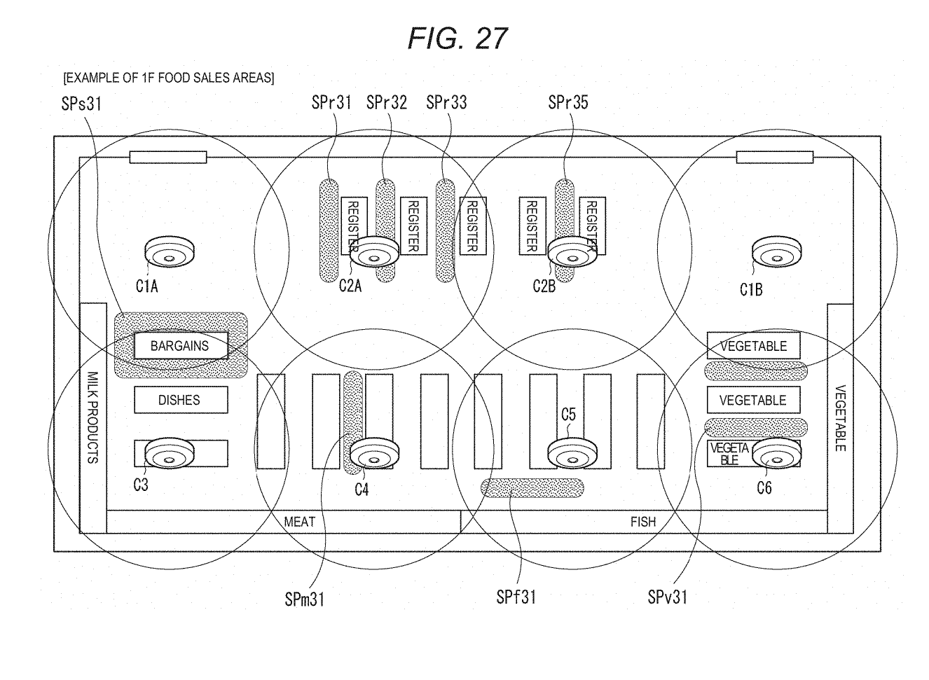

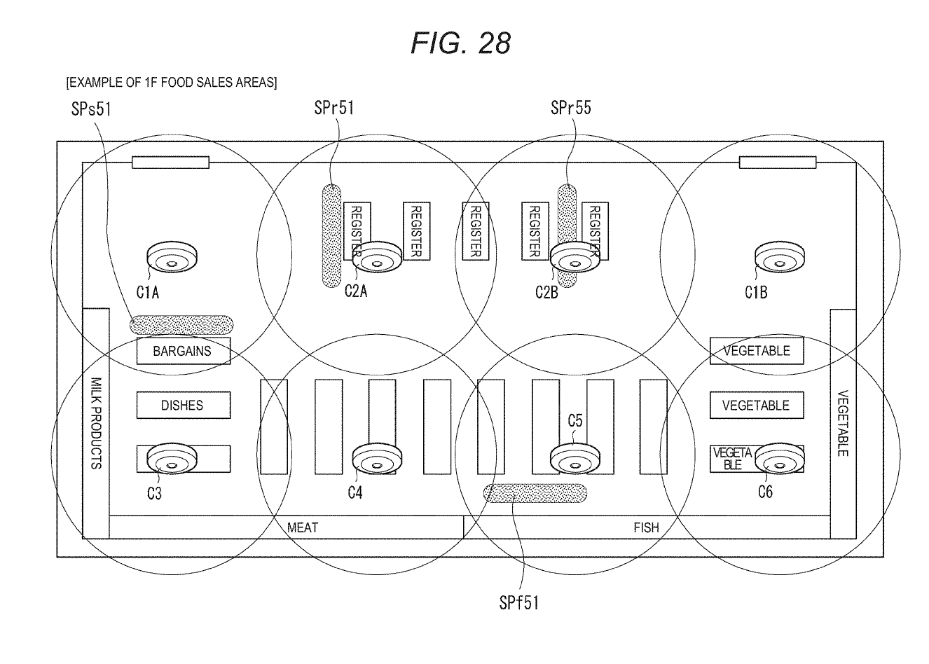

FIG. 26 is a diagram schematically illustrating an example of a moving information analysis image in which moving information of a purchaser whose staying time is one minute or more is superimposed. FIG. 27 is a diagram schematically illustrating an example of a moving information analysis image in which moving information of a purchaser whose staying time is three minutes or more is superimposed. FIG. 28 is a diagram schematically illustrating an example of a moving information analysis image in which moving information of a purchaser whose staying time is five minutes or more is superimposed.

FIGS. 26 to 28 schematically illustrate how long a person (for example, a purchaser) in the store has stayed at a predetermined position in angles of view (in other words, imaging object regions) of eight cameras (specifically, northern entrance cameras C1A and C1B, before-register-cameras C2A and C2B, bargain camera C3, meat sales area camera C4, fish sales area camera C5, and vegetable sales area camera C6) with the layout of the food sales area of store 1F illustrated in FIG. 9 as an example. FIGS. 26 to 28 may schematically illustrate how many persons have passed a predetermined location.

A moving information analysis image generated by display image generating section 350P of server 300P is an image in which each of various pieces of moving information illustrated in FIGS. 26 to 28 is superimposed on a captured image obtained by camera 100P unlike in the schematic diagrams shown in FIGS. 26 to 28. For better understanding of description, in FIGS. 26 to 28, the moving information in the angles of view of the eight cameras is shown on the layout of the food sales area of store 1F, but moving information in angles of view of a single camera or two to seven cameras may be shown on a corresponding layout of the food sales area of store 1F. In other words, a moving information analysis image (heat map image) generated by display image generating section 350P of server 300P may be, for example, an image in which moving information of a moving object within an angle of view is superimposed on a captured image within the angle of view of a single camera, and may be an image in which moving information of a moving object within angles of view is superimposed on a captured image within the angles of view of a plurality of cameras.

In FIG. 26, positions where a person in the store stays for one minute or more are represented as moving information SPs11, SPm11, SPv11, SPr11, SPr12, SPr13, SPr14, and SPr15. In other words, it is shown that a person (for example, a purchaser) has stayed around the bargain sales corner, the meat sales area, the fish sales area, the vegetable sales area, and the five registers. Therefore, it is shown that the purchaser has not stayed at the dishes sales corner and the milk product sales corner, and thus a salesperson (for example, a manager) of the store side can understand that merchandise such as dishes or milk products does not attract attention of the purchaser on the basis of a moving information analysis image corresponding to FIG. 26.

In FIG. 27, positions where a person in the store stays for three minutes or more are represented as moving information SPs31, SPm31, SPf11, SPv11, SPr31, SPr32, SPr33, and SPr35. In other words, it is shown that a person (for example, a purchaser) has stayed around the bargain sales corner, the meat sales area, the fish sales area, the vegetable sales area, and four registers. Therefore, it is shown that the purchaser has stayed at the bargain sales corner, the meat sales area, the fish sales area, and the vegetable sales area for three minutes or more, and thus a salesperson (for example, a manager) of the store side can understand that merchandise such as pieces of merchandise on the bargain sales corner, the meat sales area, the fish sales area, and the vegetable sales area attracts the attention of the purchaser on the basis of a moving information analysis image corresponding to FIG. 27. Since a purchaser staying for three minutes or more is not observed on the left of two most right registers among the five registers illustrated in FIG. 27, a salesperson of the store side can understand that a salesperson in charge of the register is excellent in his or her work on the basis of the moving information analysis image.

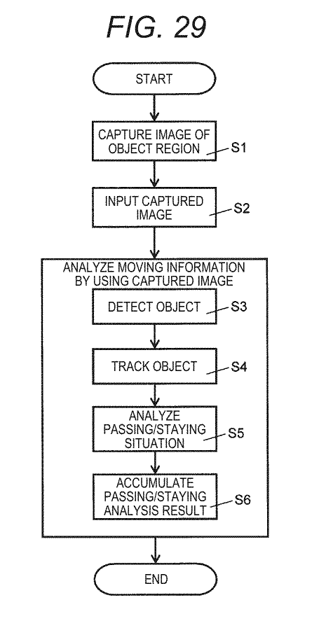

In FIG. 28, positions where a person in the store stays for five minutes or more are represented as moving information SPs51, SPf51, SPr51, and SPr55. In other words, it is shown that a person (for example, a purchaser) has stayed around the bargain sales corner, the fish sales area, and two registers. Therefore, it is shown that the purchaser has stayed at the bargain sales corner and the fish sales area for five minutes or more, and thus a salesperson (for example, a manager) of the store side can understand that merchandise such as pieces of merchandise on the bargain sales corner and the fish sales area attracts much attention of the purchaser on the basis of a moving information analysis image corresponding to FIG. 28. A manager of the store can understand circumstances peculiar to the store that, for example, there is a probability that a purchaser stays for five minutes or more in the vicinity of the fish sales area since the purchaser waits for fresh fish of the fish sales area to be handled by a salesperson in charge of cooking. Since purchasers staying for five minutes or more are observed on the most left register and the most right register among the five registers illustrated in FIG. 28, a salesperson of the store side can understand that salespersons in charge of the two registers are poor at their work and thus give purchasers a lot of trouble on the basis of the moving information analysis image. Next, with reference to FIG. 29, a description will be made of a loop process (repetition process) in camera 100P of the present exemplary embodiment. FIG. 29 is a flowchart illustrating an example of operation procedures of a loop process in camera 100P of the third exemplary embodiment.

In FIG. 29, camera 100P captures an image of a store as an object region within a predefined angle of view (step S1), and inputs captured image data (step S2). In steps S3 to S6, camera 100P analyzes moving information of a moving object (that is, a person) moving in the object region by using the captured image obtained in step S2.

Specifically, camera 100P performs image processing on a frame of the captured image obtained in step S2, and detects whether or not there is a moving object in the frame (step S3).

Camera 100P tracks moving information from the past detection region of a moving object to the present detection region thereof in the object region (for example, the inside of the store) by using differences among a plurality of frames of the captured image obtained in step S2 on the basis of information regarding the moving object and information regarding a detection region of the moving object obtained in step S3 (step S4). Camera 100P acquires a tracking result as moving information (for example, a change amount of coordinate information of the detection region of the moving object).

Camera 100P extracts and generates moving information regarding a staying position or a passing position of the moving object in a frame of the captured image on the basis of the moving information with respect to a plurality of captured images (step S5). Consequently, camera 100P can extract and generate accurate moving information regarding a position where a moving object (that is, a person) has stayed or passed in an object region (for example, the inside of a store) in frames of captured images output from image input section 20 by using feature amount information corresponding to frames of a plurality of captured images.

Camera 100P stores an analysis result (that is, extraction result data of the moving information regarding the staying position or the passing position of the moving object (for example, a person)) in step S5 (step S6). Camera 100P repeatedly performs the processes in steps S1 to S6 as a loop process.

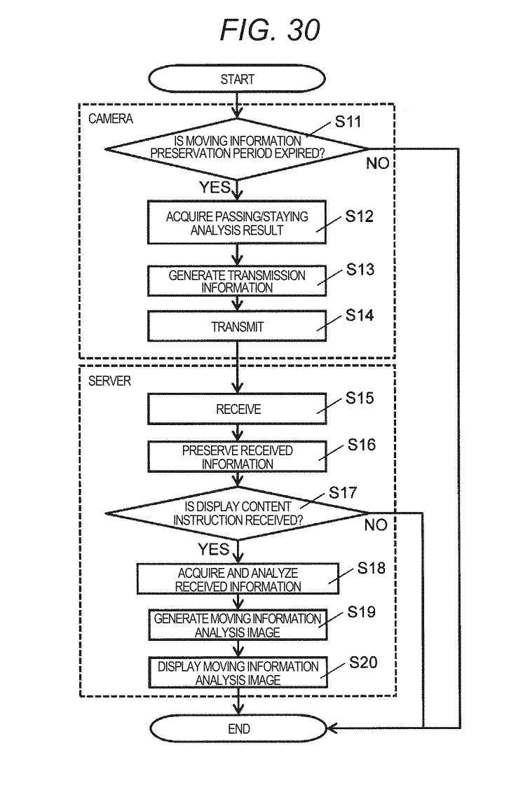

Next, with reference to FIG. 30, a description will be made of a loop process (repetition process) in camera 100P and server 300P on the expiry of a moving information preservation period in camera 100P of the present exemplary embodiment. FIG. 30 is a flowchart illustrating examples of operation procedures of a loop process in the camera and the server on the expiry of a moving information preservation period in the camera of the third exemplary embodiment.

In FIG. 30, when a preservation period of the moving information stored in object-basis passing/staying analyzing information storing section 90P is expired (YES in step S11), camera 100P reads and acquires the moving information (that is, an analysis result of passing or staying of each person) whose preservation period is expired, from object-basis passing/staying analyzing information storing section 90P (step S12). Camera 100P generates data (hereinafter, also referred to as “transmission data”) to be transmitted to server 300P (step S13), and transmits the transmission data to server 300P (step S14). The transmission data includes the moving information of each person acquired in step S12 and the captured image data acquired in step S2.

On the other hand, server 300P receives the transmission data transmitted from camera 100P (step S15), and stores the received data in received information/analysis information storing section 340P (step S16). Server 300P determines whether or not a display content instruction (for example, a situation in which a staying time is three minutes or more, or a situation in which the number of passing persons is above ten) is received from input device 400 when the user operates the input device 400 on a moving information analysis image switching screen (not illustrated) (step S17). In a case where the display content instruction from input device 400 is not received by server 300P (NO in step S17), the process illustrated in FIG. 30 is finished.

In a case where the display content instruction from input device 400 is received by server 300P (YES in step S17), server 300P reads the received data from received information/analysis information storing section 340P. Server 300P analyzes the received data so as to extract moving information conforming to the display content instruction from input device 400 (step S18), and stores an analysis result which is an extraction result in received information/analysis information storing section 340P.

Server 300P generates a moving information analysis image in which moving information regarding a staying position or a passing position of the moving object corresponding to the analysis result is superimposed on a captured image by using the analysis result from received information/analysis information storing section 340P and the captured image data included in the received data (step S19). Server 300P displays the generated moving information analysis image on monitor 450 (step S20).

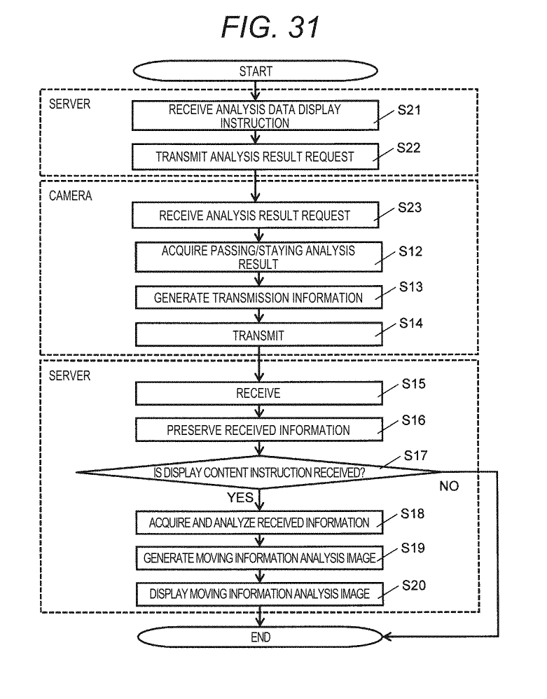

Next, with reference to FIG. 31, a description will be made of a loop process (repetition process) in camera 100P and server 300P on the expiry of a moving information preservation period in camera 100P of the present exemplary embodiment. FIG. 31 is a flowchart illustrating examples of operation procedures of a loop process in camera 100P and server 300P when an analysis data display instruction is received from input device 400 of the third exemplary embodiment. In FIG. 31, processes having the same content as that of the processes illustrated in FIG. 30 are given the same reference signs, a description thereof will be made briefly or omitted, and differing content will be described.

In FIG. 31, server 300P receives an analysis data display instruction from input device 400 (step S21). The analysis data display instruction is output from input device 400, and is received by event information receiving section 310 of server 300P, when the user operating input device 400 performs an operation for requesting display of a moving information analysis image corresponding to the specific situation on the moving information analysis image switching screen (not illustrated). If the analysis data display instruction is received, server 300P transmits an analysis result request for requesting an analysis result of moving information regarding staying or passing of a moving object, to camera 100P from notifying section 320 (step S22).

If the analysis result request is received from server 300P (step S23), camera 100P reads and acquires moving information (that is, an analysis result of passing or staying) from object-basis passing/staying analyzing information storing section 90P (step S12). Processes in step S12 and the subsequent steps are the same as the processes in step S12 and the subsequent steps illustrated in FIG. 30, and thus a description thereof will be omitted.

Another Example of Camera

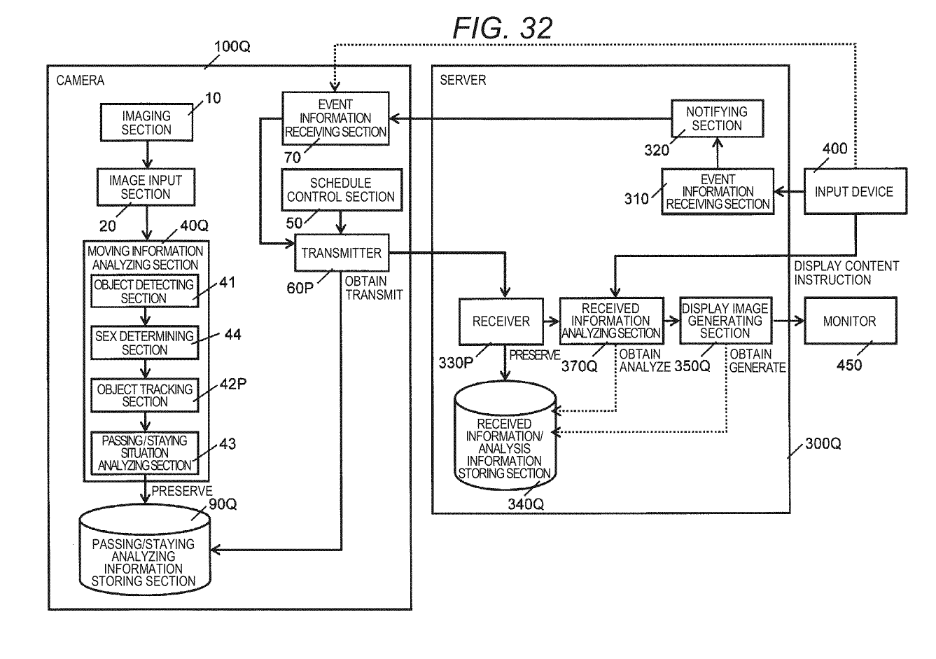

FIG. 32 is a block diagram illustrating details of a second example of a functional internal configuration of each of camera 100Q and server 300Q of the third exemplary embodiment. In description of camera 100Q and server 300Q illustrated in FIG. 32, the same constituent elements as those of camera 100P and server 300P illustrated in FIG. 25 are given the same reference numerals, a description thereof will be made briefly or omitted, and differing content will be described.

Camera 100Q illustrated in FIG. 32 includes imaging section 10, image input section 20, moving information analyzing section 40Q, schedule control section 50, transmitter GOP, event information receiving section 70, and object-basis passing/staying analyzing information storing section 90Q. Moving information analyzing section 40Q includes object detecting section 41, sex determining section 44, object tracking section 42P, and passing/staying situation analyzing section 43. Camera 100Q may include background image generating section 30 and background image storing section 80.

Moving information analyzing section 40Q is configured by using, for example, a CPU, an MPU, or a DSP, and detects moving information regarding a staying position or a passing position of a moving object (for example, a person such as a purchaser) included in a captured image for every data item (frame) for the captured image output from image input section 20 at a predetermined frame rate (for example, 10 frames per second (fps)), and preserves the moving information in object-basis passing/staying analyzing information storing section 90Q.

In a case where a moving object included in a frame of the captured image is detected, object detecting section 41 outputs information regarding the moving object and information (for example, coordinate information for the moving object in the frame) regarding a detection region of the moving object in the frame of the captured image to sex determining section 44. In a case where a moving object included in the frame of the captured image is not detected, object detecting section 41 outputs the information regarding a detection region of a person (for example, predetermined null information) to sex determining section 44.

Sex determining section 44 determines the sex, the age, and an age range of the moving object shown in a captured image output from image input section 20 through image processing on the basis of the information regarding the moving object and information regarding a detection region of the moving object output from object detecting section 41. A technique of determining sex, age, and an age range through image processing is a well-known technique, and thus details thereof will not be described. A determination result in sex determining section 44 is preserved in object-basis passing/staying analyzing information storing section 90Q along with analysis result data of moving information in passing/staying situation analyzing section 43.

Object-basis passing/staying analyzing information storing section 90Q is configured by using, for example, a semiconductor memory or a hard disk device, and stores extraction result data of moving information regarding a staying position or a passing position of a moving object (for example, a person) generated by moving information analyzing section 40Q in correlation with information regarding the sex, the age, or an age range of the moving object. A moving information preservation period (for example, a week) in object-basis passing/staying analyzing information storing section 90Q is set in the extraction result data of moving information in order to prevent an increase in a storage capacity of object-basis passing/staying analyzing information storing section 90Q. The moving information stored in object-basis passing/staying analyzing information storing section 90Q is an integrated result of pieces of moving information regarding staying position or passing position of all moving objects detected in an object region, and is not moving information regarding a staying position or a passing position of each moving object.

Transmitter 60P acquires the captured image data generated by image input section 20, and the extraction result data of the moving information regarding the staying position or the passing position of the moving object and the information regarding the sex, the age, or an age range of the moving object stored in object-basis passing/staying analyzing information storing section 90Q, in response to an instruction from schedule control section 50 or event information receiving section 70, and transmits the data to server 300Q.

### Another Example of Server

Server 300Q illustrated in FIG. 32 includes event information receiving section 310, notifying section 320, receiver 330P, received information/analysis information storing section 340Q, received information analyzing section 370Q, and display image generating section 350Q. Server 300Q may include report generating output section 360.

Receiver 330P receives data (that is, the captured image data generated by image input section 20, the extraction result data of the moving information regarding the staying information or the passing information of a moving object preserved in object-basis passing/staying analyzing information storing section 90P, and the information regarding the sex, the age, and an age range of the moving object) transmitted from transmitter GOP of camera 100Q, and stores the data in received information/analysis information storing section 340Q. Receiver 330P may output the data transmitted from transmitter GOP of camera 100Q, to received information analyzing section 370Q.

Received information/analysis information storing section 340Q is configured by using, for example, a semiconductor memory or a hard disk device, and stores the received data. The received data is read by received information analyzing section 370Q. Received information/analysis information storing section 340Q stores an analysis result (that is, an analysis result of received data corresponding to a display content instruction from input device 400) from received information analyzing section 370Q. The analysis result is read by display image generating section 350Q.

Received information analyzing section 370Q is configured by using, for example, a CPU, an MPU, or a DSP, and reads the received data from received information/analysis information storing section 340Q in a case of receiving a display content instruction for displaying moving information regarding a specific situation in a moving information analysis image from input device 400 in response to a user's operation. Received information analyzing section 370Q analyzes the received data, extracts moving information conforming to the display content instruction from input device 400 and the sex, the age, or an age range of a moving object from the received data, and stores an analysis result which is an extraction result in received information/analysis information storing section 340Q.

Here, the specific situation is, for example, a situation in which a moving object is a female person, a situation in which a moving object is a male person, a situation in which a situation in which a moving object is a female person and a situation in which a moving object is a male person are put together, a situation in which an age range of a moving object is forties, and a situation in which an age range of a moving object is sixties or more. However, the specific situation is not limited to such situations.

Display image generating section 350Q is configured by using, for example, a CPU, an MPU, or a DSP, and generates a moving information analysis image (heat map image) in which the moving information regarding the staying position or the passing position of each moving object corresponding to the analysis result is superimposed on the captured image by using the analysis result in received information analyzing section 370Q from received information/analysis information storing section 340Q and the captured image data included in the received data.

Unlike the moving information analysis image generated in the first exemplary embodiment, the moving information analysis image generated by display image generating section 350Q is an image in which only moving information conforming to the specific situation is displayed on a captured image in response to a display content instruction output from input device 400. In other words, the moving information analysis image is an image in which moving information indicating a staying position or a passing position of a moving object which is truly desired by a user (for example, a manager of the store) operating input device 400 is quantitatively visualized within a predetermined range (for example, values of 0 to 255) such as in a heat map on a captured image obtained by camera 100Q. Display image generating section 350Q displays the generated moving information analysis image on monitor 450.

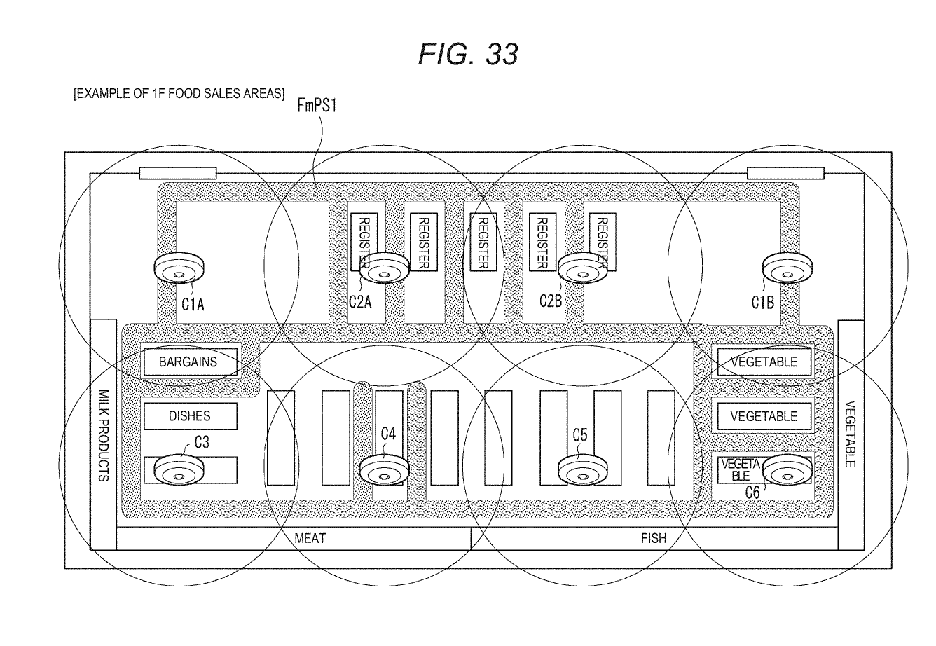

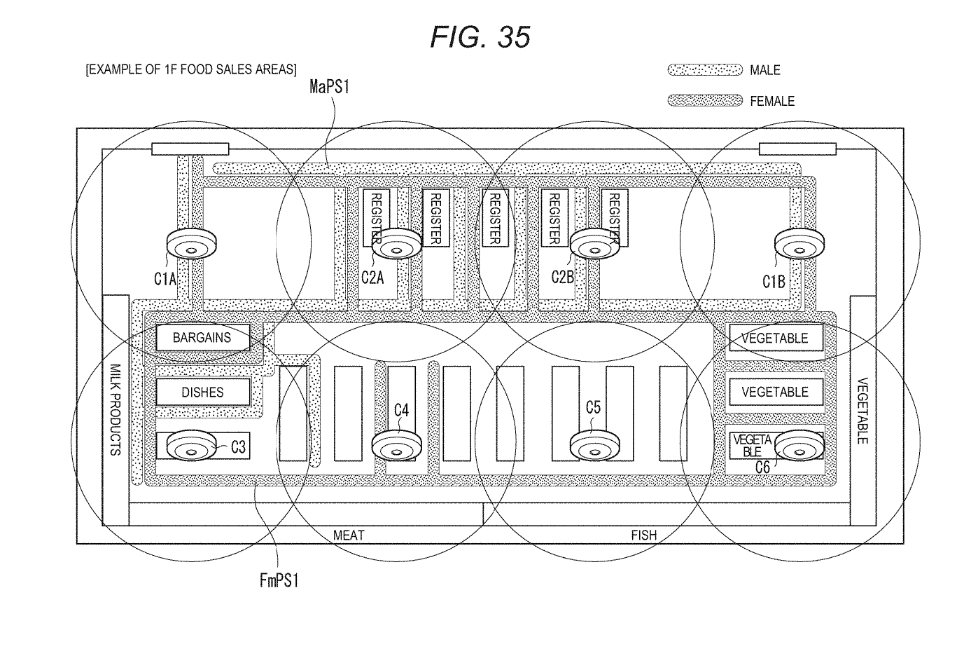

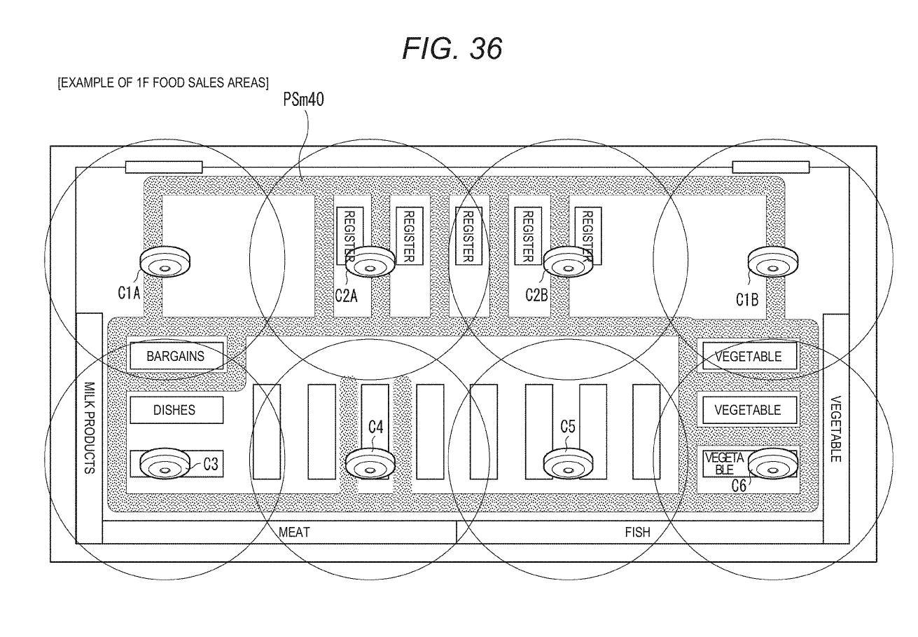

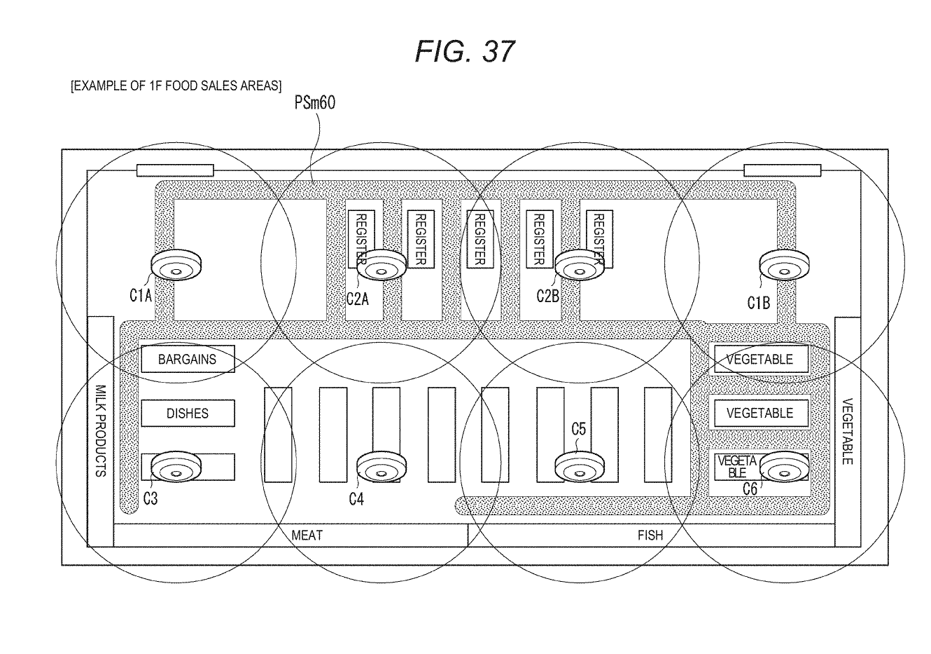

FIG. 33 is a diagram schematically illustrating an example of a moving information analysis image in which moving information of a female purchaser is superimposed. FIG. 33 is a diagram schematically illustrating an example of a moving information analysis image in which moving information of a female purchaser is superimposed. FIG. 35 is a diagram schematically illustrating an example of a moving information analysis image in which moving information of each of male and female purchasers is superimposed. FIG. 36 is a diagram schematically illustrating an example of a moving information analysis image in which moving information of a purchaser in his or her forties is superimposed. FIG. 37 is a diagram schematically illustrating an example of a moving information analysis image in which moving information of a purchaser in his or her sixties or more is superimposed.

FIGS. 33 to 37 schematically illustrate the sex, the age, and an age range of persons (for example, purchasers) in the store and how long the persons have stayed at a predetermined position, in angles of view (in other words, imaging object regions) of eight cameras (specifically, northern entrance cameras C1A and C1B, before-register-cameras C2A and C2B, bargain camera C3, meat sales area camera C4, fish sales area camera C5, and vegetable sales area camera C6) with the layout of the food sales area of store 1F illustrated in FIG. 9 as an example. FIGS. 33 to 37 may schematically illustrate the sex, the age, and an age range of persons (for example, purchasers) in the store and how many persons have passed a predetermined location.

A moving information analysis image generated by display image generating section 350Q of server 300Q is an image in which each of various pieces of moving information illustrated in FIGS. 33 to 37 is superimposed on a captured image obtained by camera 100Q unlike in the schematic diagrams shown in FIGS. 33 to 37. For better understanding of description, in FIGS. 33 to 37, the moving information in the angles of view of the eight cameras is shown on the layout of the food sales area of store 1F, but moving information in angles of view of a single camera or two to seven cameras may be shown on a corresponding layout of the food sales area of store 1F. In other words, a moving information analysis image (heat map image) generated by display image generating section 350Q of server 300Q may be, for example, an image in which moving information of a moving object within an angle of view is superimposed on a captured image within the angle of view of a single camera, and may be an image in which moving information of a moving object within angles of view is superimposed on a captured image within the angles of view of a plurality of cameras.

In FIG. 33, positions where a moving object is a woman, and the number of passing women in the store exceeds a predetermined threshold value (for example, ten) (in other words, a passing route of normal women) are represented as moving information FmPS1. In other words, it is shown that many women have passed various locations (the bargain sales corner, the milk product sales corner, the meat sales area, the fish sales area, the vegetable sales area, and the five registers) in the store. Therefore, a salesperson (for example, a manage) of the store side can understand that a woman such as a housewife tends to walk various locations in the store and to check merchandise on the basis of a moving information analysis image corresponding to FIG. 33. In FIG. 33, a situation in which a moving object is a woman, and a staying time of the woman in the store is a predetermined threshold value (for example, five minutes) or more for women may be represented as moving information FmPS1. Also in this case, similarly, a salesperson (for example, a manager) of the store side can understand that a woman such as a housewife has the tendency peculiar to women.

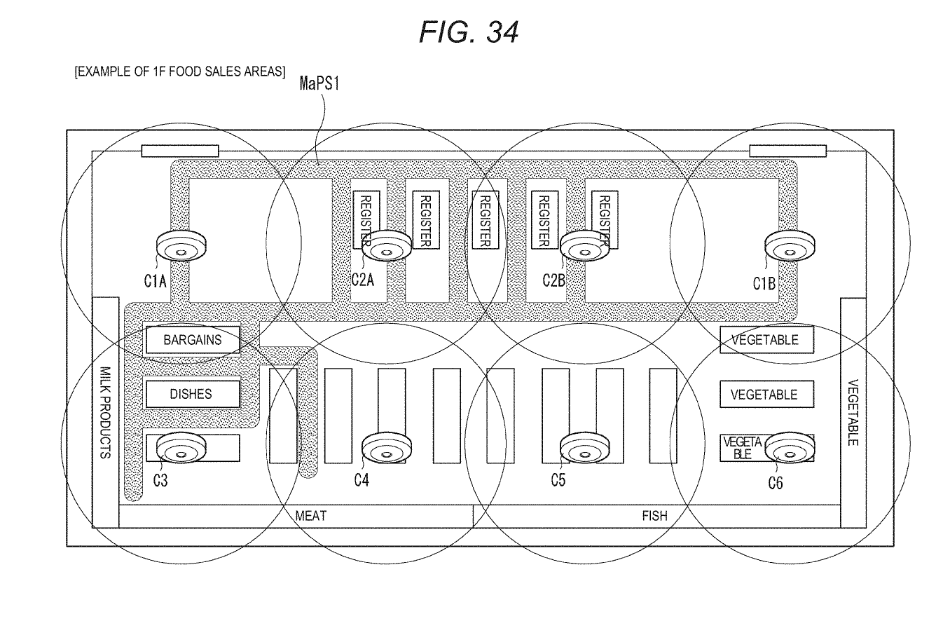

In FIG. 34, positions where a moving object is a man, and the number of passing men in the store exceeds a predetermined threshold value (for example, ten) (in other words, a passing route of normal men) are represented as moving information MaPS1. In other words, it is shown that many men have passed the bargain sales corner, the milk product sales corner, or the dishes sales corner in the store. Therefore, a salesperson (for example, a manage) of the store side can understand that a man such as an office worker tends to walk, especially, the bargain sales corner or the dishes sales corner in the store and to check merchandise on the basis of a moving information analysis image corresponding to FIG. 34. In FIG. 34, a situation in which a moving object is a man, and a staying time of the man in the store is a predetermined threshold value (for example, three minutes) or more for men may be represented as moving information MaPS1. Also in this case, similarly, a salesperson (for example, a manager) of the store side can understand that a man such as an office worker has the tendency peculiar to men.

In FIG. 35, moving information FmPS1 (refer to FIG. 33) in a case where a moving object is a woman and moving information MaPS1 (refer to FIG. 34) in a case where a moving object is a man are shown in a comparable manner. Therefore, a salesperson (for example, a manager) of the store side can recognize a visual difference between a position regarding passing or staying of a man in the store and a position regarding passing or staying of a woman in the store on the basis of a moving information analysis image illustrated in FIG. 35. In FIG. 35, a situation in which moving objects are a man and a woman, and staying times of the man and the woman in the store are respectively a predetermined threshold value (for example, three minutes) or more for men and a predetermined threshold value (for example, five minutes) or more for women may be represented as moving information MaPS1 and FmPS1. Also in this case, similarly, a salesperson (for example, a manager) of the store side can understand that a man such as an office worker and a woman such as a housewife have the tendencies peculiar to men and women.

In FIG. 36, positions where an age range of a person as a moving object is forties, and the number of passing persons in the store exceeds a predetermined threshold value (for example, ten) (in other words, a passing route of normal persons in their forties) are represented as moving information PSm40. In other words, it is shown that many persons in their forties have passed various locations (the bargain sales corner, the milk product sales corner, the meat sales area, the fish sales area, the vegetable sales area, and the five registers) in the store. Therefore, a salesperson (for example, a manage) of the store side can understand that, for example, a person in his or her forties tends to walk various locations in the store and to check merchandise on the basis of a moving information analysis image corresponding to FIG. 36. In FIG. 36, a situation in which a moving object is a person in his or her forties, and a staying time of the person in the store is a predetermined threshold value (for example, five minutes) or more for persons in their forties may be represented as moving information PSm40. Also in this case, similarly, a salesperson (for example, a manager) of the store side can understand that a person in his or her forties has the tendency peculiar to persons in their forties.

In FIG. 37, positions where an age range of a person as a moving object is sixties or more, and the number of passing persons in the store exceeds a predetermined threshold value (for example, ten) (in other words, a passing route of normal persons in their sixties or more) are represented as moving information PSm60. In other words, it is shown that many persons in their sixties or more have passed various locations (the bargain sales corner, the milk product sales corner, the fish sales area, the vegetable sales area, and the five registers) in the store. Therefore, a salesperson (for example, a manage) of the store side can understand that, for example, a person in his or her sixties or more tends not to be interested in the meat sales area and to walk various locations such as the fish sales area, the vegetable sales area, or the milk product sales corner, regarded as being healthful, and to check merchandise, on the basis of a moving information analysis image corresponding to FIG. 37. In FIG. 37, a situation in which a moving object is a person in his or her sixties or more, and a staying time of the person in the store is a predetermined threshold value (for example, four minutes) or more for persons in their sixties or more may be represented as moving information PSm60. Also in this case, similarly, a salesperson (for example, a manager) of the store side can understand that a person in his or her sixties has the tendency peculiar to persons in their sixties or more.

In FIG. 36 or 37, moving information of persons in each age range may be displayed along with comparable moving information as in the moving information illustrated in FIG. 35.

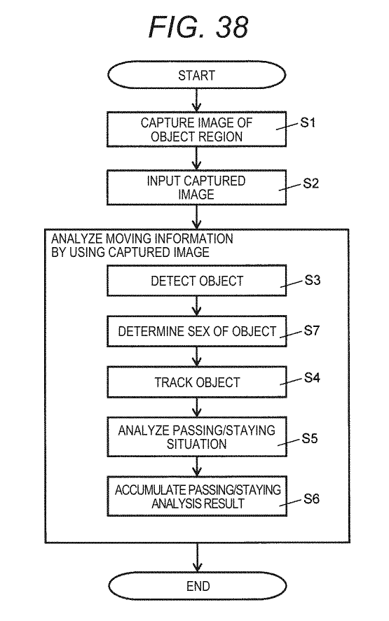

Next, with reference to FIG. 38, a description will be made of a loop process (repetition process) in camera 100Q of the present exemplary embodiment. FIG. 38 is a flowchart illustrating other examples of operation procedures of a loop process in camera 100Q of the third exemplary embodiment. In FIG. 38, processes having the same content as that of the processes illustrated in FIG. 29 are given the same reference signs, a description thereof will be made briefly or omitted, and differing content will be described.

In FIG. 38, after step S3, camera 100Q determines the sex, the age, or an age range of the moving object shown in the captured image obtained in step S2 through image processing on the basis of information regarding the moving object and information regarding a detection region of the moving object obtained in step S3 (step S7). Processes in step S7 and the subsequent steps are the same as the processes in step S4 and the subsequent steps illustrated in FIG. 29, and thus a description thereof will be omitted.

Operation procedures of a loop process in camera 100Q and server 300Q on the expiry of a moving information preservation period are the same as those in the flowchart illustrated in FIG. 30, operation procedures of a loop process in camera 100Q and server 300Q when an analysis data display instruction is received from input device 400 are the same as those in the flowchart illustrated in FIG. 31, and thus descriptions thereof will be omitted.

As mentioned above, in moving information analyzing system 500A of the third exemplary embodiment, camera 100P captures an image of a monitoring object region, extracts moving information regarding a staying position or a passing position of a moving object included in a captured image, and transmits captured image data and extraction result data of moving information to server 300P in a predetermined transmission cycle. Server 300P analyzes extraction result data of moving information in response to a display content instruction as a selection condition, extracts moving information conforming to a specific situation indicated by the display content instruction, generates moving information analysis image in which the moving information as an extraction result is superimposed on the captured image, and displays the moving information analysis image on monitor 450.

Consequently, moving information analyzing system 500A can perform fine analysis of moving information of each type of a truly desired person (for example, a purchaser) side instead of all persons shown in an object region. Moving information analyzing system 500A can efficiently obtain a moving information analysis image (heat map image) which is truly desired by the store side by using a fine analysis result of the moving information, and can thus present valuable materials for improving a marketing strategy unique to a retail industry for increasing sales of the store, to the store side. According to moving information analyzing system 500A, a salesperson (for example, a manager) of a store can obtain important hints such as the way of arranging merchandise in the store or a timing of supplying merchandise by analyzing a moving information analysis image of each type of truly desired person (for example, a purchaser), and can thus support work efficiency of each salesperson in the store.

In moving information analyzing system 500A, server 300P analyzes and acquires moving information on a staying time of a moving object basis in an object region according to a display content instruction, and generates and displays a moving information analysis image in which the moving information on a staying time basis is superimposed on a captured image. Consequently, according to moving information analyzing system 500A, a salesperson (for example, a manager) of a store can understand in detail how long a purchaser has stayed at a predetermined location in the store, or how many purchasers have passed a predetermined location, on a staying time basis. If switching occurs between display content instructions (for example, switching from a staying time of one minute or more to a staying time of three minutes or more) on the moving information analysis image switching screen (not illustrated), server 300P can perform switching from, for example, a moving information analysis image indicating a situation in which a staying time is one minute or more to a moving information analysis image indicating a situation in which a staying time is three minutes or more so as to display the moving information analysis image.

In moving information analyzing system 500A, if a display content instruction is received from input device 400, server 300P analyzes and acquires moving information of a moving object on a staying time basis in an object region, and generates and displays a moving information analysis image in which the moving information on a staying time basis is superimposed on a captured image. Consequently, according to moving information analyzing system 500A, a salesperson (for example, a manager) of a store can understand in detail how long a purchaser has stayed at a predetermined location in the store, or how many purchasers have passed a predetermined location, on a staying time basis, as moving information desired to be understood by the salesperson by operating input device 400 used by the salesperson.

In moving information analyzing system 500A, server 300Q analyzes and acquires moving information of a person as a moving object on a sex basis according to a display content instruction, and generates and displays a moving information analysis image in which the moving information on a sex basis is superimposed on a captured image. Consequently, according to moving information analyzing system 500A, a salesperson (for example, a manager) of a store can understand in detail how long a male purchaser, a female purchaser, or male and female purchasers have stayed at a predetermined location in the store, or which location purchasers have passed, on a sex basis. If switching occurs between display content instructions (for example, switching from a man to a woman) on the moving information analysis image switching screen (not illustrated), server 300Q can perform switching from, for example, a moving information analysis image of a male purchaser to a moving information analysis image of a female purchaser so as to display the moving information analysis image. If switching occurs between display content instructions (for example, switching from a woman to a man or a man and a woman) on the moving information analysis image switching screen (not illustrated), server 300Q can perform switching from, for example, a moving information analysis image of a female purchaser to a moving information analysis image of male and female purchasers so as to display the moving information analysis image.

In moving information analyzing system 500A, if a display content instruction is received from input device 400, server 300Q analyzes and acquires moving information of a person as a moving object on a sex basis, and generates and displays a moving information analysis image in which the moving information on a sex basis is superimposed on a captured image. Consequently, according to moving information analyzing system 500A, a salesperson (for example, a manager) of a store can understand in detail where a male purchaser, a female purchaser, or male and female purchasers have stayed in the store, or which location purchasers have passed, on a sex basis, as moving information desired to be understood by the salesperson by operating input device 400 used by the salesperson.

In moving information analyzing system 500A, server 300Q analyzes and acquires moving information of a person as a moving object on age or an age range basis according to a display content instruction, and generates and displays a moving information analysis image in which the moving information on age or an age range basis is superimposed on a captured image. Consequently, according to moving information analyzing system 500A, a salesperson (for example, a manager) of a store can understand in detail where a purchaser has stayed in the store, or which location purchasers have passed, on age or an age range basis. If switching occurs between display content instructions (for example, switching from forties to sixties or more) on the moving information analysis image switching screen (not illustrated), server 300Q can perform switching from, for example, a moving information analysis image of a purchaser in his or her forties to a moving information analysis image of a purchaser in his or her sixties or more so as to display the moving information analysis image. If switching occurs between display content instructions (for example, switching from sixties or more to forties) on the moving information analysis image switching screen (not illustrated), server 300Q may perform switching from, for example, a moving information analysis image of a purchaser in his or her sixties or more to a moving information analysis image of a purchaser in his or her forties so as to display the moving information analysis image.

In moving information analyzing system 500A, if a display content instruction is received from input device 400, server 300Q analyzes and acquires moving information of a person as a moving object on age or an age range basis, and generates and displays a moving information analysis image in which the moving information on age or an age range basis is superimposed on a captured image. Consequently, according to moving information analyzing system 500A, a salesperson (for example, a manager) of a store can understand in detail where a purchaser has stayed in the store, or which location a purchaser has passed, on age or an age range basis, as moving information desired to be understood by the salesperson by operating input device 400 used by the salesperson.

In moving information analyzing system 500A, server 300Q analyzes and acquires moving information of moving objects on a passing amount basis in an object region according to a display content instruction, and generates and displays a moving information analysis image in which the moving information on a passing amount basis is superimposed on a captured image. Consequently, according to moving information analyzing system 500A, a salesperson (for example, a manager) of a store can understand in detail how many purchasers have passed a predetermined location on a passing amount basis.

In moving information analyzing system 500A, if a display content instruction is received from input device 400, server 300Q analyzes and acquires moving information of a moving object on a passing amount basis in an object region, and generates and displays a moving information analysis image in which the moving information on a passing amount basis is superimposed on a captured image. Consequently, according to moving information analyzing system 500A, a salesperson (for example, a manager) of a store can understand in detail how many purchasers have passed a predetermined location, on a passing amount basis, as moving information desired to be understood by the salesperson by operating input device 400 used by the salesperson.

In moving information analyzing system 500A, server 300Q analyzes and acquires moving information regarding whether or not a moving object has passed a specific location (for example, a bargain sales corner) in an object region according to a display content instruction, and generates and displays a moving information analysis image in which the moving information regarding whether or not the moving object has passed the specific location is superimposed on a captured image. Consequently, according to moving information analyzing system 500A, a salesperson (for example, a manager) of a store can understand in detail how many purchasers have passed a specific location (for example, a bargain sales corner) in the store.

In moving information analyzing system 500A, if a display content instruction is received from input device 400, server 300Q analyzes and acquires moving information regarding whether or not a moving object has passed a specific location (for example, a bargain sales corner) in an object region, and generates and displays a moving information analysis image in which the moving information regarding whether or not the moving object has passed the specific location is superimposed on a captured image. Consequently, according to moving information analyzing system 500A, a salesperson (for example, a manager) of a store can understand in detail how many purchasers have passed a specific location (for example, a bargain sales corner) in the store as moving information desired to be understood by the salesperson by operating input device 400 used by the salesperson.

As mentioned above, although the various exemplary embodiments have been described with reference to the drawings, needless to say, the present disclosure is not limited to the exemplary embodiments. It is obvious that a person skilled in the art can conceive of various modifications or alterations within the scope of the invention disclosed in the claims, and it is understood that they naturally fall within the technical scope of the present disclosure.

In the above-described embodiments, a moving object exemplifies a person (for example, purchaser) moving in a store, but is not limited to a person. For example, a moving object may be a vehicle or a robot. In a case where a moving object is a person, moving information of a purchaser (visitor) or a salesperson in a store is analyzed. In a case where a moving object is a vehicle, for example, moving information of a vehicle in a parking lot or a road may be analyzed, and a congestion situation in the parking lot or a congestion situation such as traffic jam may be displayed in a moving information analysis image. In a case where a moving object is a robot, a robot which monitors a situation of a merchandise display shelf while circulating a store, and notifies a server of the store side of the situation, has been recently used, and a circulating situation of such a robot may be displayed in a moving information analysis image.

A description has been made of a case where, if a display content instruction is received from input device 400, received information analyzing section 370P or 370Q reads received data from received information/analysis information storing section 340P or 340Q and analyzes the received data. However, even if the display content instruction is not received from input device 400, received information analyzing section 370P or 370Q may repeatedly perform an analysis process (that is, tendency analysis on moving information of a moving object) on received data in a predefined periodic cycle, and may store analysis results in received information/analysis information storing section 340P or 340Q. In this case, display image generating section 350P or 350Q may generate a moving information analysis image by using the analysis results stored in received information/analysis information storing section 340P or 340Q. In other words, even if there is no explicit operation from a user operating input device 400, server 300P or 300Q may generate a moving information analysis image.

A description has been made of a case where an analysis process on received data is performed by server 300P or 300Q, but the analysis process may be performed by passing/staying situation analyzing section 43 of moving information analyzing section 40P or 40Q of camera 100P or 100Q. In other words, a display content instruction from input device 400 is transmitted to camera 100P or 100Q via server 300P or 300Q, or is directly transmitted thereto, from input device 400. In this case, an analysis result in passing/staying situation analyzing section 43 is stored in object-basis passing/staying analyzing information storing section 90P or 90Q. Transmitter GOP causes the analysis result in passing/staying situation analyzing section 43 to be also included in transmission data, and transmits the transmission data to server 300P or 300Q. Server 300P or 300Q generates a moving information analysis image by using received data. Consequently, received information analyzing section 370P or 370Q can be omitted from server 300P or 300Q, and thus a processing load is reduced.

In the third exemplary embodiment, server 300P or 300Q may divide moving objects in a store into salespersons and purchasers (visitors), and generate a moving information analysis image for the salespersons and a moving information analysis image for the purchases and display the images on monitor 450. In this case, in camera 100P or 100Q, object detecting section 41 of moving information analyzing section 40P or 40Q determines whether a moving object is a salesperson or a purchaser, and stores an analysis result of moving information of each salesperson and each purchaser in object-basis passing/staying analyzing information storing section 90P or 90Q. Regarding a method in which object detecting section 41 determines whether a person is a salesperson or a customer, for example, in a case where a salesperson wears a common uniform in a store, the salesperson can be easily identified through image processing, and persons other than the salesperson may be determined as being customers. In a case where a wireless tag for transmitting position information is attached to a basket or a cart carried by a customer in a store, object detecting section 41 may receive a signal from the wireless tag with camera 100P or 100Q, and may acquire position information of a purchaser by analyzing the signal.

In the third exemplary embodiment, camera 100P or 100Q may not necessarily perform a determination of a salesperson or a purchaser, or the age, an age range, or the sex of a moving object. For example, there may be a configuration in which a camera (not illustrated) which is different from camera 100P or 100Q is provided, the camera or a server (not illustrated) which receives an image from the camera and analyzes the image determines whether a moving object is a salesperson or a purchaser, and a determination result thereof is transmitted to camera 100P or 100Q or server 300P or 300Q so as to be managed in associated with an analysis result in camera 100P or 100Q. Similarly, there may be a configuration in which a camera (not illustrated) which is different from camera 100P or 100Q is provided, the camera or a server (not illustrated) which receives an image from the camera and analyzes the image determines the age, an age range, or the sex of a moving object, and a determination result thereof is transmitted to camera 100P or 100Q or server 300P or 300Q so as to be managed in associated with an analysis result in camera 100P or 100Q.

In the third exemplary embodiment, camera 100Q may extract moving information for each staying time in a store in addition to the sex, the age, and an age range of a moving object. In this case, camera 100Q measures a staying time of a moving object with moving information analyzing section 40Q, and also stores a measurement result of the staying time in object-basis passing/staying analyzing information storing section 90Q. Consequently, since server 300Q generates a moving information analysis image for each staying time in a store in addition to the sex, the age, and an age range of a moving object, and displays the moving information analysis image on monitor 450, a salesperson of the store can understand a difference between, for example, a person staying at the store for an hour and a person leaving the store in five minutes.

In the third exemplary embodiment, a display content instruction output from input device 400 may include whether or not a person has passed a designated area in a store (for example, whether or not a person has passed a register), a designated behavior (for example, whether a purchaser carries a basket, a cart, or neither), and an external condition (for example, weather). Server 300P or 300Q may analyze moving information read from received information/analysis information storing section 340P or 340Q in accordance with such a display content instruction, and may generate a moving information analysis image in which an analysis result thereof is superimposed on a captured image and display the moving information analysis image on monitor 450. Consequently, a salesperson (for example, a manager) of a store can visually recognize a moving information analysis image in which activity of a purchaser desired to be understood is specified for each case of whether or not a person has passed the above-described designated area, for each designated behavior, or for each external condition, by operating input device 400, and can thus examine closely an arrangement layout of merchandise or the like.

In a case where a staying position on a moving information analysis image is designated through clicking by a user (for example, a salesperson of a store) operating input device 400 used thereby on an operation screen (for example, refer to FIG. 10 or 11) including the moving information analysis image displayed on monitor 450, server 300P or 300Q may display detailed information of the designated staying position on monitor 450. The detailed information includes, for example, the sex, the age, an age range, and a staying time of a moving object having stayed at the staying position. Consequently, even if it is hard for the salesperson of the store to understand details of moving information from a moving information analysis image of the entire imaging object region of camera 100P or 100Q, but the salesperson can check detailed information of a moving object at a designated staying position or passing position through a simple designation operation on input device 400, and can thus obtain information which contributes to examination of marketing strategies.

In FIGS. 26 to 28, moving information may be color-coded and displayed for each staying time by server 300P. In FIGS. 33 to 37, moving information may be color-coded and displayed for each moving object's sex, age or age range by server 300Q.

What is claimed is:

1. A moving information analyzing system comprising:
a camera and a server that are connected to each other,
wherein the camera
captures an image of an object region,
extracts moving information regarding a staying position or a passing position of each moving object,
stores the extracted moving information of each moving object, and
transmits a captured image of the object region and the moving information of each moving object to the server in a predetermined transmission cycle, and
wherein the server
acquires moving information of at least one moving object satisfying a selection condition regarding a specific behavior on the basis of the moving information of each moving object transmitted from the camera,
generates a moving information analysis image in which the moving information of at least one moving object satisfying the selection condition regarding the specific behavior is superimposed on the captured image transmitted from the camera, and
displays the moving information analysis image on a monitor connected to the server.

2. The moving information analyzing system of claim 1,
wherein the server
acquires moving information of at least one moving object having passed through the entire object region as the selection condition regarding the specific behavior, and
displays, on the monitor, a moving information analysis image in which the moving information of at least one moving object having passed through the entire object region is superimposed on the captured image.

3. The moving information analyzing system of claim 2,
wherein, if there is an input of the selection condition regarding the specific behavior by using an input device connected to the server, the server displays, on the monitor, the moving information analysis image in which the moving information of at least one moving object having passed through the entire object region is superimposed on the captured image.

4. The moving information analyzing system of claim 1,
wherein the server
acquires moving information of at least one moving object having stayed at a specific location in the object region as the selection condition regarding the specific behavior, and
displays, on the monitor, a moving information analysis image in which the moving information of at least one moving object having stayed at the specific location in the object region is superimposed on the captured image.

5. The moving information analyzing system of claim 4,
wherein, if there is an input of the selection condition regarding the specific behavior by using an input device connected to the server, the server displays, on the monitor, the moving information analysis image in which the moving information of at least one moving object having stayed at the specific location in the object region is superimposed on the captured image.

6. The moving information analyzing system of claim 1,
wherein, if any one of positions in the moving information analysis image is designated, the server displays an input screen of a selection condition regarding the specific behavior on the monitor, and, in a case where there are pieces of moving information of a plurality of moving objects conforming to the selection condition regarding the specific behavior designated on the input screen, the server displays identifiers of the pieces of moving information of the plurality of moving objects on the monitor along with the moving information analysis image.

7. The moving information analyzing system of claim 6,
wherein, if any one of the identifiers is designated by using an input device connected to the server, the server displays a change in the moving information of the moving object corresponding to the designated identifier in a moving image form along with a video corresponding to the captured image.

8. A moving information analyzing method for a moving information analyzing system in which a camera and a server are connected to each other, the method comprising:
causing the camera
to capture an image of an object region,
to extract moving information regarding a staying position or a passing position of each moving object,
to store the extracted moving information of each moving object, and
to transmit a captured image of the object region and the moving information of each moving object to the server in a predetermined transmission cycle; and
causing the server
to acquire moving information of at least one moving object satisfying a selection condition regarding a specific behavior on the basis of the moving information of each moving object transmitted from the camera,
to generate a moving information analysis image in which the moving information of at least one moving object satisfying the selection condition regarding the specific behavior is superimposed on the captured image transmitted from the camera, and
to display the moving information analysis image on a monitor connected to the server.

9. A moving information analyzing system comprising:
a camera and a server that are connected to each other,
wherein the camera
captures an image of an object region,
extracts moving information regarding a staying position or a passing position of a moving object, and
transmits a captured image of the object region and the moving information to the server in a predetermined transmission cycle, and
wherein the server
acquires moving information of a moving object corresponding to a selection condition on the basis of the moving information transmitted from the camera,
generates a moving information analysis image in which the moving information of the moving object corresponding to the selection condition is superimposed on the captured image transmitted from the camera, and
displays the moving information analysis image on a monitor connected to the server.

10. The moving information analyzing system of claim 9,
wherein the server
acquires moving information of the moving object on a staying time of the moving object basis in the object region as the selection condition, and
displays, on the monitor, a moving information analysis image in which the moving information of the moving object on the staying time basis is superimposed on the captured image.

11. The moving information analyzing system of claim 10,
wherein, if there is an input of the selection condition by using an input device connected to the server, the server acquires the moving information of the moving object on the staying time basis, and displays, on the monitor, the moving information analysis image in which the moving information of the moving object on the staying time basis is superimposed on the captured image.

12. The moving information analyzing system of claim 9,
wherein the server
acquires moving information of the moving object on the sex of a person who is the moving object basis as the selection condition, and
displays, on the monitor, a moving information analysis image in which the moving information of the moving object on the sex basis is superimposed on the captured image.

13. The moving information analyzing system of claim 12,
wherein, if there is an input of the selection condition by using an input device connected to the server, the server acquires moving information of the moving object on the sex of the person basis, and displays, on the monitor, the moving information analysis image in which the moving information of the moving object on the sex basis is superimposed on the captured image.

14. The moving information analyzing system of claim 9,
wherein the server acquires moving information of the moving object on the age or an age range of a person who is the moving object basis as the selection condition, and
displays, on the monitor, a moving information analysis image in which the moving information of the moving object on the age or the age range basis is superimposed on the captured image.

15. The moving information analyzing system of claim 14,
wherein, if there is an input of the selection condition by using an input device connected to the server, the server acquires moving information of the moving object on the age or the age range of the person basis, and displays, on the monitor, the moving information analysis image in which the moving information of the moving object on the age or the age range basis is superimposed on the captured image.

16. The moving information analyzing system of claim 9,
wherein the server
acquires moving information of the moving object on a passing amount basis of the moving object basis in the object region as the selection condition, and
displays, on the monitor, a moving information analysis image in which the moving information of the moving object on the passing amount basis is superimposed on the captured image.

17. The moving information analyzing system of claim 16,
wherein, if there is an input of the selection condition by using an input device connected to the server, the server acquires the moving information of the moving object on the passing amount basis, and displays, on the monitor, the moving information analysis image in which the moving information of the moving object on the passing amount basis is superimposed on the captured image.

18. The moving information analyzing system of claim 9,
wherein the server
acquires moving information of the moving object on passing of a specific position of the moving object basis as the selection condition, and
displays, on the monitor, a moving information analysis image in which the moving information of the moving object on the passing of the specific position basis is superimposed on the captured image.

19. The moving information analyzing system of claim 18,
wherein, if there is an input of the selection condition by using an input device connected to the server, the server acquires moving information of the moving object on the passing of the specific position basis, and displays, on the monitor, the moving information analysis image in which the moving information of the moving object on the passing of the specific position basis is superimposed on the captured image.

20. A moving information analyzing method for a moving information analyzing system in which a camera and a server are connected to each other, the method comprising:
causing the camera
to capture an image of an object region,
to extract moving information regarding a staying position or a passing position of a moving object, and
to transmit a captured image of the object region and the moving information to the server in a predetermined transmission cycle; and
causing the server
to acquire moving information of a moving object corresponding to a selection condition on the basis of the moving information transmitted from the camera,
to generate a moving information analysis image in which the moving information of the moving object corresponding to the selection condition is superimposed on the captured image transmitted from the camera, and
to display the moving information analysis image on a monitor connected to the server.
